(19) United States
(12) Patent Application Publication
(10) Pub. No.: US 2026/0291356 A1
(43) Pub. Date: Sep. 24, 2026

(54) STATORS, STATOR DEVICES, AND ATTACHMENT OF COVER TO STATOR FOR DISPLACEMENT SYSTEMS

(71) Applicant: PLANAR MOTOR INCORPORATED, Vancouver (CA)

(72) Inventors: Graham WILLIAMSON, Vancouver (CA); Seung Hoon LEE, Burnaby (CA); Kevin XIAO, White Rock (CA); Xi Wen GOH, Vancouver (CA); Xiaodong LU, Vancouver (CA)

(21) Appl. No.: 19/463,913

(22) Filed: Jan. 29, 2026

Related U.S. Application Data
(63) Continuation-in-part of application No. 19/302,944, filed on Aug. 18, 2025.
Application No. 19/302,944 is a continuation of application No. 18/774,592, filed on Jul. 16, 2024, now Pat. No. 12,395,057.
Application No. 18/774,592 is a continuation of application No. 17/785,831, filed on Dec. 16, 2020, now Pat. No. 12,068,656.
(60) Provisional application No. 62/948,335, filed on Dec. 16, 2019.
(60) Provisional application No. 63/081,584, filed on Sep. 22, 2020.

(51) Int. Cl. H02K 41/03; H02K 1/12

(52) U.S. Cl. CPC H02K 41/031; H02K 1/12; H02K 2201/18

(57) ABSTRACT

Aspects of the present disclosure provide a method of holding a cover to a stator of a displacement system. The stator includes a holding surface and at least one electrical conductor positioned to generate at least one magnetic field external to the stator and operable to move at least one mover in a working environment of the displacement system. The cover includes a first surface facing the holding surface of the stator and a second surface across the cover from the first surface. The method includes causing a first fluid pressure in at least a space between the holding surface of the stator and the first surface of the cover to be lower than a second fluid pressure at the second surface of the cover to urge the cover toward the holding surface to hold the cover to the stator.

### CROSS-REFERENCE TO RELATED APPLICATIONS

This is a continuation-in-part application which claims the benefit of, and priority to U.S. utility application Ser. No. 19/302,944 filed Aug. 18, 2025, which itself claims the benefit of, and priority to U.S. utility application Ser. No. 18/774,592 filed Jul. 16, 2024, which itself claims the benefit of, and priority to U.S. utility application Ser. No. 17/785,831 filed Jun. 15, 2022, which is itself a National Stage Entry of and claims the benefit of, and priority to, international application PCT/CA2020/051735 filed Dec. 16, 2020, which itself claims the benefit of, and priority to, U.S. provisional patent application no. 62/948,335 filed on Dec. 16, 2019 and U.S. provisional patent application no. 63/081,584 filed on Sep. 22, 2020, the entire contents of which are each incorporated by reference herein.

### FIELD

This disclosure relates generally to displacement systems or robotic systems and stator devices for such systems.

### RELATED ART

Displacement systems, also known as robotic systems or conveyors, such as XY tables and rotary tables may be used in various manufacturing, inspection, and assembling processes. These systems may include a stator and a mover, typically referred to as a robotic device, mover device, or moveable stage. The stator actuates the mover. However, known displacement systems may have some disadvantages. For example, stators of existing systems may not be adequately protected from adverse environmental conditions.

### SUMMARY

According to one embodiment, there is disclosed a stator module comprising: a stator body; a working surface supported relative to the stator body and extending by a width in a first dimension between first and second exposed opposite sides of the stator module, the working surface further extending by a length in a second dimension between first and second opposite ends of the stator module, the second dimension different from the first dimension, the length greater than the width; and a plurality of electrical conductors, each electrical conductor of the plurality of electrical conductors extending along a respective portion of the working surface and operable to generate a magnetic field to facilitate moving, relative to the working surface, a magnetized mover in the magnetic field in response to electrical current through the electrical conductor; at least some electrical conductors of the plurality of electrical conductors in a first layer of electrical conductors of the plurality of electrical conductors extending in a first electrical conductor direction; and at least some electrical conductors of the plurality of electrical conductors in a second layer of electrical conductors of the plurality of electrical conductors separate from the first layer of electrical conductors extending in a second electrical conductor direction nonparallel to the first electrical conductor direction; the at least some electrical conductors of the plurality of electrical conductors in the first layer at least partially overlapping the at least some electrical conductors of the plurality of electrical conductors in the second layer in a direction orthogonal to the first and second electrical conductor directions; wherein the plurality of electrical conductors and the working surface are supported relative to the stator body such that the stator module is a unitary assembly.

According to another embodiment, there is disclosed a stator module comprising: a stator body; a working surface supported relative to the stator body; and a plurality of electrical conductors, each electrical conductor of the plurality of electrical conductors extending along a respective portion of the working surface and operable to generate a magnetic field to facilitate moving, relative to the working surface, a magnetized mover in the magnetic field in response to electrical current through the electrical conductor; at least some electrical conductors of the plurality of electrical conductors in a first layer of electrical conductors of the plurality of electrical conductors extending in a first electrical conductor direction; at least some electrical conductors of the plurality of electrical conductors in the first layer of electrical conductors of the plurality of electrical conductors extending in a second electrical conductor direction nonparallel to the first electrical conductor direction; and at least some electrical conductors of the plurality of electrical conductors in a second layer of electrical conductors of the plurality of electrical conductors separate from the first layer of electrical conductors extending in a third electrical conductor direction nonparallel to the first electrical conductor direction and nonparallel to the second electrical conductor direction.

According to another embodiment, there is disclosed a stator module comprising: a stator body; a working surface supported relative to the stator body; a motor sub-module comprising a plurality of electrical conductors, each electrical conductor of the plurality of electrical conductors extending along a respective portion of the working surface and operable to generate a magnetic field to facilitate moving, relative to the working surface, a magnetized mover in the magnetic field in response to electrical current through the electrical conductor; and a position-sensor sub-module comprising at least one position sensor operable to sense a position of the mover and defining a plurality of through-holes; wherein the stator body comprises a surface and a plurality of protrusions, each protrusion of the plurality of protrusions extending from the surface, towards the motor sub-module, and through a respective through-hole of the plurality of through-holes of the position-sensor sub-module and supporting the motor sub-module.

According to another embodiment, there is disclosed a method of holding a cover to a stator of a displacement system, the stator comprising a holding surface and at least one electrical conductor positioned to generate at least one magnetic field external to the stator and operable to move at least one mover in a working environment of the displacement system, the cover comprising a first surface facing the holding surface of the stator and a second surface across the cover from the first surface, the method comprising: causing a first fluid pressure in at least a space between the holding surface of the stator and the first surface of the cover to be lower than a second fluid pressure at the second surface of the cover to urge the cover toward the holding surface to hold the cover to the stator.

According to another embodiment, there is disclosed a stator for a displacement system, the stator comprising: at least one electrical conductor positioned to generate at least one magnetic field external to the stator and operable to move at least one mover in a working environment of the displacement system; and a stator body comprising a holding surface and an access surface different from the holding surface, the stator body defining an internal conduit comprising at least one conduit opening in the holding surface and at least one access opening in the access surface, the at least one access opening in fluid communication with the at least one conduit opening through the internal conduit.

According to another embodiment, there is disclosed a stator device for a displacement system, the stator device comprising: a stator comprising: at least one electrical conductor positioned to generate at least one magnetic field external to the stator and operable to move at least one mover in a working environment of the displacement system; and a holding surface; and a vacuum source operable to cause a first fluid pressure, in at least a space between the holding surface of the stator and a first surface of a cover positioned proximate the stator with the first surface facing the holding surface, to be lower than a second fluid pressure, at a second surface of the cover across the cover from the first surface, to urge the cover toward the holding surface to hold the cover to the stator.

According to another embodiment, there is disclosed a stator device for a displacement system, the stator device comprising: a stator comprising: at least one electrical conductor positioned to generate at least one magnetic field external to the stator and operable to move at least one mover in a working environment of the displacement system; and a holding surface; and a cover comprising: a first surface facing the holding surface of the stator; and a second surface across the cover from the first surface, wherein a first fluid pressure, in at least a space between the holding surface of the stator and the first surface of the cover, is lower than a second fluid pressure, at the second surface of the cover, to urge the cover toward the holding surface to hold the cover to the stator.

Other aspects and features will become apparent to those ordinarily skilled in the art upon review of the following description of illustrative embodiments in conjunction with the accompanying figures.

### BRIEF DESCRIPTION OF THE DRAWINGS

FIG. 1 is a top view of a robotic/displacement system according to one embodiment.

FIG. 2 is a cross-sectional view of the robotic/displacement system of FIG. 1.

FIG. 3 schematically illustrates a stator module according to one embodiment.

FIG. 4 schematically illustrates stator modules and a control system according to one embodiment.

FIG. 5 and FIG. 6 illustrate a stator module according to one embodiment.

FIG. 7 illustrates a stator module according to another embodiment.

FIG. 8 illustrates a stator module according to another embodiment.

FIG. 9 illustrates an electromagnetic driving region of the stator module of FIG. 5 and FIG. 6.

FIG. 10 illustrates electrical conductors in a first layer of the electromagnetic driving region of FIG. 9.

FIG. 11 illustrates electrical conductors in a second layer of the electromagnetic driving region of FIG. 9.

FIG. 12 illustrates a stator module according to another embodiment.

FIG. 13 illustrates additional electrical conductors of the stator module of FIG. 12 according to one embodiment.

FIG. 14 illustrates a stator module and a mover according to another embodiment.

FIG. 15 illustrates a product on the mover of FIG. 14.

FIG. 16 illustrates a stator module and a mover according to another embodiment.

FIG. 17 illustrates a motor sub-module according to another embodiment.

FIG. 18 illustrates electrical conductors in one layer of the motor sub-module of FIG. 17.

FIG. 19 illustrates electrical conductors according to another embodiment.

FIG. 20 illustrates electrical conductors in another layer of the motor sub-module of FIG. 17.

FIG. 21 is a plan view of magnet arrays of a mover according to one embodiment.

FIG. 22 is an elevation view of one of the magnet arrays of the mover of FIG. 21.

FIG. 23 shows two coordinate systems that may describe some embodiments.

FIG. 24 shows a mover-stator interaction according to one embodiment.

FIG. 25 shows a mover-stator interaction according to another embodiment.

FIG. 26 shows a mover-stator interaction according to another embodiment.

FIG. 27 shows a mover-stator interaction according to another embodiment.

FIG. 28 is an elevation view of a robotic/displacement system according to one embodiment.

FIG. 29 is a top view of the robotic/displacement system of FIG. 28.

FIG. 30 is a cross-sectional view of the robotic/displacement system of FIG. 28, taken along the line 29-29 in FIG. 29.

FIG. 31 is a perspective view of a stator body of the robotic/displacement system of FIG. 28.

FIG. 32 is a perspective view of a position-sensor sub-module of the robotic/displacement system of FIG. 28.

FIG. 33 is a perspective view of a robotic/displacement system according to one embodiment.

FIG. 34 is a perspective view of the robotic/displacement system of FIG. 33 with a magnet assembly of a magnetized mover of the robotic/displacement system exposed.

FIG. 35 is an exploded perspective view of a displacement system according to one embodiment.

FIG. 36 is a perspective view of the displacement system of FIG. 35.

FIG. 37 is a cross-sectional view of the displacement system of FIG. 35, taken along the line 37-37 in FIG. 36.

FIG. 38 is a top view of a stator device of the displacement system of FIG. 35, with a stator cover of the stator device removed.

FIG. 39 is a top view of an alternate spacer usable with the stator device of FIG. 38.

FIG. 40 is a top view of another alternate spacer usable with the stator device of FIG. 38.

FIG. 41 is an exploded perspective view of a displacement system according to another embodiment.

FIG. 42 is a perspective view of the displacement system of FIG. 41.

FIG. 43 is a cross-sectional view of the displacement system of FIG. 41, taken along the line 43-43 in FIG. 42.

FIG. 44 is a top view of a stator device of the displacement system of FIG. 35, with a stator cover of the stator device removed.

FIG. 45 is a top view of the stator device of FIG. 44, with a first spacer layer of a spacer of the stator device removed.

FIG. 46 is a cross-sectional view of displacement system according to another embodiment.

FIG. 47 is a perspective view of a displacement system according to another embodiment.

FIG. 48 is a schematic of a heat exchange layout for a stator device according to one embodiment.

FIG. 49 is a schematic of a heat exchange layout for a stator device according to another embodiment.

FIG. 50 is a perspective view of a stator device including a heat-exchange network according to one embodiment.

FIG. 51 is a partially exploded perspective view of the stator device of FIG. 50.

FIG. 52 is a cross-sectional perspective view of the stator device of FIG. 50, taken along the line 52, 53-52, 53 in FIG. 50.

FIG. 53 is a cross-sectional top view of the stator device of FIG. 50, taken along the line 52, 53-52, 53 in FIG. 50.

FIG. 54 is a perspective view of a stator device including a heat-exchange network according to another embodiment.

FIG. 55 is a partially exploded perspective view of the stator device of FIG. 54.

FIG. 56 is a cross-sectional perspective view of the stator device of FIG. 54, taken along the line 56, 57-56, 57 in FIG. 54.

FIG. 57 is a cross-sectional top view of the stator device of FIG. 54, taken along the line 56, 57-56, 57 in FIG. 54.

FIG. 58 is a cross-sectional perspective view of a stator device including a heat-exchange network according to another embodiment.

FIG. 59 is a cross-sectional top view of the stator device of FIG. 58.

FIG. 60 is a cross-sectional perspective view of a stator device including a heat-exchange network according to another embodiment.

FIG. 61 is a cross-sectional top view of the stator device of FIG. 60.

### DETAILED DESCRIPTION

The following references may assist the reader: U.S. Pat. Nos. 6,003,230; 6,097,114; 6,208,045; 6,441,514; 6,847,134; 6,987,335; 7,436,135; 7,948,122; United States patent publication no. 2008/0203828; W. J. Kim and D. L. Trumper, “High-precision magnetic levitation stage for photolithography”, Precision Eng. 22 2 (1998), pp. 66-77; D. L. Trumper et al., “Magnet arrays for synchronous machines”, IEEE Industry Applications Society Annual Meeting, vol. 1, pp. 9-18, 1993; J. W. Jansen, C. M. M. van Lierop, E. A. Lomonova, A. J. A. Vandenput, “Magnetically Levitated Planar Actuator with Moving Magnets”, IEEE Tran. Ind. App., Vol 44, No 4, 2008; PCT publication no. WO 2013/059934; PCT publication no. WO 2015/017933; PCT publication no. WO 2015/188281; PCT publication no. WO 2015/184553; and PCT publication no. WO 2015/179962.

Manufacturing, assembly, and inspection systems may use displacement systems, also known as robotic systems or conveyors, to transport components to be processed, combined, and packaged. Electromagnetic planar motors may be used as displacement or robotic systems in such applications. An electromagnetic planar motor generally includes one or more movers for holding components and one or more stators for supporting and driving/actuating the movers. The one or more stators may be incorporated into a stator device, which may further include additional elements such as support structures, enclosures, coatings, utility conduits, and/or protective covers.

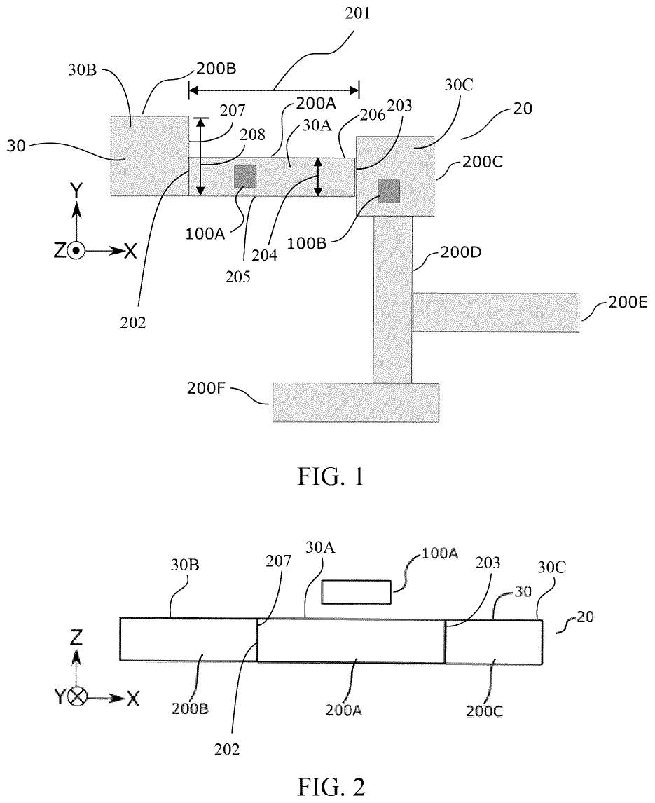

Referring to FIG. 1 and to FIG. 2, a robotic or displacement system according to one embodiment includes a stator 20 and movers 100A and 100B. The stator 20 includes stator modules 200A, 200B, 200C, 200D, 200E, and 200F. The stator modules 200A, 200B, 200C, 200D, 200E, and 200F collectively define a working surface 30 of the stator 20, and the movers 100A and 100B may move relative to the working surface 30 as described herein, for example. Of course the embodiment shown is an example only, and alternative embodiments may differ. For example, alternative embodiments may include more, fewer, or different stator modules, and alternative embodiments may include more, fewer, or different movers. For example, some embodiments may include only one stator module or more than one stator module. Further, the working surface 30 is planar, but alternative working surfaces may be curved, cylindrical, spherical, or other shapes, for example.

In the embodiment shown, the robotic/displacement system may be described with reference to various axes. For example, in the embodiment shown, the stator 20 may be described with reference to Cartesian axes identified as X, Y, and Z in the drawings, and the Cartesian axes identified as X, Y, and Z may be fixed relative to the stator 20 such that the X and Y axes are perpendicular to each other, such that the working surface 30 extends in the X and Y axes, and such that the Z axis is perpendicular to the working surface 30 and to the X and Y axes. However, alternative embodiments may differ, and embodiments such as those described herein are not limited to or limited by any particular axes.

As shown in FIG. 1 for example, embodiments such as those described herein may include stators including differently shaped stator modules. As also shown in FIG. 1 for example, embodiments such as those described herein may include stators including stator modules having working surfaces that form respective portions of at least some of an overall working surface of a stator, and the respective working surfaces of the stator modules may have different shapes.

For example, in the embodiment of FIG. 1, each of the stator modules 200A, 200B, 200C, 200D, 200E, and 200F has a respective working surface, and as examples, FIG. 1 illustrates a working surface 30A of the stator module 200A, a working surface 30B of the stator module 200B, and a working surface 30C of the stator module 200C. In the embodiment of FIG. 1, the respective working surfaces of the stator modules 200A, 200B, 200C, 200D, 200E, and 200F form respective portions of at least some of the working surface 30, and the respective working surfaces of the stator modules 200A, 200B, 200C, 200D, 200E, and 200F have different shapes. For example, in the embodiment shown, the working surfaces 30B and 30C of the stator modules 200B and 200C are square-shaped and the respective working surfaces of the stator modules 200A, 200D, 200E, and 200F are rectangular, but of course alternative embodiments may differ.

In other words, in the embodiment shown, for example, the stator module 200A and the working surface 30A of the stator module 200A have a length 201 in a dimension (along the X axis in this embodiment) between opposite ends 202 and 203 of the stator module 200A and of the working surface 30A of the stator module 200A, the stator module 200A and the working surface 30A of the stator module 200A have a width 204 in a different dimension (along the Y axis in this embodiment) between exposed opposite sides 205 and 206 of the stator module 200A and of the working surface 30A of the stator module 200A, and the length 201 is greater than the width 204. The sides 205 and 206 may be referred to as “exposed” because the sides 205 and 206 are exposed to an environment of the stator 20 without other structure of the stator 20 or without any other structure on the sides 205 and 206.

As shown in FIG. 1 for example, a stator module having one shape (or having a working surface having one shape) may be positioned against, adjacent, or abutting a stator module having a different shape (or having a working surface having a different shape), and a stator module having one orientation (or having a working surface having one orientation) may be positioned against, adjacent, or abutting a stator module having a different orientation (or having a working surface having a different orientation).

For example, in the embodiment of FIG. 1, the stator module 200A is rectangular, the working surface 30A of the stator module 200A is rectangular, and the stator module 200A is positioned against, adjacent, or abutting a side 207 of the stator module 200B with the respective working surfaces of the stator modules 200A and 200B adjacent or abutting each other, and the stator module 200B and the working surface of the stator module 200B are square-shaped. The side 207 has a width (or, more generally, an extent) 208 greater than the width 204.

Also, in the embodiment of FIG. 1, the stator module 200D is positioned against, adjacent, or abutting the stator module 200E with the respective working surfaces of the stator modules 200D and 200E adjacent or abutting each other, the stator modules 200D and 200E are rectangular, and the respective working surfaces of the stator modules 200D and 200E are rectangular, but the stator module 200D and the working surface of the stator modules 200D extend along the Y axis and the stator module 200E and the working surface of the stator modules 200E extend along the X axis. In other words, in the embodiment shown, the stator module 200D and the working surface of the stator modules 200D have one orientation (along the Y axis) and may be positioned against, adjacent, or abutting another stator module (the stator module 200E in the embodiment shown), and the other stator module and the working surface of the other stator module have a different orientation (along the X axis). Of course alternative embodiments may differ.

In general, such combinations of stator modules having such different shapes may allow for greater flexibility for designing or assembling different stators for different applications when compared to stator modules having the same shapes (such as only square shapes, for example). Further, such combinations of stator modules having such different shapes may allow for stators to be assembled at lower costs when compared to stators that are assembled from stator modules having the same shapes (such as only square shapes, for example) because, for example, rectangular stator modules such as the stator modules 200A, 200D, 200E, and 200F may extend a longer distance for a lower cost than square-shaped stator modules, for example.

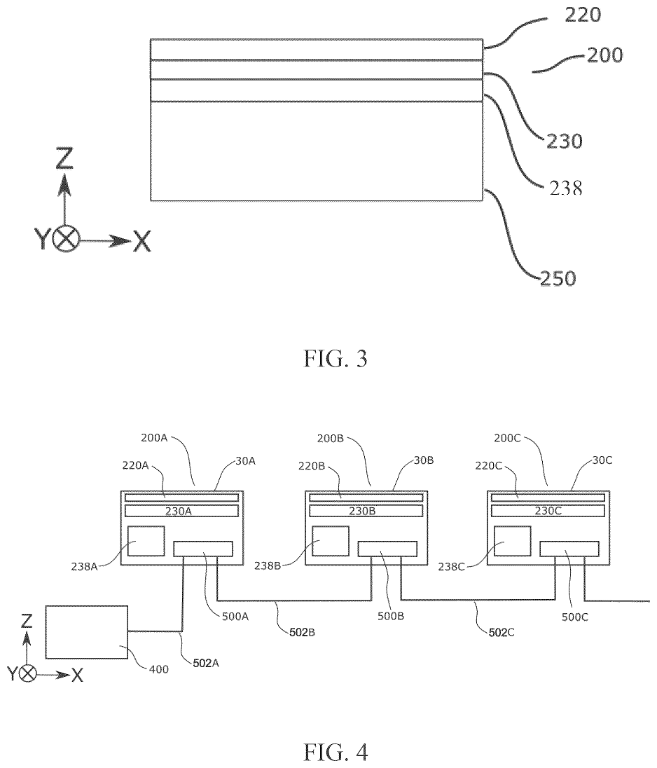

FIG. 3 schematically illustrates a stator module 200, which may be illustrative of the stator modules 200A, 200D, 200E, and 200F or of other stator modules such as those described herein, for example. The stator module 200 includes a motor sub-module 220, a position-sensor sub-module 230, an amplifier sub-module 238, and a stator body 250 as mechanical structure supporting the sub-modules and the working surfaces. The motor sub-module 220 may include electrical conductors that may be operable to generate a magnetic field to facilitate moving, relative to a working surface of the stator module 200, a magnetized mover (such as the mover 100A or 100B) in the magnetic field along (or otherwise relative to) the working surface in response to electrical currents through the electrical conductors. The position-sensor sub-module 230 may include at least one position sensor operable to sense a position of such a mover. The amplifier sub-module 238 may be operable to amplify control signals received from a system controller or a module controller to control at least some of the electrical conductors of the motor sub-module 220. In some embodiments, the amplifier sub-module 238 may be operable to amplify control signals received from a system controller or a module controller to control each electrical conductor of the motor sub-module 220.

In this particular non-limiting embodiment, the order of components from top to bottom is motor sub-module 220, then the position-sensor sub-module 230, followed by the amplifier sub-module 238. That particular arrangement from top to bottom is not required, and alternative embodiments may differ. However, in some embodiments, the motor sub-module should be as close to the working surface as possible to maximize the generated magnetic field experienced by a mover (such as the mover 100A or 100B) above the working surface. In alternative embodiments, the arrangement of sub-modules may differ, or alternative embodiments may include more, fewer, or different sub-modules.

FIG. 4 schematically illustrates the stator modules 200A, 200B, and 200C and a control system (or a system controller or a control circuit) 400 operable to control the stator modules 200A, 200B, and 200C (and possibly more or fewer stator modules). The stator module 200A includes a motor sub-module 220A, a position-sensor sub-module 230A, an amplifier sub-module 238A, and a module controller 500A. The stator module 200B includes a motor sub-module 220B, a position-sensor sub-module 230B, an amplifier sub-module 238B, and a module controller 500B. The stator module 200C includes a motor sub-module 220C, a position-sensor sub-module 230C, an amplifier sub-module 238C, and module controller 500C. Each stator module may also include a stator body (such as the stator body 250 described above, for example) as mechanical structure supporting the sub-modules and the working surfaces of the stator module. The motor sub-modules 220A, 220B, and 220C may each include electrical conductors that may be operable to generate a magnetic field to facilitate moving, relative to a working surface of the stator module 200, a magnetized mover (such as the mover 100A or 100B) in the magnetic field along (or otherwise relative to) the working surface in response to electrical currents through the electrical conductors. The position-sensor sub-modules 230A, 230B, and 230C may each include at least one position sensor operable to sense a position of such a mover. The amplifier sub-module 238A may include circuitry operable to amplify control signals received from the module controller 500A to control the electrical conductors of the motor sub-modules 220A, the amplifier sub-module 238B may include circuitry operable to amplify control signals received from the module controller 500B to control the electrical conductors of the motor sub-modules 220B, and the amplifier sub-module 238C may include circuitry operable to amplify control signals received from the module controller 500C to control the electrical conductors of the motor sub-modules 220C.

In the embodiment of FIG. 4, the control system 400 communicates with the module controller 500A using a data cable 502A, the module controller 500A communicates with the module controller 500B using a data cable 502B, and the module controller 500B communicates with the module controller 500C using a data cable 502C. Such communication may involve transmitting or receiving one or more signals to control the amplifier sub-module of the stator modules or transmitting or receiving one or more signals representing measurements by the position-sensor sub-modules of the stator modules, for example. In some embodiments, the control system 400 may transmit one or more control signals representing one or more set points (or desired values) of electrical currents flowing through some of the electrical conductors as described above, and such electrical current set points may transmitted to one or more module controllers (such as the module controllers 500A, 500B, and 500C), which may further generate one or more signals to one or more amplifier sub-modules (such as the amplifier sub-modules 238A, 238B, and 238C) so that the amplifier sub-modules may cause electrical currents to flow through electrical conductors as described above according to the electrical current set points. In some embodiments, the control system 400 may transmit one or more control signals representing one or more set points (or desired values) of mover positions to one or more module controllers (such as the module controllers 500A, 500B, and 500C), which may further use the position set points and position sensor information to determine electrical current set points for electrical currents flowing through some of the electrical conductors as described above. For example, to control an amplifier sub-module (such as the amplifier sub-module 238A, 238B, or 238C), a module controller (such as the module controller 500A, 500B, and 500C) may transmit, to the amplifier sub-module, one or more control signals (such as one or more pulse-width modulation (PWM) or analog control signals, for example) according to the electrical current set points. The data cables 502B and 502C are external to the stator modules 200A, 200B, and 200C, and in general, stator modules such as those described herein may communicate with each other using data cables external to the stator modules. Of course alternative embodiments may differ, and may include wireless communication or other alternatives to the embodiment of FIG. 4.

In general, the stator modules described above may be unitary. For example, stator bodies (such as the stator body 250) may support motor sub-modules, electrical conductors of the motor sub-modules, working surfaces, or other sub-modules such as those described herein, or two or more thereof such that the stator modules described above may be unitary assemblies. Such unitary assemblies may be connected to each other using external data cables (such as the data cables 502B and 502C external to the stator modules 200A, 200B, and 200C, for example) or other connections external to the stator modules. Further, stator modules as described herein may be units of a stator such that the stator may be formed from the stator modules such that the stator modules are the smallest units of the stator that include some or all of the sub-modules described above and that can function individually or collectively as stators.

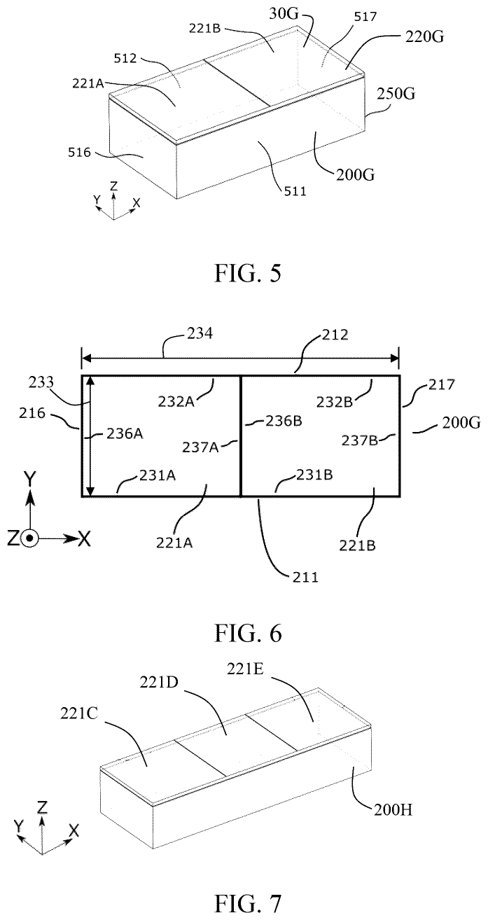

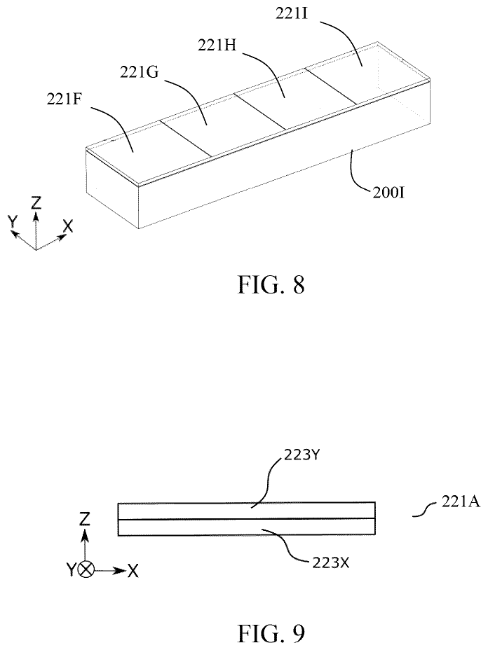

FIG. 5 and FIG. 6 illustrate a stator module 200G according to one embodiment. The stator module 200G includes a stator body 250G, a motor sub-module 220G, and a working surface 30G. The motor sub-module 220G includes two electromagnetic driving regions 221A and 221B in a single row and covered by the working surface 30G. Alternative embodiments may include only one electromagnetic driving region or more than two electromagnetic driving regions. For example, FIG. 7 illustrates a stator module 200H according to one embodiment and including three electromagnetic driving regions 221C, 221D, and 221E in a single row. As another example, FIG. 8 illustrates a stator module 200I according to one embodiment and including four electromagnetic driving regions 221F, 221G, 221H, and 221I in a single row. In such embodiments, Y-oriented edges (or, more generally, transverse edges) of the electromagnetic driving regions may be generally coincidental to such edges of one or more adjacent electromagnetic driving regions. The stator module 200H and 200I may otherwise be similar to the stator module 200G.

Referring back to FIG. 5 and FIG. 6, in the embodiment shown, the stator body 250G has outer side surfaces with a first outer side surface 511 (with a normal direction in −Y), a second outer side surface 516 (with a normal direction in −X), a third outer side surface 512 (with a normal direction in +Y), and a fourth outer side surface 517 (with a normal direction in +X). The projection of the surfaces 511, 512, 516, and 517 on the X-Y plane forms, respectively, a first projected surface edge 211, a second projected surface edge 216, a third projected surface edge 212, and a fourth projected surface edge 217.

In the embodiment shown, the first electromagnetic driving region 221A has a first edge 231A, a second edge 236A, a third edge 232A, and a fourth edge 237A. Although only four edges are shown, additional edges may be adopted in some embodiments. The second electromagnetic driving region 221B has a fifth edge 231B, a sixth edge 236B, a seventh edge 232B, and an eighth edge 237B. Again, although only four edges are shown, additional edges may be adopted in some embodiments. In this embodiment, the first projected surface edge 211 coincides with the first edge 231A, the third projected surface edge 212 coincides with the third edge 232A, the second projected surface edge 216 coincides with the second edge 236A, the fourth edge 237A coincides with the sixth edge 236B, the first projected surface edge 211 coincides with the fifth edge 231B, and the third projected surface edge 212 coincides with the seventh edge 232B.

Therefore, in the embodiment shown, the stator module 200G, the stator body 250G, and the working surface 30G have a width 233 between exposed opposite sides of the stator module 200G at the first projected surface edge 211 and at the third projected surface edge 212, and a length 234 between opposite ends of the stator module 200G at the second projected surface edge 216 and at the fourth projected surface edge 217. The length 234 is greater than the width 233, and the stator module 200G may therefore be included in a stator similarly to the stator module 200A as shown in FIG. 1, for example.

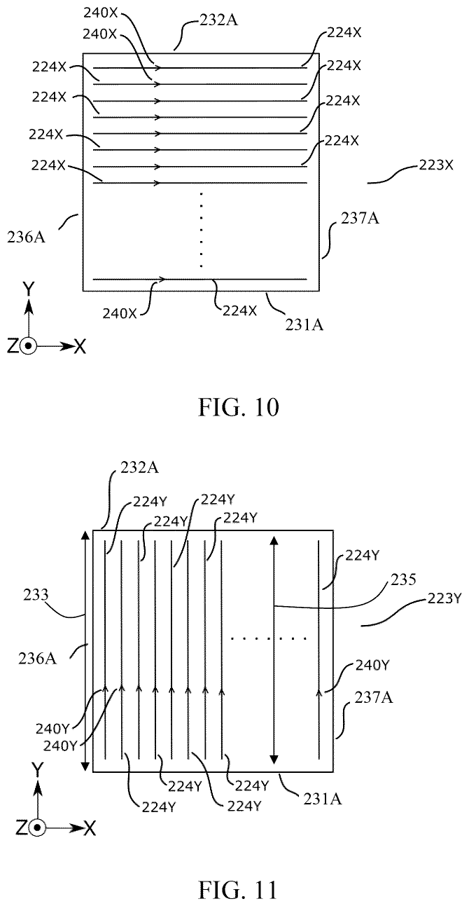

Referring to FIG. 9, FIG. 10, and FIG. 11, the electromagnetic driving region 221A (also shown in FIG. 5 and FIG. 6) includes electrical conductors 224X (which may be referred to a subset of the electrical conductors of the stator module 200G) in a first layer 223X of the electromagnetic driving region 221A. The electrical conductors 224X extend longitudinally relative to the working surface 30G, although alternative embodiments may include electrical conductors that extend in one or more different longitudinal directions, such as one or more curvilinear longitudinal directions or one or more directions that may not necessarily be along the X axis as shown. In general, a line, direction, or dimension as described herein may include a straight or curvilinear line, a linear or curved direction, or a linear or curved dimension.

In the embodiment shown, the electrical conductors 224X are evenly spaced apart from each other along the Y axis and extend between the edges 231A and 232A, but alternative embodiments may differ. Also, in the embodiment shown, a distance between the edge 231A and the electrical conductor 224X closest to the edge 231A is no more than five or ten times a width of the electrical conductor 224X, and a distance between the edge 232A and the electrical conductor 224X closest to the edge 232A is no more than five or ten times a width of the electrical conductor 224X, but alternative embodiments may differ. Each of the electrical conductors 224X also extends between the edges 236A and 237A, which may mean that a distance from the electrical conductors 224X to the edge 236A and a distance from the electrical conductors 224X to the edge 237A is no more than five or ten times a width of each electrical conductor 224X.

In general, herein, an electrical conductor may extend between two edges, meaning that a distance from the electrical conductor to each of the edges is no more than five or ten times a width of the electrical conductor.

Each of the electrical conductors 224X extends along a respective portion of the working surface 30G. When an electrical current passes through an electrical conductor 224X, a magnetic field around the electrical conductor 224X is generated. Therefore, each of the electrical conductors 224X may be operable to generate a magnetic field to facilitate moving, relative to the working surface 30G, a magnetized mover (such as the mover 100A or 100B) in the magnetic field along (or otherwise relative to) the working surface 30G in response to electrical currents 240X through the electrical conductors. Although the currents 240X are shown in the positive X direction, the actual current flowing direction can be either positive or negative, depending on the values of the current. The labeled current directions in this document are merely illustrative reference directions rather than restrictive or actual flowing directions.

The electromagnetic driving region 221A also includes electrical conductors 224Y (which may be referred to a subset of the electrical conductors of the stator module 200G) in a second layer 223Y of the electromagnetic driving region 221A separate from the first layer 223X in the Z direction (or, more generally, in a direction nonparallel or orthogonal to directions of the electrical conductors 224X and 224Y). The electrical conductors 224Y extend transversely relative to the working surface 30G, and may be orthogonal to the electrical conductors 224X, although alternative embodiments may include electrical conductors that extend in one or more different transverse directions, such as one or more curvilinear transverse directions or one or more directions that may not necessarily be along the Y axis as shown.

In the embodiment shown, the electrical conductors 224Y are evenly spaced apart from each other along the X axis and extend between the edges 236A and 237A, but alternative embodiments may differ. Also, in the embodiment shown, a distance between the edge 236A and the electrical conductor 224Y closest to the edge 236A is no more than five or ten times a width of the electrical conductor 224Y, and a distance between the edge 237A and the electrical conductor 224Y closest to the edge 237A is no more than five or ten times a width of the electrical conductor 224Y, but alternative embodiments may differ. Each of the electrical conductors 224Y also extends between the edges 231A and 232A, which may mean that a distance from the electrical conductors 224Y to the edge 231A and a distance from the electrical conductors 224Y to the edge 232A is no more than five or ten times a width of each electrical conductor 224Y.

Each of the electrical conductors 224Y extends along a respective portion of the working surface 30G. When an electrical current passes through an electrical conductor 224Y, a magnetic field around the electrical conductor 224Y is generated. Therefore, each of the electrical conductors 224Y may be operable to generate a magnetic field to facilitate moving, relative to the working surface 30G, a magnetized mover (such as the mover 100A or 100B) in the magnetic field along (or otherwise relative to) the working surface 30G in response to electrical currents 240Y through the electrical conductors.

Further, the electrical conductors 224Y extend entirely across a portion 235 of the width 233 of the working surface 30G, and all of the electrical conductors of the stator module 200G that extend transversely relative to the working surface 30G are within at least a portion of the portion 235 of the width 233 of the working surface 30G.

As shown in FIG. 9, the first layer 223X and the second layer 223Y at least partially overlap in the Z direction (or, more generally, in a direction nonparallel or orthogonal to directions of the electrical conductors 224X and 224Y). Further, although two layers are shown in FIG. 9, some embodiments may include only the first layer 223X or only the second layer 223Y, or some embodiments may include more than two layers. For example, some embodiments may include two or more layers similar to the first layer 223X, two or more layers similar to the second layer 223Y, or both. Of course other embodiments may include other alternatives.

Other electromagnetic driving regions, such as the electromagnetic driving regions 221B, 221C, 221D, 221E, 221F, 221G, 221H, and 221I for example, may be similar to the electromagnetic driving region 221A. Therefore, in the stator module 200G shown in FIG. 5 and FIG. 6, the electromagnetic driving region 221A includes longitudinal electrical conductors (such as the electrical conductors 224X, for example), and the electromagnetic driving region 221B also includes longitudinal electrical conductors (similar to the electrical conductors 224X, for example) but distinct from the longitudinal electrical conductors of the electromagnetic driving region 221A. In general, electromagnetic driving regions may include electrical conductors that may be distinct from some or all of the electrical conductors of some or all other electromagnetic driving regions of a stator module.

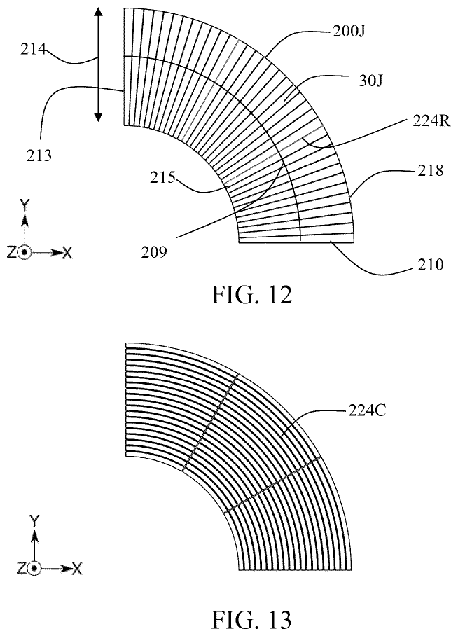

The working surface 30G is substantially rectangular, but alternative embodiments may differ. For example, FIG. 12 illustrates a stator module 200J having a working surface 30J. The stator module 200J and the working surface 30J have a curved length 209 in a dimension (a curved dimension in this embodiment) between opposite ends 210 and 213 of the stator module 200J and of the working surface 30J, the stator module 200J and the working surface 30J have a width 214 in a different dimension (a radial dimension in this embodiment) between exposed opposite curved sides 215 and 218 of the stator module 200J and of the working surface 30J, and the length 209 is greater than the width 214. The stator module 200J includes radially extending electrical conductors 224R that may be similar to electrical conductors as described above, or the stator module 200J may include other electrical conductors that may be similar to electrical conductors as described above and that may at least partially overlap in the Z direction (or, more generally, in a direction nonparallel or orthogonal to directions of the electrical conductors). For example, in some embodiments, electrical conductors of the stator module 200J may be curved, and may be orthogonal to the radially extending electrical conductors 224R, such as curved electrical conductors 224C as shown in FIG. 13, for example.

In general, each electrical conductor may have different electrical current set point (or desired value) based on suitable commutation laws, such as but not being limited to three-phase sinusoidal commutation, for example. Multiple electrical conductors may be connected in serial at their ends, for example.

In general, the electrical currents through electrical conductors as described above may be determined to move a magnetized mover (such as the mover 100A or 100B) in one, two, three, four, five, or six degrees of freedom along a working surface of one stator module or along or relative to a working surface (such as the working surface 30 shown in FIG. 1 and FIG. 2) of a stator including more than one stator module. For example, the electrical currents through electrical conductors as described above may be determined to move a magnetized mover from the working surface of one stator module to the working surface of another stator module of such as stator.

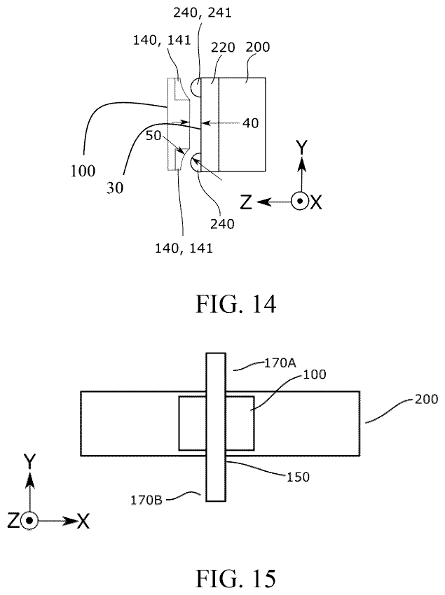

For example, FIG. 14 illustrates a mover 100 (with one or more bearing units 140 each having bearing surfaces 141) and a stator 200 (with one or more bearing units 240, which may be rails, each having bearing surfaces 241) according to one embodiment. During operation, the mover 100 may operate in a levitated state where the mover 100 is controlled by the stator 200 to maintain a sufficient working gap clearance 40 to ensure there is no contact between the mover bearing surfaces 141 and the stator bearing surfaces 241 such that the bearing support gap is a positive value. While operating in a levitated state, the Y direction motion of the mover may be limited in this particular embodiment by the stator bearing units 240, which may protrude above the stator work surface 30. During operation with this particular stator embodiment, the mover 100 may operate in a landed or engaged state in which the working gap 40 is decreased until the mover bearing surfaces 141 contact the stator bearing surfaces 241 (such that the bearing support gap 50 is generally zero). While operating in this state, motion of the mover 100 is constrained in five degrees of freedom, limiting motion of the mover 100 to be along the X direction. In such embodiments, electrical conductors of the stator 200 may all extend transversely (such as the electrical conductors 224Y, for example) relative to the stator work surface 30, although such electrical conductors may be shorter in length than the electrical conductors 224Y.

As indicated above, rectangular stator modules such as the stator modules 200A, 200D, 200E, 200F, and 200G may extend a longer distance for a lower cost than square-shaped stator modules, for example. Further, rectangular stator modules may more easily allow a product to extend wider than the stator modules. For example, FIG. 15 illustrates a product 150 is mounted on the mover 100 of FIG. 14 according to one embodiment. The product 150 has two ends 170A and 170B, which extend wider than the stator 200. In some embodiments, a high-force or energy-processing station (such as stamping, welding, or laser machining, for example) can be configured to process the product 150 on the two ends 170A and 170B of the product 150.

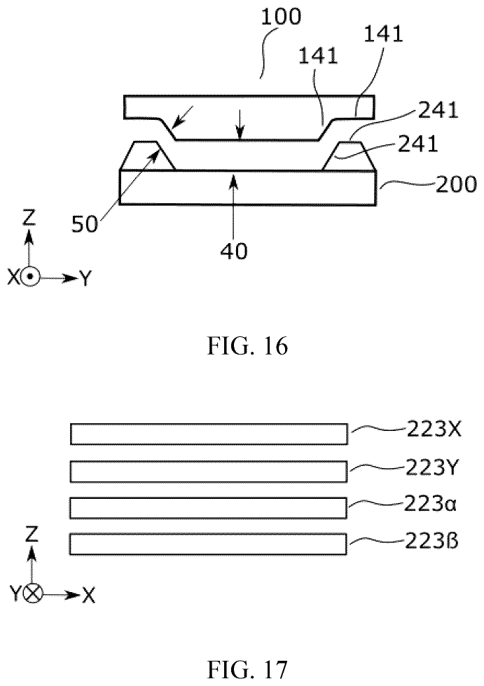

FIG. 16 illustrates an alternative to the mover 100 and stator 200 of FIG. 14. In general, the bearing surfaces 141 and 241 of the mover and stator bearing units 140 and 240 may be in the shape of curves, flat geometry, triangle, cylindrical, spherical, or some combination sufficient to guide mover motion and/or support the weight of the mover 100 (along the Z direction) while operating in a landed state. It may be desirable to maintain certain contact areas between the two mating bearing units to minimize wear during operation. The respective bearing units of the mover 100 and stator 200 may be matched together to achieve a desired behavior or performance. The bearings may utilize sliding or rolling contact during operation. In some embodiments, the two mating surfaces may not touch each other directly and a fluid film may exist in between, such as air or fluid during high speed motion. Such aero-dynamic bearing may help significantly reduce wear on bearing surfaces without requiring much electrical energy as needed in magnetic levitation. The mating bearing units may be made of materials such as but not being limited to ceramics, glass, plastics, metals with surface properly processed, or other suitable materials with smooth surfaces.

FIG. 17 illustrates a motor sub-module according to another embodiment. The motor sub-module of FIG. 17 includes electrical conductors in a first layer 223X as described above and shown in FIG. 10, electrical conductors in a second layer 223Y (separate from the first layer 223X in the Z direction, or, more generally, in a direction nonparallel or orthogonal to directions of the electrical conductors in the first layer 223X and in the second first layer 223Y) as described above and shown in FIG. 11, electrical conductors in a third layer 223α (separate from the first and second layers 223X and 223Y in the Z direction, or, more generally, in a direction nonparallel or orthogonal to directions of the electrical conductors in the first layer 223X, in the second first layer 223Y, and in the third layer 223α), and electrical conductors in a third first layer 223β separate from the first, second, and third layers 223X, 223Y, and 223α. As shown in FIG. 17, the first, second, third, and fourth layers 223X, 223Y, 223α, and 223β at least partially overlap in the Z direction (or, more generally, in a direction nonparallel or orthogonal to directions of the electrical conductors of the first, second, third, and fourth layers 223X, 223Y, 223α, and 223β).

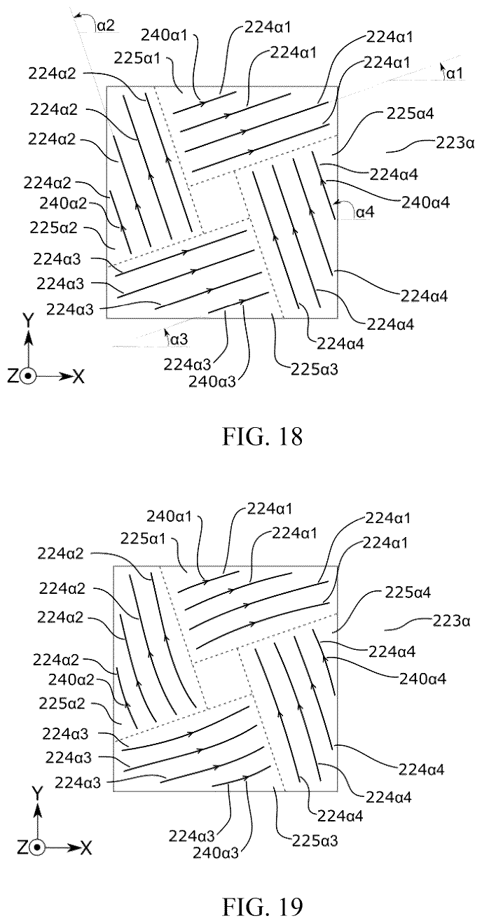

FIG. 18 illustrates electrical conductors 224α1 in a sub-sector 225α1, electrical conductors 224α2 in a sub-sector 225α2, electrical conductors 224α3 in a sub-sector 225α3, and electrical conductors 224α4 in a sub-sector 225α4 of the third layer 223α. The electrical conductors 224α1 extend at an angle α1 around the Z axis from the X axis, the electrical conductors 224α2 extend at an angle α2 around the Z axis from the X axis, the electrical conductors 224α3 extend at an angle α3 around the Z axis from the X axis, and the electrical conductors 224α4 extend at an angle α4 around the Z axis from the X axis. The electrical conductors in FIG. 18 are linear but may be curvilinear or include one or more curved segments in other embodiments. Further, although FIG. 18 illustrates four sub-sectors, alternative embodiments may include more or fewer sub-sectors, such as two or more sub-sectors, for example. In general, electrical conductors of one such sub-sector may be nonparallel to electrical conductors of another such sub-sector, and the electrical conductors of such sub-sectors may be in a common layer. Further, the electrical conductors of such sub-sectors may be nonparallel to the electrical conductors of another layer, such as the electrical conductors of the first layer 223X, of the second layer 223Y, or of both, for example. Electrical currents 240α1, 240α2, 240α3, 240α4 in the electrical conductors 224α1, 224α2, 224α3, 224α4 respectively may be controlled as described above, for example. In the embodiment shown, α2=α1 +90°, α3=α1, α4=α2, and α1 is between 15° and 45°, for example 30°, although alternative embodiments may differ and, for example, α1 may differ from α3 and α2 may differ from α4. In each sub-sector 225α1, 225α2, 225α3, and 225α4 in FIG. 18, current set points for each electrical conductor can be determined by positions of magnet arrays of a mover relative to the electrical conductors according to suitable commutation laws, such as but not being limited to three-phase sinusoidal commutation. The spacing of electrical conductors in the transverse direction (or pitch) can be designed based on a spatial period of a magnet array of a mover, and on a number of electrical conductor phases within one magnet array spatial period. For example, for a three-phase design, the pitch can be about the spatial period of the magnet array divided by 3n, where n is an integer number. If the magnet array spatial period is 60 millimeters (mm), for example, then the conductor pitch can be close to 5 mm, 10 mm, or 20 mm, for example.

In the embodiment shown in FIG. 18, the electrical conductors 224α1 and the electrical conductors 224α3 overlap partially along their lengths in a plane including directions in which the electrical conductors 224α1 and 224α3 extend, but are spaced apart from each other in such a plane in a direction transverse to their lengths. Also in the embodiment shown in FIG. 18, the electrical conductors 224α2 and the electrical conductors 224α4 overlap partially along their lengths in a plane including directions in which the electrical conductors 224α2 and 224α4 extend, but are spaced apart from each other in such a plane in a direction transverse to their lengths. Of course alternative embodiments may differ.

As indicated above, the electrical conductors in FIG. 18 are linear but may be curvilinear or include one or more curved segments in other embodiments, as shown in FIG. 19, for example. In the embodiment of FIG. 19, the first sub-sector 225α1 comprises a first plurality of curvilinear electrical conductors 224α1 elongated along a first curvilinear direction. The second sub-sector 225α2 comprises a second plurality of curvilinear electrical conductors 224α2 elongated along a second curvilinear direction. The third sub-sector 225α3 comprises a third plurality of electrical conductors 224α3 elongated along a third curvilinear direction. The fourth sub-sector 225α4 comprises a fourth plurality of electrical conductors 224α4 elongated along a fourth curvilinear direction. The electrical conductors 224α1, 224α2, 224α3, and 224α4 may be driven by an amplifier sub-module with current 240α1, 240α2, 240α3, and 240α4 respectively with suitable amount. The curve of a curvilinear direction may be generally gradual with an angle between a start and an end tangent typically being less than 45°. Although FIG. 18 illustrates four sub-sectors, alternative embodiments may include more or fewer sub-sectors, such as two or more sub-sectors, for example. In the embodiment shown, the curvilinear directions could be approximated to follow corresponding linear directions, where α2=α1+90°, α3=α1, α4=α2, and α1 is between 15° and 45°, for example 30°, although alternative embodiments may differ and, for example, α1 may differ from α3 and α2 may differ from α4.

In the embodiment shown in FIG. 19, the electrical conductors 224α1 and the electrical conductors 224α3 overlap partially along their lengths in a plane including directions in which the electrical conductors 224α1 and 224α3 extend, but are spaced apart from each other in such a plane in a direction transverse to their lengths. Also in the embodiment shown in FIG. 19, the electrical conductors 224α2 and the electrical conductors 224α4 overlap partially along their lengths in a plane including directions in which the electrical conductors 224α2 and 224α4 extend, but are spaced apart from each other in such a plane in a direction transverse to their lengths. Of course alternative embodiments may differ.

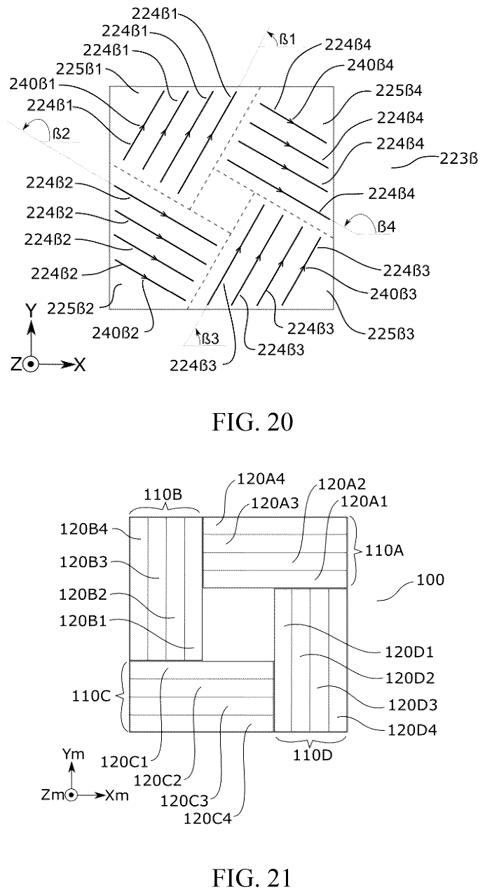

FIG. 20 illustrates electrical conductors 224β1 in a sub-sector 225β1, electrical conductors 224β2 in a sub-sector 225β2, electrical conductors 224β3 in a sub-sector 225β3, and electrical conductors 224β4 in a sub-sector 225β4 of the third layer 223β. The electrical conductors 224β1 extend at an angle β1 around the Z axis from the X axis, the electrical conductors 224β2 extend at an angle β2 around the Z axis from the X axis, the electrical conductors 224β3 extend at an angle β3 around the Z axis from the X axis, and the electrical conductors 224β4 extend at an angle β4 around the Z axis from the X axis. The electrical conductors in FIG. 20 are linear but may be curvilinear or include one or more curved segments in other embodiments. Further, although FIG. 20 illustrates four sub-sectors, alternative embodiments may include more or fewer sub-sectors, such as two or more sub-sectors, for example. In general, electrical conductors of one such sub-sector may be nonparallel to electrical conductors of another such sub-sector, and the electrical conductors of such sub-sectors may be in a common layer. Further, the electrical conductors of such sub-sectors may be nonparallel to the electrical conductors of another layer, such as the electrical conductors of the first layer 223X, of the second layer 223Y, of the third layer 223α, or of two or more thereof, for example. Electrical currents 240β1, 240β2, 240β3, 240β4 in the electrical conductors 224β1, 224β2, 224β3, 224β4 respectively may be controlled as described above, for example. In the embodiment shown, β2=β1+90°, β3=β1, β4=β2, and β1 is between 45° and 75°, for example 60°, although alternative embodiments may differ and, for example, β1 may differ from β3 and β2 may differ from β4.

In the embodiment shown in FIG. 20, the electrical conductors 224β1 and the electrical conductors 224β3 overlap partially along their lengths in a plane including directions in which the electrical conductors 224β1 and 224β3 extend, but are spaced apart from each other in such a plane in a direction transverse to their lengths. Also in the embodiment shown in FIG. 18, the electrical conductors 224β2 and the electrical conductors 224β4 overlap partially along their lengths in a plane including directions in which the electrical conductors 224β2 and 224β4 extend, but are spaced apart from each other in such a plane in a direction transverse to their lengths. Of course alternative embodiments may differ.

Further, in the Z direction (or, more generally, in a direction nonparallel or orthogonal to directions of the electrical conductors of the first, second, third, and fourth layers 223X, 223Y, 223α, and 223β), the sub-sector 225β1 may at least partially overlap the sub-sectors 225α1 and 225α2, the sub-sector 225β2 may at least partially overlap the sub-sectors 225α2 and 225α3, the sub-sector 225β3 may at least partially overlap the sub-sectors 225α3 and 225α4, and the sub-sector 225β4 may at least partially overlap the sub-sectors 225α4 and 225α1.

In general, embodiments such as the motor sub-module of FIG. 17 include electrical conductors that extend along portions of a working surface within 15° of each other, or along at least four different directions, and that at least partially overlap in a direction nonparallel or orthogonal to directions of the electrical conductors.

As shown from FIG. 21 to FIG. 27, the motor sub-module of FIG. 17 may significantly extend controllable rotary motion range around the Z axis.

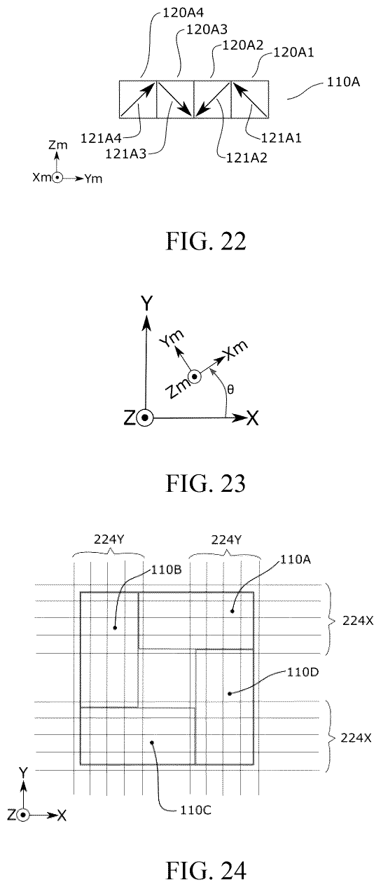

FIG. 21 shows a particular embodiment of a mover 100. The mover 100 includes a magnet assembly including four magnet arrays 110A, 110B, 110C, and 110D. Each of the magnet arrays 110A, 110B, 110C, and 110D includes a plurality of linearly elongated magnetization segments (such as permanent magnets, for example), each having a magnetization direction that may be orthogonal to its elongation direction. For example, the magnet array 110A includes magnetization segments 120A1, 120A2, 120A3, and 120A4 as shown in FIG. 21 and in FIG. 22. As shown in FIG. 22, the magnetization segments 120A1, 120A2, 120A3, and 120A4 may have magnetization directions 121A1, 121A2, 121A3, and 121A4. Each such magnetization segment may include a plurality of magnet pieces, which may be oriented in a particular pattern to generate a strong magnetic force on the bottom side of the mover. In this particular non-limiting embodiment, each magnet array includes four magnets, but alternative embodiments may include more, fewer, or different magnets.

FIG. 23 shows two coordinate systems that may describe some embodiments. As indicated above, Cartesian axes identified as X, Y, and Z may be fixed relative to a stator, and Cartesian axes identified as Xm, Ym, and Zm may be fixed relative to a mover such as the mover 100. However, alternative embodiments may differ, and embodiments such as those described herein are not limited to or limited by any particular axes. A relative angle between the stator and mover axes X and Xm when projected onto the XY plane of the stator work surface may be defined as θm. This angle θm may be utilized in other embodiments to describe the relative orientation between the two coordinate systems.

FIG. 24 shows a mover-stator interaction according to one embodiment in which the magnet arrays 110A and 110C interact with the electrical conductors 224X and the magnet arrays 110B and 110D interact with the electrical conductors 224Y. In such an embodiment, the electrical conductors 224X and the electrical conductors 224Y may cause rotation of the mover 100 around the Z axis by about 15° in either direction around the Z axis such that −15°<θm<15°.

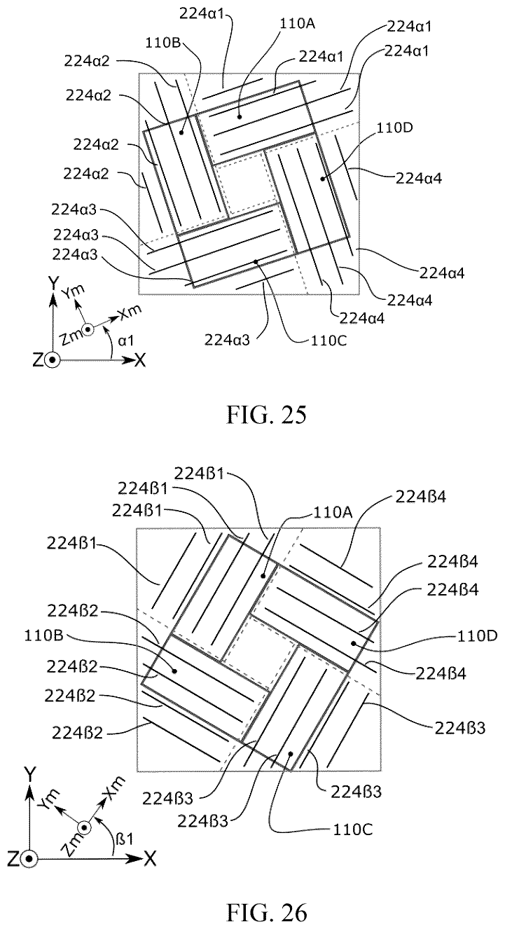

FIG. 25 shows a mover-stator interaction according to another embodiment in which the magnet array 110A interacts with the electrical conductors 224α1, the magnet array 110B interacts with the electrical conductors 224α2, the magnet array 110C interacts with the electrical conductors 224α3, and the magnet array 110D interacts with the electrical conductors 224α4. Again, in such an embodiment, the electrical conductors 224α1, 224α2, 224α3, and 224α4 may cause rotation of the mover 100 around the Z axis by about 15° in either direction around the Z axis such that α1−15°<θm<α1+15°.

Therefore, the magnet arrays 110A and 110C may interact with the electrical conductors 224X and the magnet arrays 110B and 110D may interact with the electrical conductors 224Y to rotate the mover 100 from the orientation shown in FIG. 24 towards the orientation shown in FIG. 25, and then the magnet arrays 110A, 110B, 110C, and 110D may interact with the electrical conductors 224α1, 224α2, 224α3, and 224α4 to rotate the mover 100 towards the orientation shown in FIG. 25, so that the electrical conductors 224X, 224Y, 224α1, 224α2, 224α3, and 224α4 may be controlled to cause the mover 100 to rotate from the orientation shown in FIG. 24 to the orientation shown in FIG. 25.

FIG. 26 shows a mover-stator interaction according to another embodiment in which the magnet array 110A interacts with the electrical conductors 224β1, the magnet array 110B interacts with the electrical conductors 224β2, the magnet array 110C interacts with the electrical conductors 224β3, and the magnet array 110D interacts with the electrical conductors 224β4. Again, in such an embodiment, the electrical conductors 224β1, 224β2, 224β3, and 224β4 may cause rotation of the mover 100 around the Z axis by about 15° in either direction around the Z axis such that β1−15°<θm<β1+15°.

Therefore, the magnet arrays 110A, 110B, 110C, and 110D may interact with the electrical conductors 224α1, 224α2, 224α3, and 224α4 to rotate the mover 100 from the orientation shown in FIG. 25 towards the orientation shown in FIG. 26, and then the magnet arrays 110A, 110B, 110C, and 110D may interact with the electrical conductors 224β1, 224β2, 224β3, and 224β4 to rotate the mover 100 towards the orientation shown in FIG. 26, so that the electrical conductors 224α1, 224α2, 224α3, 224α4, 224β1, 224β2, 224β3, and 224β4 may be controlled to cause the mover 100 to rotate from the orientation shown in FIG. 25 to the orientation shown in FIG. 26.

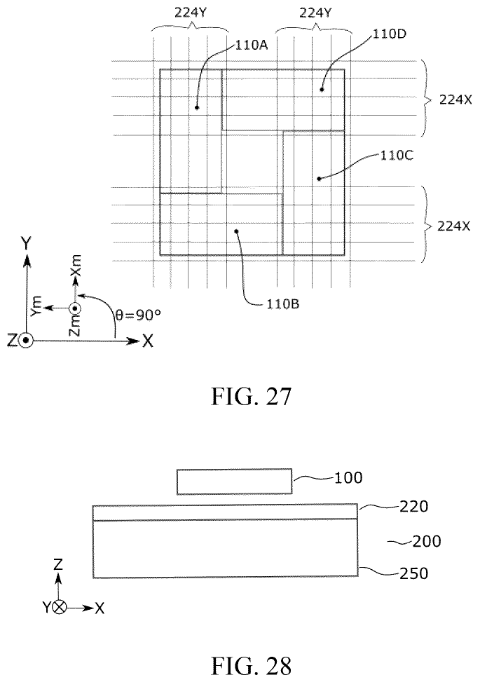

FIG. 27 shows a mover-stator interaction according to one embodiment in which the magnet arrays 110A and 110C interact with the electrical conductors 224Y and the magnet arrays 110B and 110D interact with the electrical conductors 224X. In such an embodiment, the electrical conductors 224X and the electrical conductors 224Y may cause rotation of the mover 100 around the Z axis by about 15° in either direction around the Z axis such that 75°<θm<105°.

Therefore, the magnet arrays 110A, 110B, 110C, and 110D may interact with the electrical conductors 224β1, 224β2, 224β3, and 224β4 to rotate the mover 100 from the orientation shown in FIG. 26 towards the orientation shown in FIG. 27, and then the magnet arrays 110A and 110C may interact with the electrical conductors 224Y and the magnet arrays 110B and 110D may interact with the electrical conductors 224X to rotate the mover 100 towards the orientation shown in FIG. 27, so that the electrical conductors 224β1, 224β2, 224β3, 224β4, 224X, and 224Y may be controlled to cause the mover 100 to rotate from the orientation shown in FIG. 26 to the orientation shown in FIG. 27.

As shown in the examples from FIG. 24 to FIG. 27, the motor sub-module of FIG. 17 may rotate the mover 100 90° around the Z axis (or around an axis orthogonal or nonparallel to the working surface of a stator module including the motor sub-module of FIG. 17). More generally, the motor sub-module of FIG. 17 may rotate the mover 100 to any rotational position around the Z axis (or around an axis orthogonal or nonparallel to the working surface of a stator module including the motor sub-module of FIG. 17) by repeating variations of the examples from FIG. 24 to FIG. 27.

Of course the embodiments described above are examples only, and alternative embodiments may include other electrical conductors in one or more other of the same or different layers.

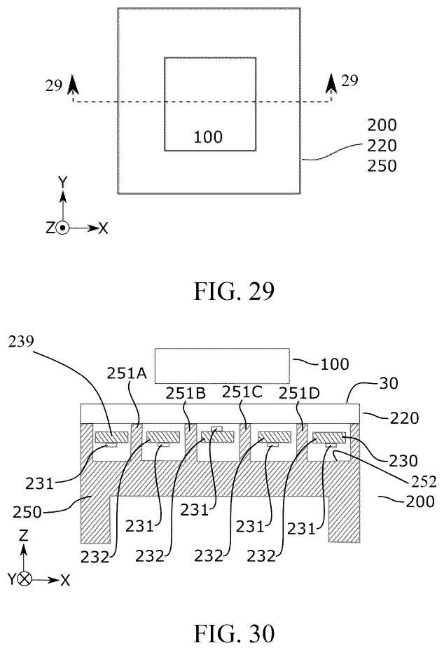

FIG. 28, FIG. 29, and FIG. 30 illustrate a robotic or displacement system according to another embodiment and including a stator module 200 and a mover 100. The stator module 200 includes a working surface 30 and motor sub-module 220, which may be similar to the motor sub-modules described above and may include a plurality of electrical conductors in one or more layers as described above. The stator module 200 also includes a stator body 250 supporting the sub-modules and the working surfaces of the stator module.

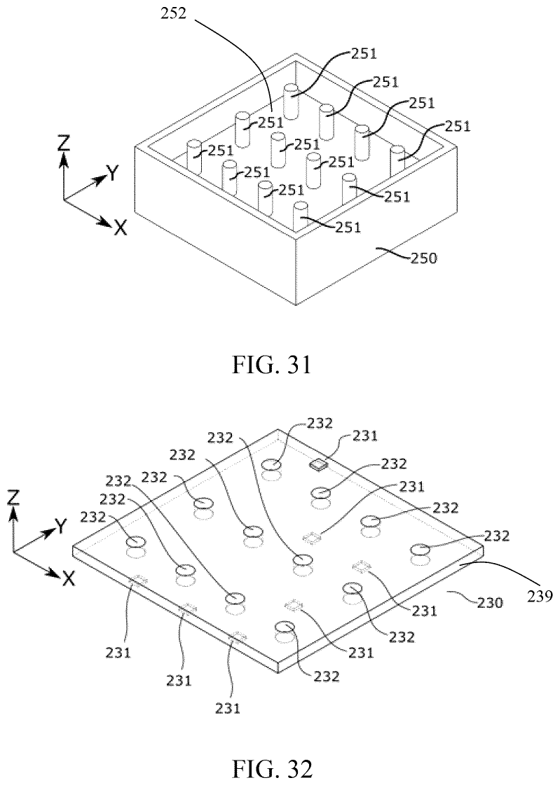

As shown in FIG. 30 and FIG. 31, protrusions 251 (also shown as protrusions 251A, 251B, 251C, and 251D) protrude from a surface 252 of the stator body 250 and towards the motor sub-module 220. The protrusions 251 may be attached to the motor sub-module 220 directly or indirectly (by an attachment such as, without limitation, bonding, potting, welding, or soldering) to support the motor sub-module 220 relative to the stator body 250. Although the protrusions 251 are shown to be round, alternative embodiments may include other shapes such as square, rectangle, triangle, octagon, or hexagon, for example.

As shown in FIG. 30 and FIG. 32, the stator module 200 includes a position-sensor sub-module 230, which includes a planar position-sensor body 239 defining through-holes 232 positioned to receive respective ones of the protrusions 251 when the position-sensor sub-module 230 is positioned between the surface 252 (from which the protrusions 251 protrude) and the motor sub-module 220. The position-sensor sub-module 230 at least one position sensor 231 on the position-sensor body 239. In general, one or more position sensors 231 may facilitate sensing a position of the mover 100 based on one or more physics principles such as, but not limited to, optical, capacitive, eddy current, inductive, magnetic, resistive, or a combination of two or more thereof.

In general, the protrusions 251 may transfer forces from the motor sub-module 220 to a portion of the stator body 250 on an opposite side of the position-sensor sub-module 230 from the motor sub-module 220. The portion of the stator body 250 on the opposite side of the position-sensor sub-module 230 from the motor sub-module 220 may be relatively large, the protrusions 251 may allow the motor sub-module 220 to be supported by a relatively large portion of the stator body 250 while allowing the position-sensor sub-module 230 to be relatively close to the motor sub-module 220. Further, any forces applied on the motor sub-module 220 by the mover 100 may be directly transferred to the portion of the stator body 250 on the opposite side of the position-sensor sub-module 230 from the motor sub-module 220 without being transferred to the position-sensor sub-module 230. In other words, the protrusions 251 may create load paths between the motor sub-module 220 and the portion of the stator body 250 on the opposite side of the position-sensor sub-module 230 from the motor sub-module 220 that may not necessarily transmit loads to the position-sensor sub-module 230, which may protect the position-sensor sub-module 230 from receiving potentially damaging load forces such that mechanical stress on the position-sensor sub-module 230 may be reduced, which may avoid damage to the position-sensor sub-module 230.

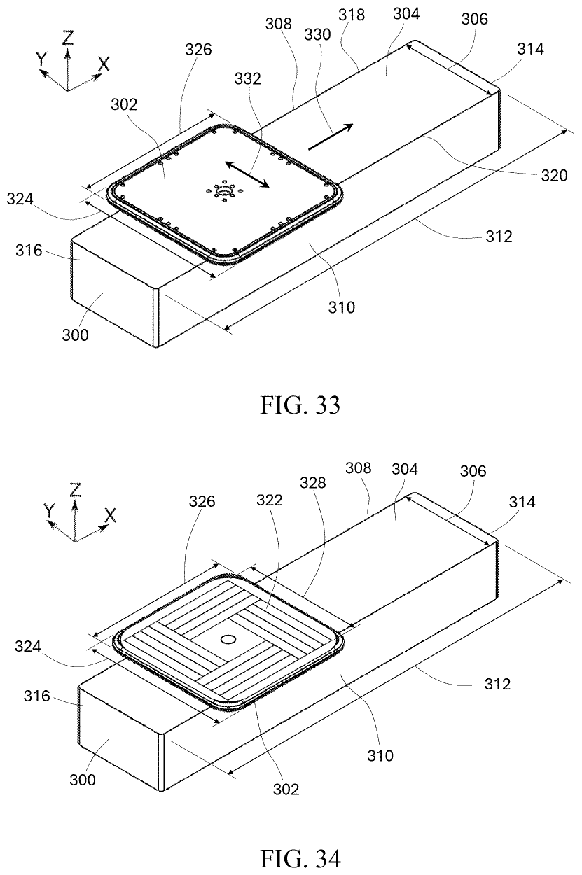

FIGS. 33 and 34 illustrate a robotic or displacement system according to another embodiment and including a stator 300 and a wide magnetized mover 302. The stator 300 may generally be similar to the stators described above (such as, for example, the stator 20 and/or the stator 200) and includes a working surface 304 and one or more stator modules such as those described above (for example, such as the stator module 200A, the stator module 200D, the stator module 200E, the stator module 200F, and/or the stator module 200G). The working surface 304 of the embodiment shown in FIGS. 33 and 34 is rectangular, but of course alternative embodiments may differ. In other words, in the embodiment shown, for example, the working surface 304 has a working surface width 306 in a first working surface dimension (along the Y axis in this embodiment) between exposed opposite sides 308 and 310 of the stator 300, and has a working surface length 312 in a second, different, working surface dimension (along the X axis in this embodiment) between opposite ends 314 and 316 of the stator 300, and the working surface length 312 is greater than the working surface width 306. More specifically, in the embodiment shown, the working surface 304 extends the working surface width 306 between a first edge 318 of the working surface 304 along the exposed side 308 of the stator 300 and a second edge 320 of the working surface 304 along the exposed side 310 of the stator 300.

As explained above (for example, with reference to FIG. 3), the one or more stator modules of the stator 300 may each include electrical conductors that may be operable to generate a magnetic field to facilitate moving, relative to the working surface 304, a magnetized mover—such as the magnetized mover 302—in the magnetic field along (or otherwise relative to) the working surface 304 in response to electrical currents through the electrical conductors. Thus, as also explained above, the stator 300 may be operable to, for example, move the magnetized mover 302 in one, two, three, four, five, or six degrees of freedom along the working surface 304, and/or levitate the magnetized mover 302 relative to the working surface 304. In the embodiment shown, the one or more stator modules of the stator 300 may use a conductor group layout one unit wide and more than one unit long.

The magnetized mover 302 may generally be similar to the movers described above (such as, for example, the mover 100 of the embodiment of FIGS. 21 and 22 or the mover 100 of the embodiment of FIGS. 28, 29, and 30) and includes a magnet assembly 322 which includes one or more magnet arrays rigidly connected together. FIG. 34 shows the magnetized mover 302 without a top cover such that the magnet assembly 322 is exposed. Each of the one or more magnet arrays includes one or more magnetization elements, with each magnetization element having a magnetization direction. A magnetization element may be, for example, a permanent magnet. That is, in the embodiment shown, the magnet assembly 322, and thus the magnetized mover 302, includes one or more magnets rigidly connected together.

The magnetized mover 302 of the embodiment shown in FIGS. 33 and 34 has a mover width 324 in a first mover direction (for example, parallel to the Y axis when the magnetized mover 302 is oriented as shown in FIGS. 33 and 34) and a mover length 326 in a second mover direction (for example, parallel to the X axis when the magnetized mover 302 is oriented as shown in FIGS. 33 and 34) different from the first mover direction. More specifically, in the embodiment shown, the first mover direction (parallel to the Y axis) is perpendicular to the second mover direction (parallel to the X axis) and the mover width 324 is approximately equal or equal to the mover length 326. Even more specifically, in the embodiment shown, the magnetized mover 302 is generally square-shaped. Of course, alternative embodiments may differ, and may include a mover with a different shape, such as, for example, a mover which is generally rectangular.

In the embodiment shown in FIGS. 33 and 34, the magnetized mover 302 is wider than the working surface 304 of the stator 300. That is, the mover width 324 is greater than the working surface width 306. Moreover, because the mover width 324 is approximately equal or equal to the mover length 326, the mover length 326 is also greater than the working surface width 306. However, in the embodiment shown, each of the mover width 324 and the mover length 326 is less than the working surface length 312.

Additionally, in the embodiment shown, the magnet assembly 322 of the magnetized mover 302 is wider than the working surface 304 of the stator 300. That is, the one or more magnets of the magnet assembly 322 collectively extend—and thus the magnet assembly 322 itself extends-by a magnet width 328 in the first mover direction (parallel to the Y axis), and this magnet width 328 is greater than the working surface width 306. Of course, alternative embodiments may differ. For example, some alternative embodiments may include a mover having a mover width greater than the working surface width but a magnet width less than the working surface width.

During operation, the stator 300 may generate one or more magnetic fields to cause the magnetized mover 302 to move along the working surface 304 while overhanging—that is, extending beyond—the working surface 304. For example, as shown in FIG. 33, the stator 300 may move the magnetized mover 302 in a movement direction 330 while orienting the magnetized mover 302 such that the mover width 324 is aligned with the working surface width 306—-that is, such that the first mover direction is aligned with the first working surface dimension (along the Y axis in this embodiment). Because the mover width 324 is greater than the working surface width 306, in at least this orientation of the magnetized mover 302, the magnetized mover 302 extends further than the working surface 304 in an overhang direction 332 along the working surface 304 that is aligned with the first mover direction and with the first working surface dimension (and thus with the Y axis in this embodiment). That is, the stator 300 may generate one or more magnetic fields to cause the magnetized mover 302 to move along the working surface 304 in the movement direction 330 such that, as the magnetized mover 302 moves along the working surface 304 in the movement direction 330, the magnetized mover 302 extends, in the overhang direction 332, a mover extent—that is, the mover width 324—which is greater than a working surface extent—that is, the working surface width 306—in the overhang direction 332. In the embodiment shown, the movement direction extends between the opposite ends 314 and 316 of the stator 300 and the overhang direction 332 is transverse—and, more specifically, perpendicular—to the movement direction 330. Also in the embodiment shown, as the magnetized mover 302 moves along the working surface 304 in the movement direction 330, the magnetized mover 302 extends, in the overhang direction 332, beyond both the exposed side 308 of the stator 300 and the exposed side 310 of the stator 300. For example, the stator 300 may control the magnetized mover 302 to maintain a position as close as possible to evenly between the first edge 318 and the second edge 320 of the working surface 304. However, alternative embodiments may differ. For example, in some alternative embodiments, the magnetized mover 302 may move in a movement direction which does not necessarily extend between the opposite ends 314 and 316 of the stator 300, and/or the magnetized mover 302 may overhang the working surface 304 in an overhang direction which is not perpendicular or not transverse to the movement direction. In some alternative embodiments, the magnetized mover 302 may extend beyond only one of the exposed sides 308 and 310 of the stator 300 as it moves along the working surface 304.

As noted above, in the embodiment shown in FIGS. 33 and 34, the magnet assembly 322 of the magnetized mover 302 is wider than the working surface 304 of the stator 300. Therefore, when the stator 300 moves the magnetized mover 302 in the movement direction 330 while orienting the magnetized mover 302 such that the mover width 324—and thus the magnet width 328—is aligned with the working surface width 306, the magnet assembly 322 extends further than the working surface 304 in the overhang direction 332 and thus overhangs the working surface 304. That is, the stator 300 may generate one or more magnetic fields to cause the magnetized mover 302 to move along the working surface 304 in the movement direction 330 such that, as the magnetized mover 302 moves along the working surface 304 in the movement direction 330, the magnet assembly 322 of the magnetized mover 302 extends, in the overhang direction 332, a magnet extent—that is, the magnet width 328—which is greater than a working surface extent—that is, the working surface width 306—in the overhang direction 332. In such embodiments where the magnet assembly 322 of the magnetized mover 302 is wider than the working surface 304 of the stator 300, the magnet assembly 322 may have a reduced effective area when operating along the working surface 304 while overhanging the working surface 304, and thus a performance and/or weight capacity of the magnetized mover 302 may be reduced accordingly. Therefore, in embodiments such as the embodiment shown in FIGS. 33 and 34, the stator 300 may be used to move the magnetized mover 302 when the magnetized mover 302 is not loaded or is empty. For example, such embodiments may be utilized to return empty magnetized movers to a loading area. As a more specific example, the stator 300 and the magnetized mover 302 may be part of a larger robotic/displacement system including one or more other stators. The one or more other stators may move the magnetized mover 302, while it is loaded, to an unloading position on a working surface of the one or more other stators. At that unloading position, the magnetized mover 302 may be unloaded and subsequently moved to the working surface 304 of the stator 300. The stator 300 may then move the magnetized mover 302 in the movement direction 330 along the working surface 304, with the magnetized mover 302 overhanging the working surface 304 as described above, in order to return the magnetized mover 302 to a loading area of the robotic/displacement system.

Embodiments such as the embodiment shown in FIGS. 33 and 34, where a magnetized mover and/or a magnet assembly of the magnetized mover is wider than a working surface of a stator, may be more cost-efficient and/or more flexible than robotic/displacement systems with wider stators. For example, such embodiments may require a reduced number and/or size of stators/stator modules to move movers a given distance. Such embodiments may also permit more flexibility when arranging stators and/or stator modules, due to the relatively lower stator width.

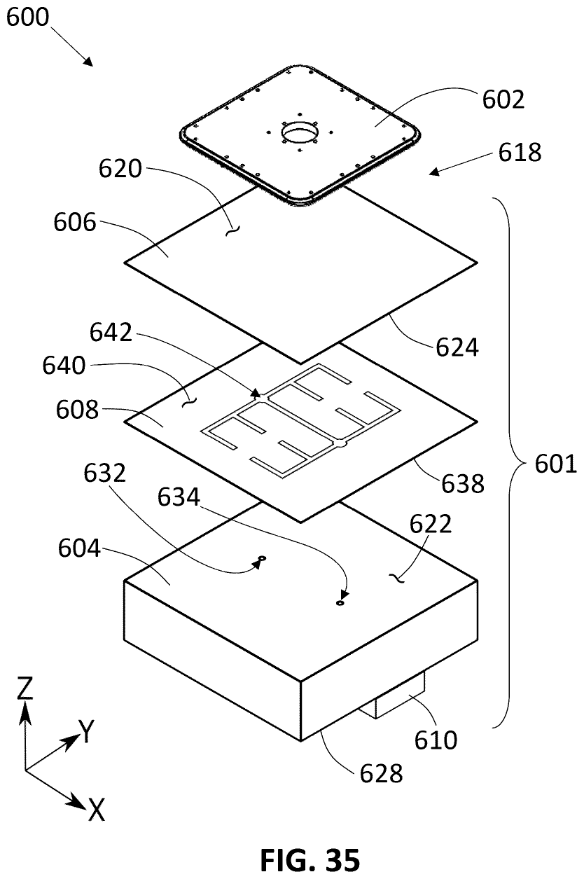

Referring now to FIGS. 35 to 38, a displacement system according to another embodiment is shown generally at 600 and includes a mover 602, a stator 604, a stator cover 606, a spacer 608, and a vacuum source 610. In general, the stator 604, the stator cover 606, the spacer 608, and the vacuum source 610 may collectively be referred to as a stator device 601. The mover 602 may generally be similar to the movers described above (such as, for example, the mover 100 of the embodiment of FIGS. 21 and 22, the mover 100 of the embodiment of FIGS. 28, 29, and 30, or the mover 302 of the embodiment of FIGS. 33 and 34) and includes one or more magnets 612 rigidly connected together. Likewise, the stator 604 may generally be similar to the stators described above (such as, for example, the stator 20, the stator 200, or the stator 300) and includes a stator body 614 and electrical conductors 616 that are operable to generate, in response to electrical currents through the electrical conductors 616, one or more external magnetic fields to facilitate moving a magnetized mover, such as the mover 602, relative to the stator 604.

The stator cover 606 overlays the stator 604 and may be held to the stator 604, functioning as a barrier between the stator 604 and a working environment of the mover 602, shown generally at 618. That is, the stator cover 606 may be positioned between the stator 604 and the working environment 618 and may be held to the stator 604 to maintain separation between the stator 604 and the working environment 618. In some embodiments, such separation may isolate the stator 604 from the working environment 618. The working environment 618 is generally a space, external to the stator 604, in which the mover 602 moves during operation-for example, when carrying a component. That is, in the working environment 618, magnetic fields generated by the electrical conductors 616 of the stator 604 may control movement of the mover 602. In some embodiments, the stator cover 606 may protect the stator 604 from adverse conditions in the working environment 618, such as humidity, liquids, and/or corrosive environments. In some embodiments, the stator cover 606 may protect the working environment 618 from contamination. In some embodiments, the stator cover 606 may be made up of a rigid, non-magnetic material such as but not limited to an austenitic stainless steel, titanium, aluminum, or an aluminum alloy. In some embodiments, the stator cover may be at least 0.2 mm thick. In some embodiments, the stator cover may be at most 2 mm thick. In some embodiments, the stator cover may be about 0.5 mm thick.

The stator cover 606 includes a working surface 620 for the mover 602 to move upon. Generally, the working surface 620 describes a continuous area of the stator cover 606 upon which the mover 602 may be controlled by the stator 604 in the working environment 618. That is, when the stator cover 606 overlays and/or is held to the stator 604, the working surface 620 is between the stator 604 and the working environment 618, and is thus between the stator 604 and the mover 602 when the mover 602 is being controlled by the stator 604 (that is, when the mover 602 is moving in response to external magnetic fields generated by the electrical conductors 616 of the stator 604). The stator 604 may be operable to move the mover 602 in one, two, three, four, five, or six degrees of freedom in the working environment 618 along the working surface 620, and/or levitate the magnetized mover 602 relative to the working surface 620. The working surface 620 may be flat, curved, cylindrical, spherical or some other shape that allows the mover 602 to move along the working surface 620. In some embodiments, a combined working surface may be defined by a plurality of stators each having a respective stator cover, such that each working surface of each stator cover may be combined into a larger combined working surface. In other embodiments, a single stator cover may overlay a plurality of stators, forming a single continuous working surface. While the working surface 620 is depicted horizontally in FIGS. 35 to 37, it should be understood that the working surface 620 may be mounted vertically or at an angle to gravity.

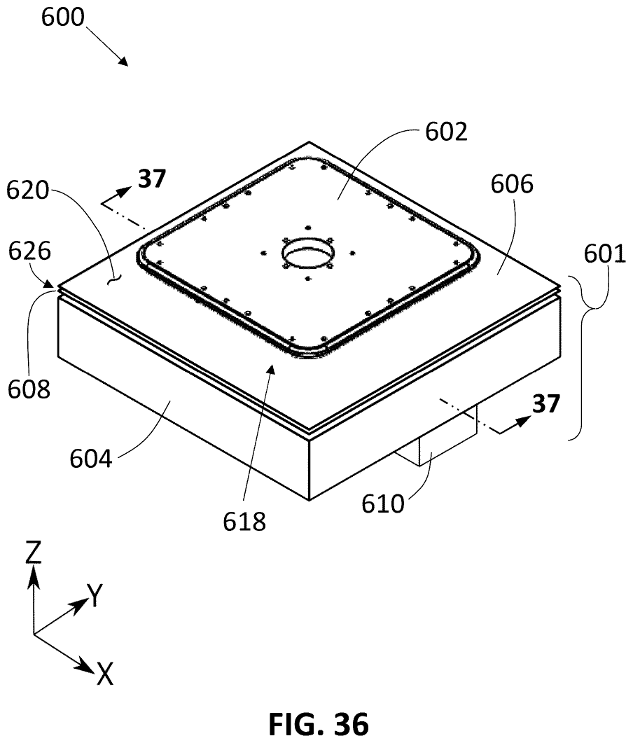

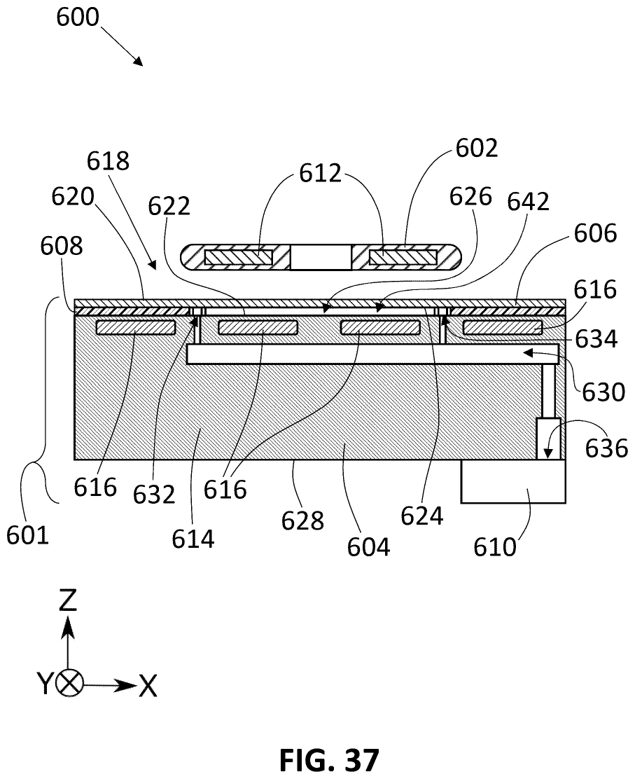

The stator body 614 of the stator 604 includes a holding surface 622 which faces the stator cover 606 and thus faces the working environment 618. Correspondingly, the stator cover 606 includes a stator-facing surface 624 which faces the holding surface 622 of the stator 604. As shown in FIG. 37, the stator-facing surface 624 is across the stator cover 606 from the working surface 620. With the stator cover 606 overlaying the stator 604 as shown in FIGS. 36 and 37, or—more generally—with the stator cover 606 positioned proximate the stator 604, the holding surface 622 of the stator 604 and the stator-facing surface 624 of the stator cover 606 define a space, shown generally at 626, therebetween. In the embodiment shown, the spacer 608 is positionable on the holding surface 622 of the stator 604 in the space 626 between the holding surface 622 and the stator-facing surface 624 of the stator cover 606. Thus positioned, the spacer 608 prevents direct contact between the holding surface 622 of the stator 604 and the stator-facing surface 624 of the stator cover 606. However, alternative embodiments may differ. For example, some alternative embodiments may not include a spacer such as the stator 608, and in some such alternative embodiments the holding surface 622 of the stator 604 may be able to directly contact the stator-facing surface 624 of the stator cover 606. More generally, a size of the space 626 will vary depending on the proximity of the stator cover 606 to the stator 604, and in some alternative embodiments the space 626 may be infinitesimally small when the holding surface 622 of the stator 604 directly contacts the stator-facing surface 624 of the stator cover 606.

In the embodiment shown, the stator cover 606—and more specifically, the stator-facing surface 624 of the stator cover 606—generally conforms to the holding surface 622 of the stator 604. More specifically, in the embodiment shown, both the stator-facing surface 624 of the stator cover 606 and the holding surface 622 of the stator 604 are generally flat/planar. However, alternative embodiments may differ. For example, in some alternative embodiments, the stator-facing surface 624 of the stator cover 606 may, at least at some positions, diverge from the holding surface 622 of the stator 604.

Furthermore, in the embodiment shown, the stator cover 606 covers and thus protects a majority of the holding surface 622 of the stator 604 when the stator cover 606 is held to the stator 604. More specifically, in the embodiment shown, the stator-facing surface 624 has a stator-facing-surface area which is at least 75% of a holding-surface surface area of the holding surface 622, such that when the stator cover 606 is aligned with the holding surface 622 and held to the stator 604, the the stator cover 606 covers at least 75% of the holding surface 622. In some embodiments, stator-facing-surface area may be at least 80% of the holding-surface surface area, such that when the stator cover 606 is aligned with the holding surface 622 and held to the stator 604, the the stator cover 606 covers at least 80% of the holding surface 622. In some embodiments, stator-facing-surface area may be at least 90% of the holding-surface surface area, such that when the stator cover 606 is aligned with the holding surface 622 and held to the stator 604, the the stator cover 606 covers at least 90% of the holding surface 622. In some embodiments, stator-facing-surface area may be substantially equal to the holding-surface surface area, such that when the stator cover 606 is aligned with the holding surface 622 and held to the stator 604, the the stator cover 606 covers substantially all of the holding surface 622.

The stator body 614 of the stator 604 further includes an access surface 628 which is different from the holding surface 622. In the embodiment shown, the access surface 628 is across the stator body 614 from the holding surface 622. The stator body 614 also defines an internal conduit shown generally at 630. The internal conduit 630 includes conduit openings, shown generally at 632 and 634, in the holding surface 622, and an access opening, shown generally at 636, in the access surface 628. Through the internal conduit 630, the conduit openings 632 and 634 are in fluid communication with the access opening 636. Therefore, for example, fluid may flow from the holding surface 622 to the access surface 628 through one or both of the conduit openings 632 and 634, at least a portion of the internal conduit 630, and the access opening 636. As shown in FIG. 37, the internal conduit 630 of the embodiment shown extends to the holding surface 622 of the stator 604 through the stator body 614 between adjacent ones of the electrical conductors 616. Such positioning of the internal conduit 630 may minimize any disruption to performance of the electrical conductors 616 (that is, in generating one or more external magnetic fields to move the mover 602). In some embodiments, an internal conduit similar to the internal conduit 630 may also or instead extend to the holding surface 622 through a central portion of one or more of the electrical conductors 616.

The vacuum source 610 is generally operable to remove fluid from the space 626 between the holding surface 622 of the stator 604 and the stator-facing surface 624 of the stator cover 606 in order to cause a first fluid pressure in the space 626 to be lower than a second fluid pressure at the working surface 620 of the stator cover 606—that is, in order to cause the first fluid pressure in the space 626 to be lower than a fluid pressure in the working environment 618. More specifically, in the embodiment shown, the vacuum source 610 is in fluid communication with the internal conduit 630 through the access opening 636, and is thus in fluid communication with the space 626 through the the access opening 636, the internal conduit 630, and the conduit openings 632 and 634, and is therefore operable to remove at least some fluid from the space 626 through one or both of the conduit openings 632 and 634, at least a portion of the internal conduit 630, and the access opening 636. In some embodiments, the vacuum source 610 may be or may include a vacuum pump. In some embodiments, the vacuum source 610 may be or may include a vacuum accumulator. In some embodiments, the vacuum source 610 may include both a vacuum pump and a vacuum accumulator. In some embodiments, some or all of the vacuum source 610 may be removable/detachable from the stator device 601 (for example, for use with other stator devices). The vacuum source 610 may be controlled to regulate the first fluid pressure in the space 626 by, for example, a controller (such as the module controller 500A of the embodiment of FIG. 4) and/or a control system (such as the control system 400 of the embodiment of FIG. 4) in communication with the vacuum source 610. In the embodiment shown, the vacuum source 610 is positioned to be in contact with the access surface 628 of the stator 604 at the access opening 636. However, alternative embodiments may differ. For example, some alternative embodiments may include a vacuum source spaced apart from the stator 604 and in fluid communication with the internal conduit 630 through the access opening 636 via an external conduit between the vacuum source and the access opening 636.

When the vacuum source 610 removes fluid from the space 626 and thus causes the first fluid pressure in the space 626 to be lower than the second fluid pressure at the working surface 620 of the stator cover 606, the resulting pressure difference between the—lower—first fluid pressure and the—higher—second fluid pressure may urge the stator cover 606 toward the holding surface 622 of the stator 604 and may thus hold the stator cover 606 to the stator 604. That is, this pressure difference may generate suction between the holding surface 622 of the stator 604 and the stator-facing surface 624 of the stator cover 606. Thus, by causing the first fluid pressure in the space 626 to be lower than the second fluid pressure at the working surface 620, the vacuum source 610 is ultimately operable to cause the stator cover 606 to be held to the stator 604. The vacuum source 610 may, for example, cause the stator cover 606 to be held to the stator 604 in this way when the stator 604 is controlling movement of the mover 602 in the working environment 618 during operation of the displacement system 600. In some embodiments, the vacuum source 610 may further be operable to cause or allow the first fluid pressure in the space 626 to be equal to or greater than the second fluid pressure at the working surface 620 to release the stator cover 606 from the stator 604.

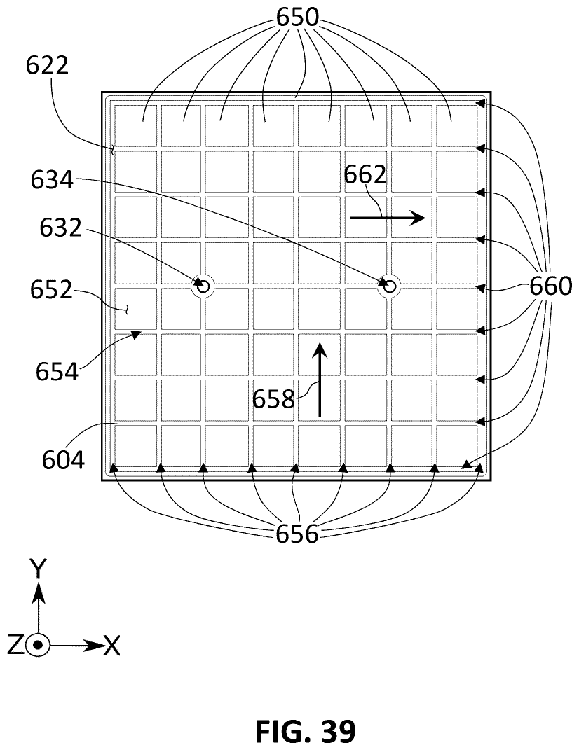

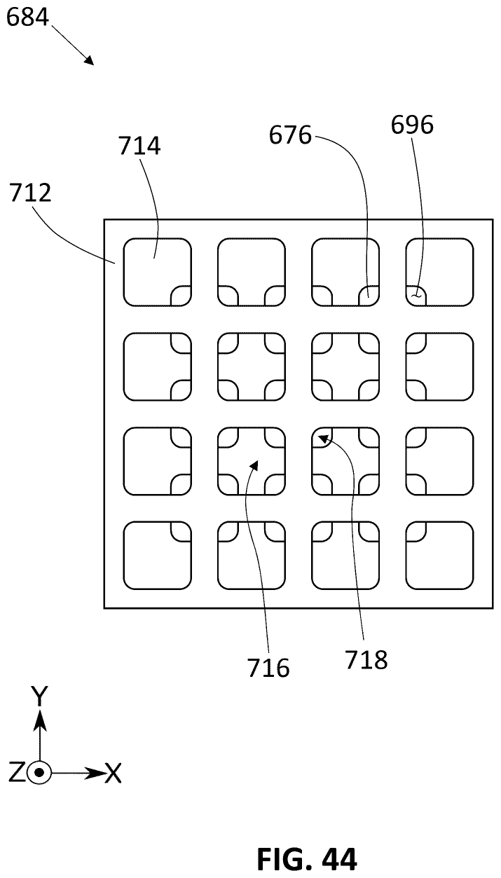

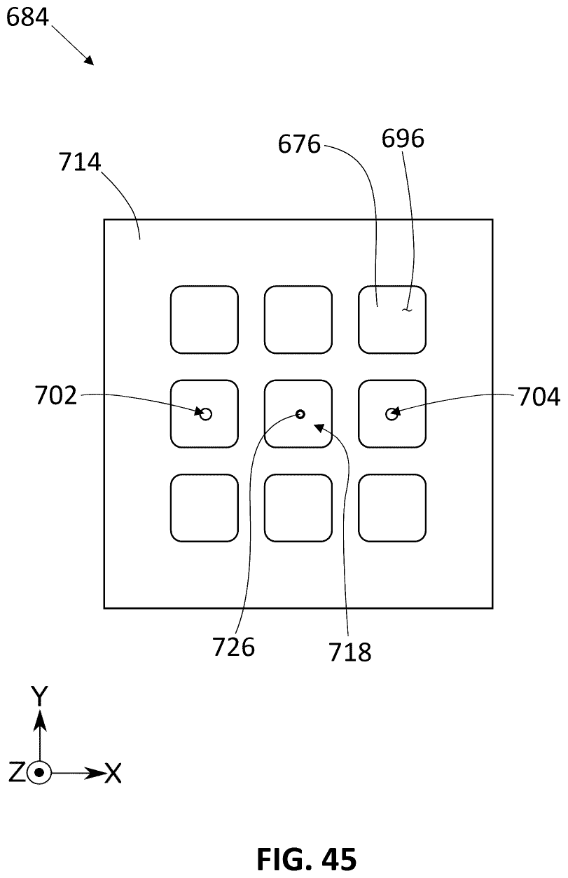

Still referring to FIGS. 35 to 38, in the embodiment shown, the spacer 608 is a solid body positionable on the holding surface 622 of the stator 604 to be in the space 626 between the holding surface 622 and the stator-facing surface 624 of the stator cover 606 at least when the stator cover 606 overlays the stator 604 as shown in FIGS. 36 and 37. In some embodiments, the spacer 608 may be attached or attachable to the holding surface 622. For example, in some such embodiments, the spacer 608 may be attached or attachable to the holding surface 622 by an adhesive. In some embodiments, the spacer 608 may include stainless steel, vinyl, and/or thermoplastic polyurethane. In the embodiment shown in FIGS. 35 to 38, the spacer 608 is unitary—that is, made up of a single part. However, alternative embodiments may differ and may include a spacer made up of multiple parts and/or more than one spacer (see, for example, FIGS. 39 to 45).

The spacer 608 includes a base surface 638 and a contact surface 640 across the spacer 608 from the base surface 638. The base surface 638 is positioned to contact the holding surface 622 of the stator 604 when the spacer 608 is positioned on the holding surface 622, and the contact surface 640 is positioned to contact the stator-facing surface 624 of the stator cover 606 when the stator cover 606 is held to the stator 604. In some embodiments, a distance between the base surface 638 and the contact surface 640—that is, a thickness of the spacer 608—may be between 0.2 mm and 0.6 mm. For example, in some embodiments, the spacer may have a thickness between 0.3 mm and 0.5 mm.

The spacer 608 also defines a cavity, shown generally at 642, extending through the spacer 608 from the base surface 638 to the contact surface 640. The cavity 642 is open to both the base surface 638 and the contact surface 640 and, in the embodiment shown, when the spacer 608 is positioned on the holding surface 622, the cavity 642 is in fluid communication with the conduit openings 632 and 634. As such, in the embodiment shown, when the stator cover 606 overlays the stator 604 to define the space 626 and the spacer 608 is positioned on the holding surface 622, as shown in FIGS. 36 and 37, the space 626 includes the cavity 642 and the vacuum source 610 is operable to remove fluid from the cavity 642 through one or both of the conduit openings 632 and 634 to cause the first fluid pressure in the cavity 642—and thus in the space 626—to be lower than the second fluid pressure at the working surface 620 and thus to urge the stator cover 606 toward the holding surface 622 to hold the stator cover 606 to the stator 604. In the embodiment shown, when the stator cover 606 is thus held to the stator 604, the spacer 608 supports the stator cover 606 on the holding surface 622 and seals the space 626 within the cavity 642 from an exterior of the stator 604. In some embodiments, the spacer 608 may deform in response to the stator cover 606 being thus held to the stator 604 in order to seal the space 626 within the cavity 642 from the exterior of the stator 604.

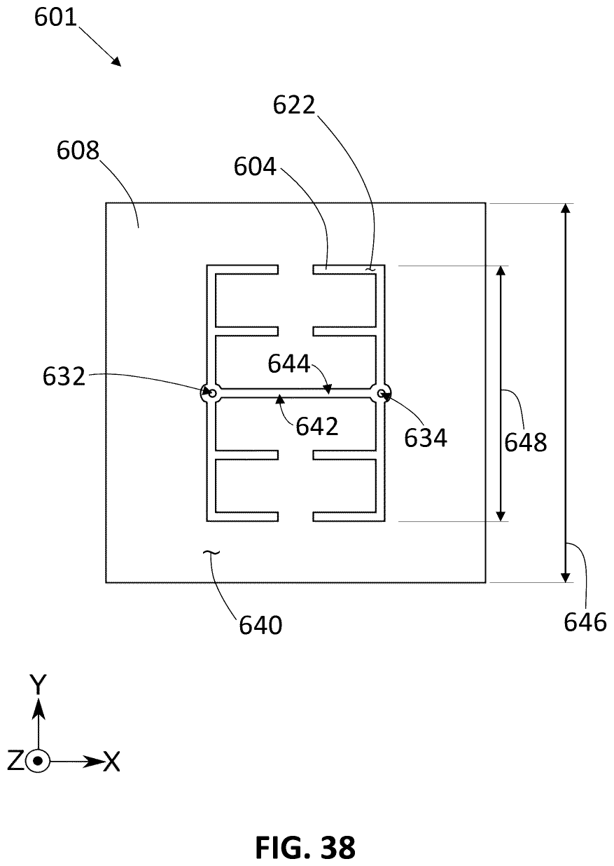

As noted above, in the embodiment shown, the cavity 642 is open to the contact surface 640 of the spacer 608. More specifically, the cavity 642 includes a cavity opening, shown generally at 644, in the contact surface 640. When the stator cover 606 overlays the stator 604, the cavity opening 644 exposes the cavity 642 to the stator-facing surface 624 of the stator cover 606, and thus exposes the stator-facing surface 624 to the first fluid pressure in the cavity 642. As explained above, the pressure difference between the first fluid pressure—in the cavity 642 and at the the stator-facing surface 624—and the second fluid pressure—at the working surface 620 of the stator cover 606—generates suction which may urge the stator cover 606 toward the holding surface 622 of the stator 604 and thus hold the stator cover 606 to the stator 604. As shown in FIG. 38, the cavity opening 644 extends throughout the contact surface 640 of the spacer 608 away from the conduit openings 632 and 634, thus exposing a greater area of the stator-facing surface 624 across a greater extent thereof to the first fluid pressure than would be exposed if, for example, the spacer 608 were absent and the holding surface 622 of the stator 604 directly contacted the stator-facing surface 624 of the stator cover 606 when the stator cover 606 was held to the stator 604—in the latter case, the stator-facing surface 624 might only be exposed to the first fluid pressure at or near the conduit openings 632 and 634. By increasing the amount and the extent of the stator-facing surface 624 of the stator cover 606 exposed to the first fluid pressure in this way, the spacer 608 of the embodiment shown (with the cavity 642 and the cavity opening 644 as shown in FIG. 38) may effectively increase both an amount and a distribution, across the stator-facing surface 624, of suction generated by the pressure difference between the first and second fluid pressures, and may thus improve the holding of the stator cover 606 to the stator 604 by the vacuum source 610.

As shown in FIG. 38, the contact surface 640 of the spacer 608 extends a contact-surface extent 646 along the Y axis along the cover facing surface 622 of the stator 604, while the cavity opening 644 of the spacer 608 extends a cavity-opening extent 648 along the Y axis along the cover facing surface 622. In some embodiments, the cavity-opening extent 648 may be at least 50% of the contact-surface extent 646. In some embodiments, the cavity-opening extent 648 may be at least 60% of the contact-surface extent 646. In some embodiments, the cavity-opening extent 648 may be at least 70% of the contact-surface extent 646. In some embodiments, the cavity-opening extent 648 may be at least 80% of the contact-surface extent 646.

Of course, the spacer 608 of the embodiment shown in FIGS. 35 to 38 is an example only, and alternative embodiments may differ. For example, some alternative embodiments may include a spacer defining multiple cavities. In some alternative embodiments with multiple cavities, at least some of the cavities may generally resemble the cavity 642, extending from the base surface to the contact surface of the spacer—that is, through an entire thickness of the spacer. In some alternative embodiments with multiple cavities, at least some of the cavities may not extend through an entire thickness of the spacer. In some alternative embodiments with multiple cavities, each of the cavities may be in fluid communication with one or more conduit openings of the underlying stator such as the conduit openings 632 and 634 of the stator 604. In some alternative embodiments with multiple cavities, each of the cavities may be in fluid communication with each other one of the cavities. More generally, in some alternative embodiments, the spacer may include a porous material defining a plurality of pores making up at least part of the cavity. In some such alternative embodiments, at least some of the plurality of pores may be in fluid communication with one or more conduit openings of the stator. Further, in some such embodiments, the porous material may be or may include a compressible foam which is compressed when the stator cover is held to the stator, such that at least some of the pores are reduced in size or become closed. Thus, the porous material may allow fluid to flow therethrough when the spacer is uncompressed (for example, when the stator cover is not held to the stator) and may restrict or prevent fluid from flowing therethrough when the spacer is compressed (for example, when the stator cover is held to the stator). Some alternative embodiments may include a spacer with a textured contact surface. For example, the contact surface of such a spacer may define concentric ridges or grooves along a perimeter of the contact surface, which may improve sealing between the contact surface of the spacer and the stator-facing surface of the stator cover when the stator cover is held to the stator.

Referring now to FIG. 39, another embodiment is shown which includes a spacer made up of a plurality of spacer parts 650. The plurality of spacer parts 650 may be used, for example, in the stator device 601 in place of the spacer 608 of FIGS. 35 to 38. The plurality of spacer parts 650 may generally be similar to the spacer 608, and may be attached or attachable to the holding surface 622 of the stator 604. Like the spacer 608, each of the plurality of spacer parts 650 includes a base surface (not shown) and a contact surface 652 across that one of the plurality of spacer parts 650 from the base surface, with the base surface positioned to contact the holding surface 622 of the stator 604 when the plurality of spacer parts 650 is positioned on the holding surface 622, and the contact surface 652 positioned to contact the stator-facing surface 624 of the stator cover 606 when the stator cover 606 is held to the stator 604. Also like the spacer 608, the plurality of spacer parts 650 defines a cavity, shown generally at 654, which extends through the plurality of spacer parts 650 from the base surface to the contact surface 652 of each of the plurality of spacer parts 650. Like the cavity 642 of the spacer 608, the cavity 654 of the plurality of spacer parts 650 is in fluid communication with the conduit openings 632 and 634 when the plurality of spacer parts 650 is positioned on the holding surface 622. In general, the cavity 652 of the embodiment shown in FIG. 39 has the form of a grid pattern extending throughout the plurality of spacer parts 650. More specifically, the cavity 652 includes a first plurality of channels 656 extending parallel to one another in a first direction 658 along the contact surfaces 654 and a second plurality of channels 660 extending parallel to one another in a second direction 662 along the contact surfaces 654 which is transverse to the first direction 658. In the embodiment shown in FIG. 39, the first direction 658 is parallel to the Y axis and the second direction 662 is parallel to the X axis.

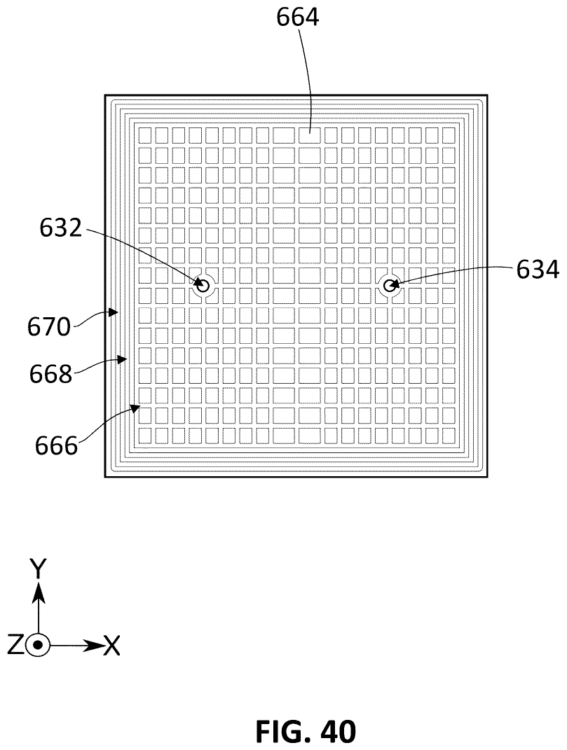

Referring now to FIG. 40, another embodiment is shown which includes a spacer made up of a plurality of spacer parts 664, similar to the plurality of spacer parts 650 of the embodiment of FIG. 39. Like the plurality of spacer parts 650, the plurality of spacer parts 664 may be used, for example, in the stator device 601 in place of the spacer 608 of FIGS. 35 to 38. Also like the plurality of spacer parts 650, the plurality of spacer parts 664 defines a cavity, shown generally at 666, which extends through the plurality of spacer parts 650, is in fluid communication with the conduit openings 632 and 634 of the stator 604 when the plurality of spacer parts 664 is positioned on the holding surface 622 of the stator 604, and generally has the form of a grid pattern. However, unlike the plurality of spacer parts 650, the plurality of spacer parts 664 also defines additional cavities, shown generally at 668 and 670, which are not in fluid communication with the conduit openings 632 and 634.

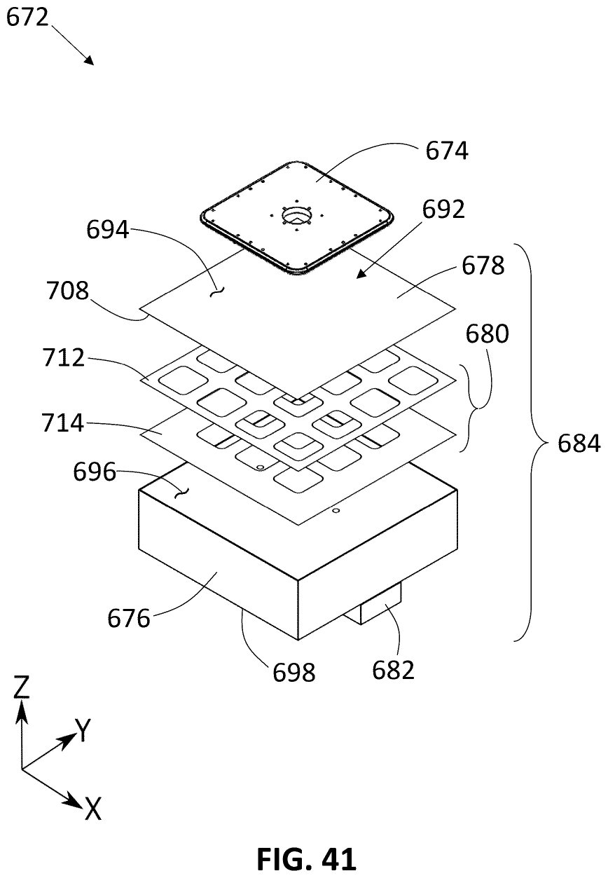

Referring now to FIGS. 41 to 45, a displacement system according to another embodiment is shown generally at 672 and includes a mover 674, a stator 676, a stator cover 678, a spacer 680, and a vacuum source 682. In general, the stator 676, the stator cover 678, the spacer 680, and the vacuum source 682 may collectively be referred to as a stator device 684. The mover 674 may generally be similar to the movers described above (such as, for example, the mover 602 of the embodiment of FIGS. 35 to 38) and includes one or more magnets 686 rigidly connected together. Likewise, the stator 676 may generally be similar to the stators described above (such as, for example, the stator 604 of the embodiment of FIGS. 35 to 38) and includes a stator body 688 and electrical conductors 690 that are operable to generate, in response to electrical currents through the electrical conductors 690, one or more external magnetic fields to facilitate moving a magnetized mover, such as the mover 674, relative to the stator 676. The stator cover 678 may generally be similar to the stator cover 606 of the embodiment of FIGS. 35 to 38, and may be held to the stator 676 to maintain separation between the stator 676 and a working environment 692 of the mover 674. Like the stator cover 606, the stator cover 678 includes a working surface 694 for the mover 674 to move upon in the working environment 692.

Like the stator body 614 of the stator 604 of the embodiment of FIGS. 35 to 38, the stator body 688 of the stator 676 of the embodiment shown in FIGS. 41 to 45 includes a holding surface 696 which faces the stator cover 678 and thus faces the working environment 692, and an access surface 698 which is across the stator body 688 from the holding surface 696. Also like the stator body 614, the stator body 688 of the embodiment shown defines an internal conduit shown generally at 700. The internal conduit 700 includes conduit openings, shown generally at 702 and 704, in the holding surface 696, and an access opening, shown generally at 706, in the access surface 698. Through the internal conduit 700, the conduit openings 702 and 704 are in fluid communication with the access opening 706. Therefore, for example, fluid may flow from the holding surface 696 to the access surface 698 through one or both of the conduit openings 702 and 704, at least a portion of the internal conduit 700, and the access opening 706.

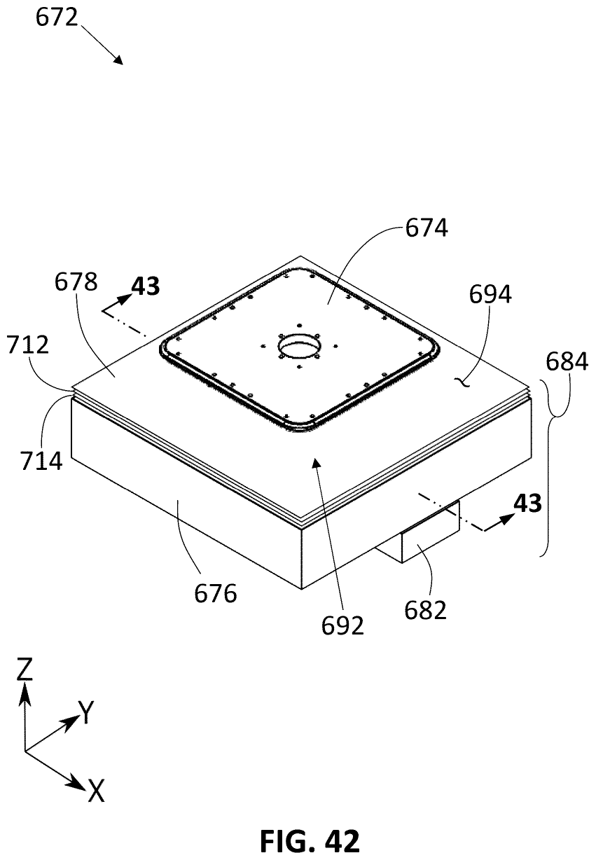

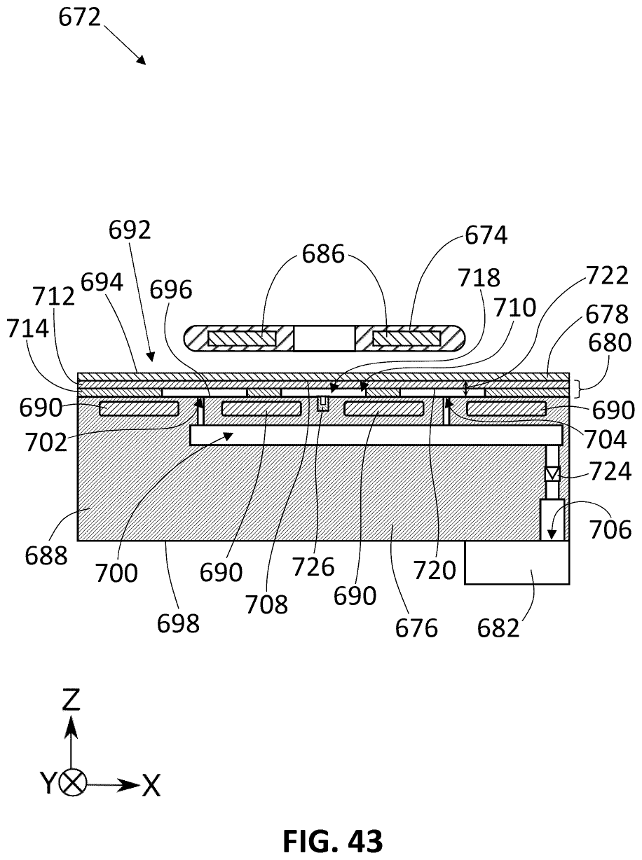

The stator cover 678 further includes a stator-facing surface 708 which faces the holding surface 696 of the stator 676. As shown in FIG. 43, the stator-facing surface 708 is across the stator cover 678 from the working surface 694. With the stator cover 678 overlaying the stator 676 as shown in FIGS. 42 and 43, or—more generally—with the stator cover 678 positioned proximate the stator 676 and between the stator 676 and the working environment 692, the holding surface 696 of the stator 676 and the stator-facing surface 708 of the stator cover 678 define a space, shown generally at 710, therebetween. As in the embodiment of FIGS. 35 to 38, in the embodiment shown in FIGS. 41 to 45, the spacer 680 is positionable on the holding surface 696 of the stator 676 in the space 710 between the holding surface 696 and the stator-facing surface 708, such that the spacer 680 prevents direct contact between the holding surface 696 and the stator-facing surface 708.

The vacuum source 682 may generally be similar to the vacuum source 610 of the embodiment of FIGS. 35 to 38, and is generally operable to remove fluid from the space 710 between the holding surface 696 of the stator 676 and the stator-facing surface 708 of the stator cover 678 in order to cause a first fluid pressure in the space 710 to be lower than a second fluid pressure at the working surface 694 of the stator cover 678 and thus generate suction urging the stator cover 678 toward the holding surface 696 of the stator 676 to hold the stator cover 678 to the stator 676. More specifically, in the embodiment shown in FIGS. 41 to 45, the vacuum source 682 is in fluid communication with the internal conduit 700 through the access opening 706, and is thus in fluid communication with the space 710 through the the access opening 706, the internal conduit 700, and the conduit openings 702 and 704, and is therefore operable to remove at least some fluid from the space 710 through one or both of the conduit openings 702 and 704, at least a portion of the internal conduit 700, and the access opening 706.

In the embodiment shown in FIGS. 41 to 45, the spacer 680 includes a first spacer layer 712 and a second spacer layer 714. Each of the first and second spacer layers 712 and 714 may generally be similar to the spacer 608 of the embodiment of FIGS. 35 to 38. More specifically, the first spacer layer 712 is a solid body defining a first plurality of through-thickness cavities 716, and the second spacer layer 714 is a solid body defining a second plurality of through-thickness cavities 718. The first and second spacer layers 712 and 714 are positionable on the holding surface 696 of the stator 676 to be in the space 710 between the holding surface 696 and the stator-facing surface 708 of the stator cover 678 at least when the stator cover 678 overlays the stator 676 as shown in FIGS. 42 and 43. More specifically, as shown in FIGS. 42 to 45, the second spacer layer 714 may be positioned on the holding surface 696 of the stator 676, and the first spacer layer 712 may be positioned on the second spacer layer 714 to contact the stator-facing surface 708 of the stator cover 678 when the stator cover 678 is held to the stator 676. When the first and second spacer layers 712 and 714 are thus positioned, at least a portion of the second spacer layer 714 is between at least a portion of the first spacer layer 712 and the holding surface 696 of the stator 676.

In the embodiment shown, when the first and second spacer layers 712 and 714 are positioned on the holding surface 696 of the stator 676 as shown in FIGS. 42 to 44, cavities of the first plurality of cavities 716 of the first spacer layer 712 are offset from cavities of the second plurality of cavities 718 of the second spacer layer 714—that is, the first plurality of cavities 716 does not line up with the second plurality of cavities 718. As such, portions of the first spacer layer 712, such as the portion 720 shown in FIG. 43, are exposed within the second plurality of cavities 718.

Also in the embodiment shown, when the first and second spacer layers 712 and 714 are positioned on the holding surface 696 of the stator 676 as shown in FIGS. 42 to 44, each cavity of the first plurality of cavities 716 is in fluid communication with at least one corresponding cavity of the second plurality of cavities 718, and each cavity of the second plurality of cavities 718 is in fluid communication with multiple corresponding cavities of the first plurality of cavities 716. Moreover, in the embodiment shown, due to the offset between the first plurality of cavities 716 and the second plurality of cavities 718, each of the first plurality of cavities 716 and the second plurality of cavities 718 is ultimately in fluid communication with each other one of the first plurality of cavities 716 and the second plurality of cavities 718. As such, in the embodiment shown, the first plurality of cavities 716 and the second plurality of cavities 718 may collectively be considered one continuous cavity of the spacer 680, with a first cavity portion—made up of the first plurality of cavities 716—defined by the first spacer layer 712, and a second cavity portion—made up of the second plurality of cavities 718—defined by the second spacer layer 714.

Additionally, when the first and second spacer layers 712 and 714 are positioned on the holding surface 696 of the stator 676 as shown in FIGS. 42 to 44, two cavities of the second plurality of cavities 718 are in fluid communication with the conduit openings 702 and 704, and thus all of the first plurality of cavities 716 and the second plurality of cavities 718 are ultimately in fluid communication with the conduit openings 702 and 704. Therefore, when the first and second spacer layers 712 and 714 of the spacer 680 are positioned on the holding surface 696 and the stator cover 678 overlays the stator 676 to define the space 710, as shown in FIGS. 42 and 43, the space 710 includes the first plurality of cavities 716 and the second plurality of cavities 718, and the vacuum source 682 is operable to remove fluid from at least some of the first plurality of cavities 716 and the second plurality of cavities 718 through one or both of the conduit openings 702 and 704 to cause the first fluid pressure in the first plurality of cavities 716 and the second plurality of cavities 718—and thus in the space 710—to be lower than the second fluid pressure at the working surface 694 of the stator cover 678 and thus to urge the stator cover 768 toward the holding surface 696 to hold the stator cover 678 to the stator 676.

When the stator cover 678 is held to the stator 676 with the first and second spacer layers 712 and 714 of the spacer 680 between the stator cover 678 and the stator 676 and the first plurality of cavities 716 of the first spacer layer 712 offset from the second plurality of cavities 718 of the second spacer layer 714, as described above and as shown in FIGS. 42 and 43, there will be various positions on the holding surface 696 of the stator 676 at which a line normal to the holding surface 696 and extending between the holding surface 696 and the stator-facing surface 708 of the stator cover 678 passes through both the spacer 680 and the cavity defined by the spacer 680 (that is, the cavity made up of the first plurality of cavities 716 and the second plurality of cavities 718). For example, as shown in FIG. 43, a line 722, which is normal to the holding surface 696 and extends between the holding surface 696 and the stator-facing surface 708, passes through both a cavity of the second plurality of cavities 718 and the portion 720 of the first spacer layer 712. There will also be positions on the holding surface 696 at which a line normal to the holding surface 696 and extending between the holding surface 696 and the stator-facing surface 708 passes through only the spacer 680 (that is, through both the first and second spacer layers 712 and 714), and positions on the holding surface 696 at which a line normal to the holding surface 696 and extending between the holding surface 696 and the stator-facing surface 708 passes through only the cavity defined by the spacer 680 (that is, through cavities of both the first plurality of cavities 716 and the second plurality of cavities 718). That is, in the embodiment shown in FIGS. 41 to 45, the spacer 680 has an effective thickness which varies across the holding surface 696 of the stator 676. Portions of the spacer 680 which span a full thickness of the space 710 between the holding surface 696 and the stator-facing surface 708—that is, where the line normal to the holding surface 696 and extending between the holding surface 696 and the stator-facing surface 708 passes through both the first and second spacer layers 712 and 714—may support the stator cover 678 when it is held to the stator 676. Such support may prevent deformation of the stator cover 678 due to, for example, the suction generated by the vacuum source 682 removing fluid from the space 710.

As shown in FIG. 43, the stator device 684 of the embodiment shown further includes a valve 724 positioned in the internal conduit 700. The valve 724 may generally prevent backflow of fluid from the internal conduit 700 back into the space 710 between the holding surface 696 of the stator 676 and the stator-facing surface 708 of the stator cover 678 through the conduit openings 702 and 704. In some embodiments, the valve 724 may be operable to partly or completely prevent fluid from flowing through the internal conduit 700-for example, when the vacuum source 682 is disabled, turned off, or disconnected from the stator 676. As a more specific example, in some such embodiments, the valve 724 may be a control valve. In some embodiments, the valve 724 may be a check valve (that is, a one-way valve) configured to allow fluid to flow through the internal conduit 700 in a first direction from the conduit openings 702 and 704 to the access opening 706, and configured to prevent fluid from flowing through the internal conduit 700 in a second direction from the access opening 706 to the conduit openings 702 and 704. Although the stator 676 of the embodiment shown only includes the one valve 724, alternative embodiments may differ and may include a stator having more than one valve positioned in the internal conduit. Also, although the valve 724 of the embodiment shown in positioned in the internal conduit 700, alternative embodiments may include a valve positioned outside of the internal conduit 700. For example, in some such alternative embodiments, the valve may be positioned in the vacuum source 682. In some such alternative embodiments where the vacuum source is spaced apart from the stator and in in fluid communication with the internal conduit through the access opening via an external conduit between the vacuum source and the access opening, the valve may be positioned in the external conduit.

The stator device 684 of the embodiment shown further includes a pressure sensor 726 positioned and operable to measure the first fluid pressure. Such measurements may be used, for example, by a controller (such as the module controller 500A of the embodiment of FIG. 4) and/or a control system (such as the control system 400 of the embodiment of FIG. 4) to detect separation of the stator cover 678 from the stator 676 and/or to control the vacuum source 682 to regulate the first fluid pressure in the space 710. In the embodiment shown, the pressure sensor 726 is located at the holding surface 696 of the stator 676 to measure the first fluid pressure in the space 710 between the holding surface 696 of the stator 676 and the stator-facing surface 708 of the stator cover 678. However, alternative embodiments may differ. For example, some alternative embodiments may include an internal pressure sensor located in the internal conduit 700, between the valve 724 and the conduit openings 702 and 704. In such embodiments, the internal pressure sensor may be operable to measure a pressure in the internal conduit 700, which may be the same as the first fluid pressure in the space 710. Additionally, some alternative embodiments may include more than one pressure sensor, and in some such embodiments, the pressure sensors may be positioned in different locations (for example, at the holding surface and/or in the internal conduit).

In operation, for example, the stator cover 606 of the stator device 601 may be positioned proximate the stator 604 between the stator 604 and the working environment 618, with the stator-facing surface 624 of the stator cover 606 facing the holding surface 622 of the stator 604 and the spacer 608 positioned on the holding surface 622 between the holding surface 622 and the stator-facing surface 624. The vacuum source 610 may then be controlled to remove fluid from the space 626 between the holding surface 622 and the stator-facing surface 624 to cause the first fluid pressure in the space 626 to be lower than the second fluid pressure at the working surface 620 of the stator cover 606 to urge the stator cover 606 toward the holding surface 622 of the stator 604 to hold the stator cover 606 to the stator 604. In some embodiments where the vacuum source 610 includes a vacuum accumulator, the vacuum accumulator may be used to cause a sudden drop in the first fluid pressure in the space 626, thus generating a sudden suction between the holding surface 622 and the stator-facing surface 624 to rapidly urge the stator cover 606 toward the stator 604. For example, in such embodiments where the vacuum source 610 also includes a vacuum pump, the vacuum accumulator may begin by being sealed from the internal conduit 630, and the vacuum pump may be controlled to remove fluid from the vacuum accumulator to build up a low pressure in the vacuum accumulator. Once the low pressure is built up in the vacuum accumulator, the seal between the vacuum accumulator and the internal conduit 630 may be released (for example, by opening a valve) to connect the vacuum accumulator to the internal conduit 630, resulting in a rapid flow of fluid into the vacuum accumulator from the internal conduit 630 and the space 626 and a corresponding rapid decrease in the first fluid pressure in the internal conduit 630 and the space 626. Such a rapid decrease in the first fluid pressure in the space 626 may, for example, at least initially improve sealing between the stator cover 606, the spacer 608, and the stator 604, resulting in a more effective hold of the stator cover 606 to the stator 604. Once the the stator cover 606 is held to the stator 604, the vacuum source 610 may maintain the relatively low first fluid pressure in the space 626 (for example, by removing further fluid from the space 626 as needed) to keep the stator cover 606 held to the stator 604. Subsequently, when the stator cover 606 is to be removed from the stator 604, the vacuum source 610 may be controlled to cause or allow fluid to re-enter the space 626 to cause the first fluid pressure in the space 626 to be equal to or greater than the second fluid pressure at the working surface 620 to release the stator cover 606 from the stator 604.

Similarly, the stator cover 678 of the stator device 684 may be positioned proximate the stator 676 between the stator 676 and the working environment 692, with the stator-facing surface 708 of the stator cover 678 facing the holding surface 696 of the stator 676 and the first and second spacer layers 712 and 714 of the spacer 680 positioned on the holding surface 696 between the holding surface 696 and the stator-facing surface 708. The vacuum source 682 may then be controlled to remove fluid from the space 710 between the holding surface 696 and the stator-facing surface 708 to cause the first fluid pressure in the space 710 to be lower than the second fluid pressure at the working surface 694 of the stator cover 678 to urge the stator cover 678 toward the holding surface 696 of the stator 676 to hold the stator cover 678 to the stator 676.

In some embodiments, when the stator cover 606 is positioned proximate the stator 604 between the stator 604 and the working environment 618, the stator 604 may be controlled to cause one or more movers, such as the mover 602, to push the stator cover 606 toward the holding surface 622 of the stator 604. Similarly, in some embodiments, when the stator cover 678 is positioned proximate the stator 676 between the stator 676 and the working environment 692, the stator 676 may be controlled to cause one or more movers, such as the mover 674, to push the stator cover 678 toward the holding surface 696 of the stator 676. For example, in embodiments where the working surface is generally horizontal and positioned below the working environment, such as the stator device 601 of FIGS. 35 to 38 or the stator device 684 of FIGS. 41 to 45, the stator 604 (or 676) may cause the mover 602 (or 674) to rest on the working surface 620 (or 694) of the stator cover 606 (or 678) such that the weight of the mover 602 pushes down on the working surface 620 and thus pushes the stator cover 606 toward the holding surface 622. Alternatively or additionally, the stator 604 may actively urge the mover 602 toward the stator 604 to cause the mover 602 to push the stator cover 606 toward the holding surface 622. The stator 604 may be controlled to cause the mover 602 to push the stator cover 606 toward the holding surface 622 in this way to, for example, establish a partial or complete seal between the stator cover 606, the spacer 608, and the stator 604 to seal the space 626 within the cavity 642 from the exterior of the stator 604 while the vacuum source 610 removes fluid from the space 626 to lower the first fluid pressure in the space 626. The stator 604 may also be controlled to cause the mover 602 to push the stator cover 606 toward the holding surface 622 in this way to, for example, hold the stator cover 606 to the stator 604 in situations where the vacuum source 610 has malfunctioned.

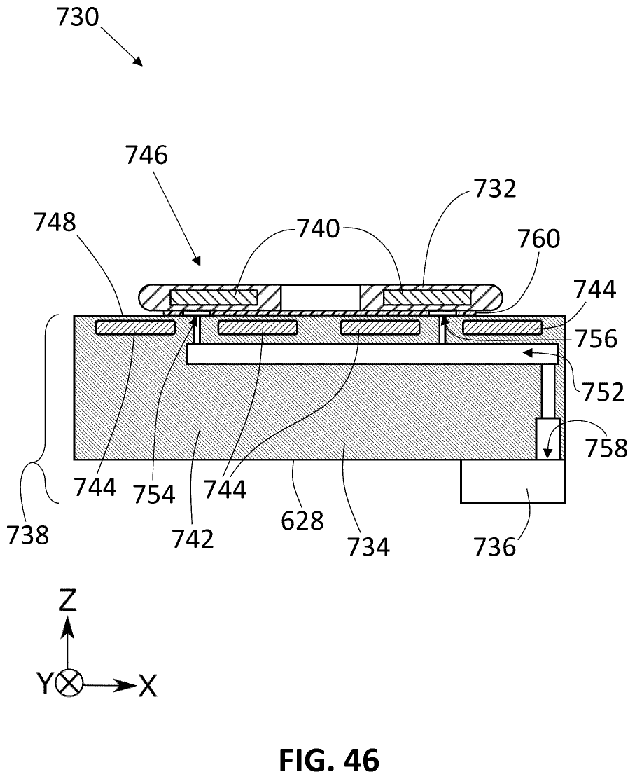

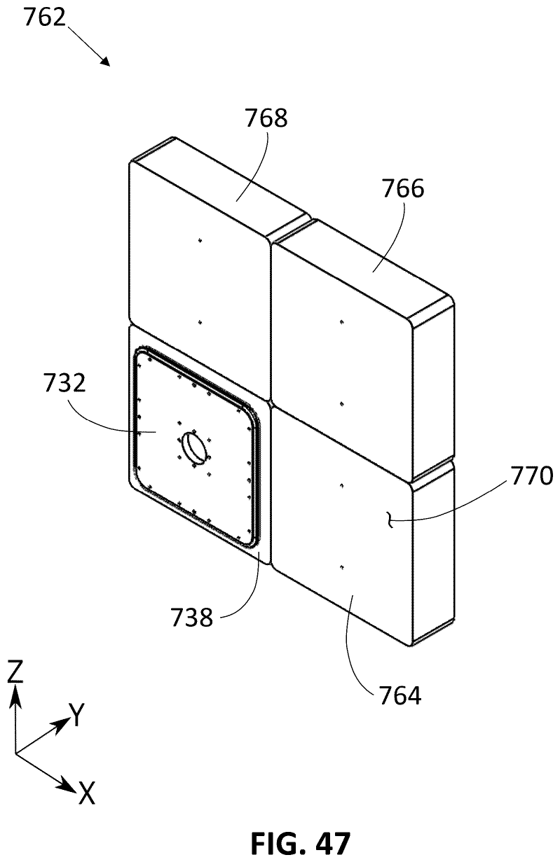

Referring now to FIG. 46, a displacement system according to another embodiment is shown generally at 730 and includes a mover 732, a stator 734, and a vacuum source 736. In general, the stator 734 and the vacuum source 736 may collectively be referred to as a stator device 738. The mover 732 may generally be similar to the movers described above (such as, for example, the mover 602 of the embodiment of FIGS. 35 to 38) and includes one or more magnets 740 rigidly connected together. Likewise, the stator 734 may generally be similar to the stators described above (such as, for example, the stator 604 of the embodiment of FIGS. 35 to 38) and includes a stator body 742 and electrical conductors 744 that may be operable to generate, in response to electrical currents through the electrical conductors 744, one or more external magnetic fields to facilitate moving a magnetized mover, such as the mover 732, relative to the stator 734, in a working environment 746.

The stator body 742 includes a working surface 748 for the mover 732 to move upon in the working environment 746, and an access surface 750 which is across the stator body 742 from the working surface 748. Like the stator body 614 of the stator 604 of the embodiment of FIGS. 35 to 38, the stator body 742 of the stator 734 of the embodiment shown in FIG. 46 defines an internal conduit shown generally at 752. The internal conduit 752 includes conduit openings, shown generally at 754 and 756, in the working surface 748, and an access opening, shown generally at 758, in the access surface 750. Through the internal conduit 752, the conduit openings 754 and 756 are in fluid communication with the access opening 758. Therefore, for example, fluid may flow from the working surface 748 to the access surface 750 through one or both of the conduit openings 754 and 756, at least a portion of the internal conduit 752, and the access opening 758.

The vacuum source 736 may generally be similar to the vacuum source 610 of the embodiment of FIGS. 35 to 38, and is generally operable to remove fluid from the working environment 746 near the conduit openings 754 and 756 at the working surface 748 in order to cause a first fluid pressure in the working environment 746 near the conduit openings 754 and 756 to be lower than a second fluid pressure in the working environment 746 away from the conduit openings 754 and 756, and thus generate suction toward the conduit openings 754 and 756. More specifically, in the embodiment shown in FIG. 46, the vacuum source 736 is in fluid communication with the internal conduit 752 through the access opening 758, and is thus in fluid communication with the working environment 746 near the conduit openings 754 and 756 through the the access opening 758, the internal conduit 752, and the conduit openings 754 and 756, and is therefore operable to remove at least some fluid from the working environment 746 near the conduit openings 754 and 756 through one or both of the conduit openings 754 and 756, at least a portion of the internal conduit 752, and the access opening 758.

An operator may in some situations desire to passively maintain a position of the mover 732 without powering the electrical conductors 744 of the stator 734 (which may potentially consume energy and generate heat for non-horizontal and/or turbulent operations). Unlike the stator device 601 of the embodiment of FIGS. 35 to 38, the stator device 738 of the embodiment shown in FIG. 46 does not include a stator cover. Therefore, in the embodiment shown in FIG. 46, the mover 732 may interface directly with the conduit openings 754 and 756 at the working surface 748, and may thus be exposed to the suction generated by the vacuum source 736 toward the conduit openings 754 and 756. This suction may allow storage of the mover 732 in a non-levitated storage state (also known as “workholding”). For example, the mover 732 may be positioned over one or both of the conduit openings 754 and 756 and lowered toward the working surface 748 until it is captured and held by the suction generated by the vacuum source 736. Thus, the working surface 748 may effectively serve as a “holding surface” for the mover 732. In some embodiments, this non-levitated storage state may be utilized with non-horizontal operation where the mover 732 may not be passively supported by the working surface 748 due to gravity (see, for example, FIG. 47). In such embodiments, the non-levitated storage state may ensure static operation with minimal power usage while the suction is maintained. In such cases, a position of the mover 732 may be monitored while in the non-levitated storage state and if the mover 732 begins to move from its storage position, the mover 732 may be controlled by the stator 734 to prevent undesired movement and separation from the work surface 748.

In the embodiment shown, a gasket 760 is positioned between the mover 732 and the working surface 748 near the conduit openings 754 and 756 to help establish a seal between the mover 732 and the working surface 748 when the suction generated by the vacuum source 736 captures the mover 732. To release the mover 732, the vacuum source 736 may be deactivated and fluid may be allowed to flow (for example, via leaking or the opening of a valve) from the internal conduit 752 out through the conduit openings 754 and 756 in order to remove the suction, at which point the mover 732 may transition from a landed state to a levitated state for further actions. In some embodiments, the gasket 760 may be carried by the mover 732. In other embodiments, the gasket 760 may be fixed to the working surface 748.

Referring now to FIG. 47, a displacement system according to another embodiment is shown generally at 762 and includes the mover 732 and the stator device 738 of the embodiment of FIG. 46, along with additional stator devices 764, 766, and 768. Each of the stator devices 764, 766, and 768 may generally be similar to the stator device 738 (for example, each includes two conduit openings such as the conduit openings 754 and 756 of the stator device 738. The stator devices 738, 764, 766, and 768 form a collective working surface 770, which includes the working surface 748 of the stator device 738. In the embodiment shown in FIG. 47, the working surface 770 is non-horizontal—more specifically, it is generally vertically oriented, in the X-Z plane. Thus, if the stator devices 738, 764, 766, and 768 generate magnetic fields to levitate the mover 732 and then stop generating magnetic fields, the mover 732 will fall due to gravity. However, in such situations, as described above with respect to the stator device 738, one or more of the stator devices 738, 764, 766, and 768 may be used to hold the mover 732 via suction in the non-levitated storage state.

In some embodiments without a stator cover, such as the embodiments of FIGS. 46 and 47, a mover such as the mover 732 may include onboard tooling which may be configured to be powered by fluid flow at a conduit opening on the working surface, such as one or both of the conduit openings 754 and 756 at the working surface 748. In such embodiments, the mover may land on the working surface near the conduit opening to connect the onboard tooling to the conduit opening to receive the fluid flow. For example, such onboard tooling may include pneumatic tooling.

In general, embodiments such as those described herein may operate in low-or high-temperature environments and/or may generate considerable heat during operation, and may thus require control or regulation of an operating temperature of one or more stators or stator devices as described herein. The operating temperature of a stator/stator device may be regulated by circulating a heat exchange fluid through one or more heat exchange conduits in the stator/stator device to absorb or provide heat as needed. Effective temperature regulation may, for example, allow the system to consume more power to achieve higher performance (for example, in terms of load capacity and/or acceleration). In embodiments which include a stator cover, such as the embodiments of FIGS. 35 to 38, 39, 40, and 41 to 45, effective temperature regulation may reduce or prevent thermal strain between the stator cover and the underlying stator. Such thermal strain may occur due to thermal expansion of the stator cover, which may in turn lead to buckling or bulging of the stator over and localized or total separation of the stator cover from the stator. In terms of heat generation in a stator device during operation, the most substantial internal sources of heat are generally the motor (that is, the electrical conductors) and the amplifier. These components are therefore often the design focus for stator device cooling schemes. For example, heat exchange conduits are often routed between these components, with low resistance thermal paths from these components to the heat exchange conduits. The internal layout of the various electrical components of a stator device is also an important consideration to balance thermal, maintenance, performance, sealing, durability, and usability concerns.

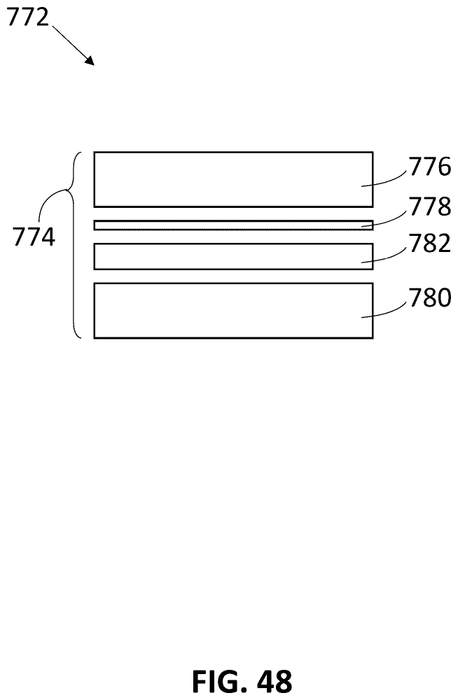

FIG. 48 shows a heat exchange layout, shown generally at 772, for a stator device 774 according to one embodiment. The stator device 774 may generally be similar to the stator devices described above (such as, for example, the stator device 601 of the embodiment of FIGS. 35 to 38 and/or the stator device 684 of the embodiment of FIGS. 41 to 45) and includes a motor module 776, a position-sensor module 778, an amplifier module 780, and a heat-exchange network 782. Generally, as described in the embodiments above, the motor module 776 includes one or more electrical conductors that are operable to generate, in response to electrical currents through the electrical conductors, external magnetic fields to facilitate moving a magnetized mover, the position-sensor module 778 includes one or position sensors operable to sense a position of such a mover, and the amplifier module 780 is operable to control the electrical conductors of the motor module 776. The heat-exchange network 782 includes one or more heat-exchange conduits for conveying a heat-exchange fluid therethrough. In the embodiment shown in FIG. 48, the heat-exchange network 782 is positioned below the motor module 776 and the position-sensor module 778, and above the amplifier module 780. During operation, the heat-exchange fluid flows through the heat-exchange network 782 and absorbs or provides heat to or from the amplifier module 780 and to or from the motor module 776 through the position-sensor module 778.

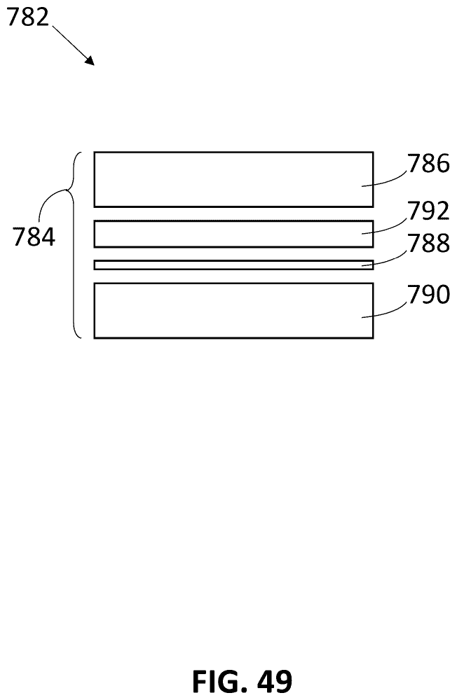

FIG. 49 shows a heat exchange layout, shown generally at 782, for a stator device 784 according to another embodiment. The stator device 774 may generally be similar to the stator devices described above (such as, for example, the stator device 772 of the embodiment of FIG. 48) and includes a motor module 786 similar to the motor module 776, a position-sensor module 788 similar to the position-sensor module 778, an amplifier module 790 similar to the amplifier module 780, and a heat-exchange network 792 similar to the heat-exchange network 782. In the embodiment shown in FIG. 49, the heat-exchange network 792 is positioned below the motor module 786, and above the position-sensor module 788 and the amplifier module 790. During operation, a heat-exchange fluid flows through the heat-exchange network 792 and absorbs or provides heat to or from the motor module 786 and to or from the amplifier module 790 through the position-sensor module 788.

In some embodiments, thermal conduction between a stator component and the heat-exchange network may be enhanced by utilizing a large contact area and/or low thermal resistance materials to create low resistance thermal paths. In some embodiments, when heat passes through an intervening stator component (for example, the position-sensor module 778 or the position-sensor module 788), the intervening stator component may define an opening allowing a thermally conductive material to pass through the intervening stator component from the heat-exchange network to contact the element to be cooled or heated, thereby creating a more effective heat conducting path. In some embodiments, the intervening stator component may include built-in heat conducting pathways (for example, un-connected vias) to create simple low resistance thermal paths therethrough.

In the embodiments shown in FIGS. 48 and 49, the position-sensor module is positioned embodiments the sensor may be located between the motor module and the amplifier module. However, in alternative embodiments, the position-sensor module may be located outside of the motor module and the amplifier module-for example, the position-sensor module may be located below the amplifier module.

In some embodiments, a closed loop liquid heat-exchange network may be used to transfer heat away from a motor module to a desired heat transfer portion of the stator device (for example, a back panel of the stator device). In such embodiments, the heat may then be transferred to, for example, an external heat dissipating element (for example, a liquid cooling system or refrigeration unit) and/or outside surroundings via thermal convection.

In some embodiments, in order to reduce a risk of the heat-exchange fluid contacting and affecting electrical components of the stator device, the heat-exchange network may be arranged such that the heat-exchange conduits are physically separated from all the electrical components of the stator device, for example, by routing the heat-exchange conduits externally along the stator device. Such external routing of the heat-exchange conduits may be implemented, for example, in embodiments where the stator device is mostly or entirely a unitary assembly (that is, a monolithic body), such that any leak from a heat-exchange conduit may be easily isolated from the internal electronic components of the stator device (and easily identified). Externally routed heat-exchange conduits may take the form of channels and/or holes in external portions (that is, a periphery) of the stator body. In general, the heat-exchange network may also include one or more inlets in fluid communication with the heat-exchange conduits to receive the heat-exchange fluid, and one or more outlets in fluid communication with the heat-exchange conduits through which the heat-exchange fluid leaves the heat-exchange network.

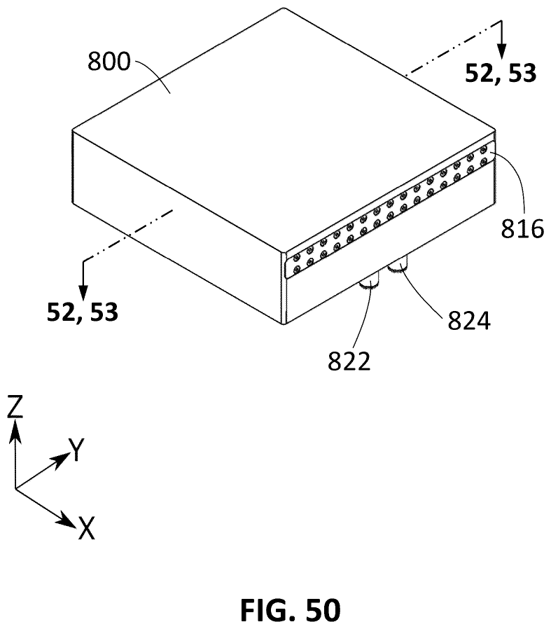

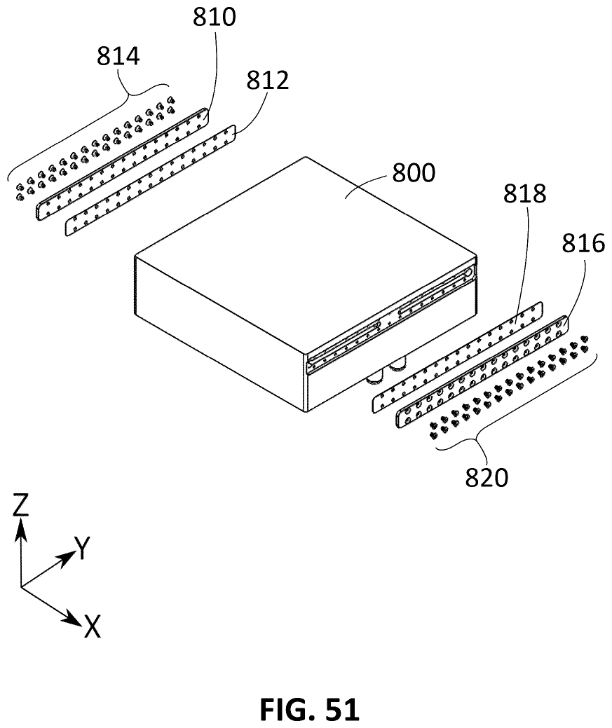

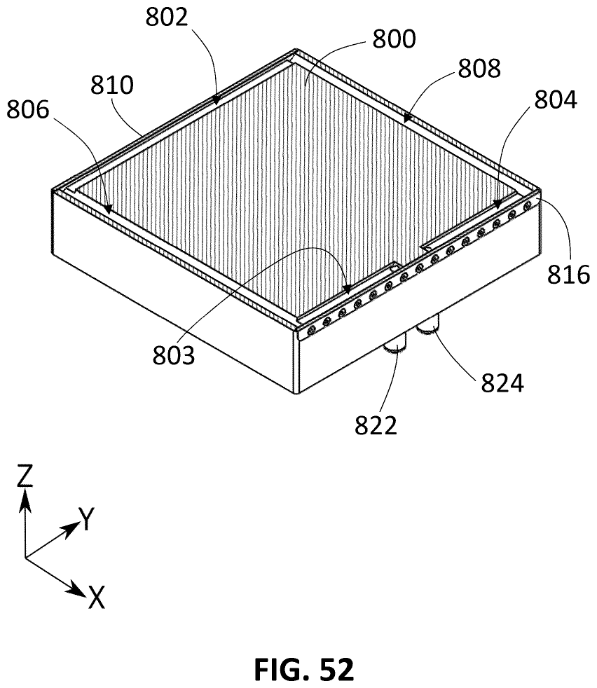

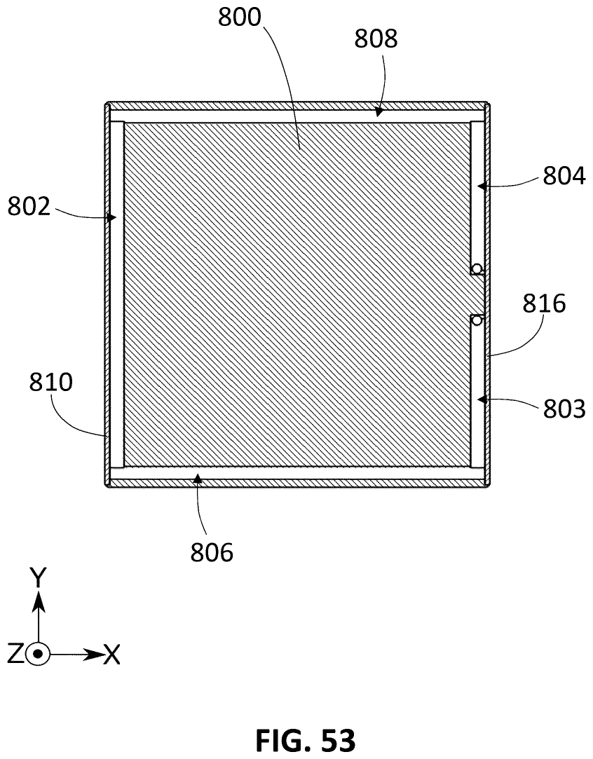

Referring now to FIGS. 50 to 53, an embodiment of a heat-exchange network for a stator 800 is shown and includes a plurality of externally-routed heat-exchange conduits, including channels 802, 803, and 804, and through holes 806 and 808. The stator 800 may generally be similar to the stators described above (such as, for example, the stator 604 of the embodiment of FIGS. 35 to 38 and/or the stator 676 of the embodiment of FIGS. 41 to 45). The channels 802 and 803 are sealed by a cover 810 with a sealing element 812 and fasteners 814, and the channel 804 is sealed by a cover 816 with a sealing element 818 and fasteners 820. The heat exchange network of the embodiment shown in FIGS. 50 to 53 also includes an inlet fitting 822 which may be connect to an external heat-exchange fluid source (not shown) and an outlet fitting 824 which may be connect to an external heat-exchange fluid sink (not shown). In operation, heat-exchange fluid (for example, water) from the external heat-exchange fluid source enters the heat-exchange network through the inlet fitting 822 and flows through the channel 803, the through hole 806, the channel 802, the through hole 808, and the channel 804, before exiting through the outlet fitting 824 to the external heat-exchange fluid sink. As the heat-exchange fluid flows through the heat-exchange network, it exchanges heat with the stator 800 to regulate the operating temperature of the stator 800. After the heat-exchange fluid has exited the heat-exchange network to the external heat-exchange fluid sink, it may be run through an external heat exchanger to be heated or cooled as needed before returning to the external heat-exchange fluid source to be reused in the heat-exchange network. If a leaking failure occurs in the heat-exchange network, the covers 810 and 816 are removable and allow access to the channels 802 and 804 and the through holes 806 and 808.

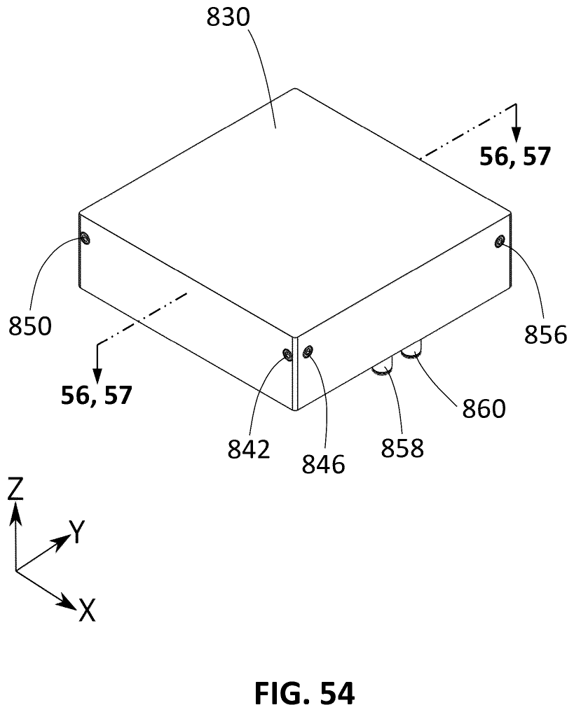

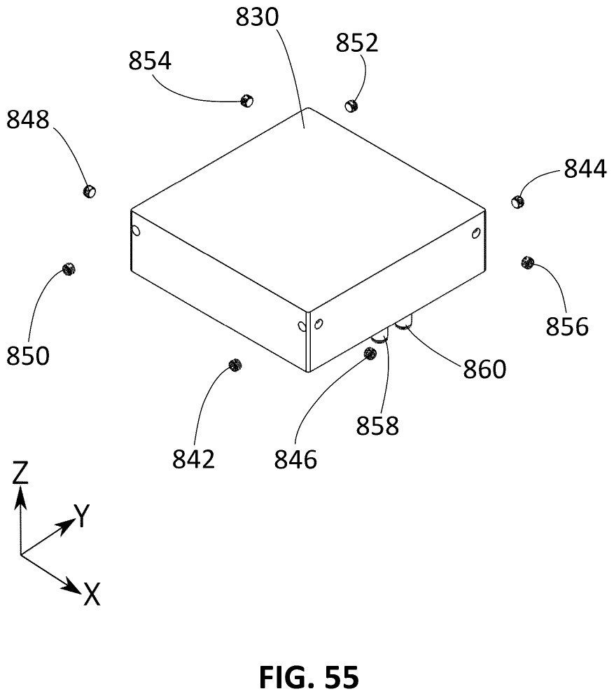

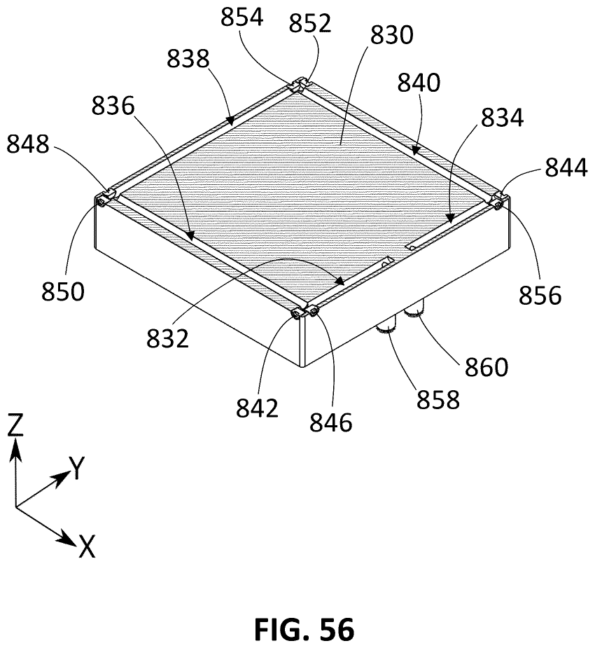

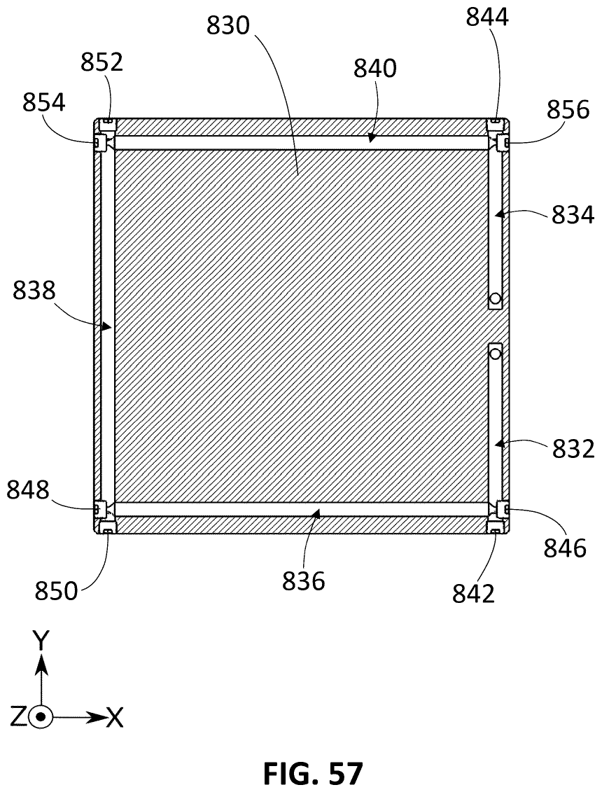

Referring to FIGS. 54 to 57, another embodiment of a heat-exchange network for a stator 830 is shown and includes a plurality of externally-routed heat-exchange conduits, including blind holes 832 and 834 and through holes 836, 838, and 840. The stator 830 may generally be similar to the stators described above (such as, for example, the stator 604 of the embodiment of FIGS. 35 to 38 and/or the stator 676 of the embodiment of FIGS. 41 to 45). An open end of the blind hole 832 is blocked by an end cap 842, and an open end of the blind hole 834 is blocked by an end cap 844. Similarly, open ends of the through hole 836 are blocked by end caps 846 and 848, open ends of the through hole 838 are blocked by end caps 850 and 852, and open ends of the through hole 840 are blocked by end caps 854 and 856. The heat exchange network of the embodiment shown in FIGS. 54 to 57 also includes an inlet fitting 858 which may be connect to an external heat-exchange fluid source (not shown) and an outlet fitting 860 which may be connect to an external heat-exchange fluid sink (not shown). The embodiment shown in FIGS. 54 to 57 operates similarly to the embodiment of FIGS. 50 to 53. That is, in operation, heat-exchange fluid from the external heat-exchange fluid source enters the heat-exchange network through the inlet fitting 858 and flows through the blind hole 832, the through hole 836, the through hole 838, the through hole 840, and the blind hole 834, before exiting through the outlet fitting 860 to the external heat-exchange fluid sink. As the heat-exchange fluid flows through the heat-exchange network, it exchanges heat with the stator 830 to regulate the operating temperature of the stator 830. After the heat-exchange fluid has exited the heat-exchange network to the external heat-exchange fluid sink, it may be run through an external heat exchanger to be heated or cooled as needed before returning to the external heat-exchange fluid source to be reused in the heat-exchange network. If a leaking failure occurs in the heat-exchange network, the end caps 842, 844, 846, 848, 850, 852, 854, and 856 are removable and allow access to the blind holes 832 and 834 and the through holes 836, 838, and 840. Some alternative embodiments may include additional blind holes to reduce the number of blocking elements, such as end caps or covers, required for the heat-exchange network.

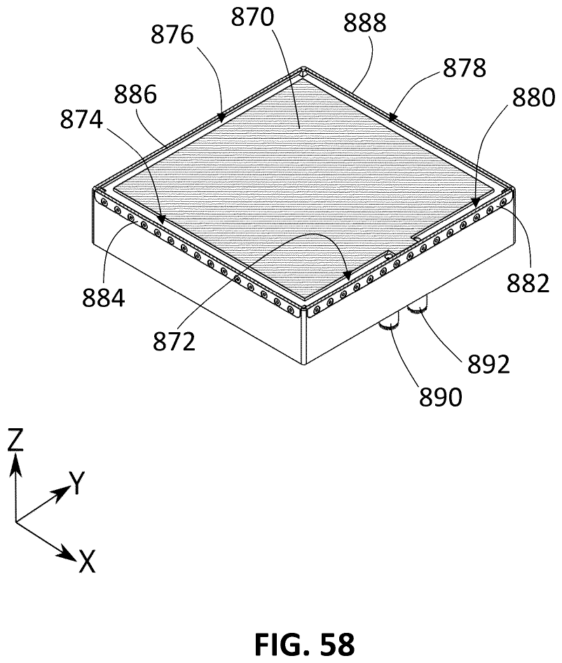

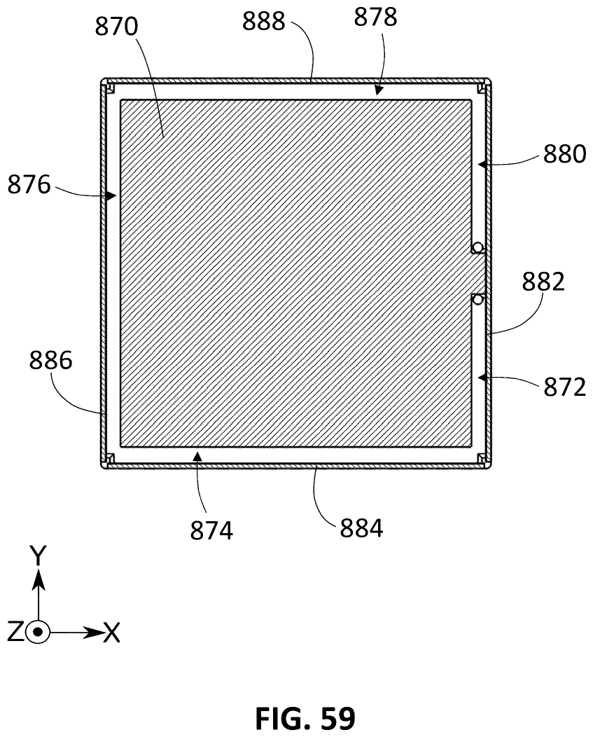

Referring to FIGS. 58 and 59, another embodiment of a heat-exchange network for a stator 870 is shown and includes a plurality of externally-routed heat-exchange conduits, including channels 872, 874, 876, 878, and 880. The stator 870 may generally be similar to the stators described above (such as, for example, the stator 604 of the embodiment of FIGS. 35 to 38 and/or the stator 676 of the embodiment of FIGS. 41 to 45). The channels 872, 874, 876, 878, and 880 may generally be similar to the channels 802, 803, and 804 of the embodiment of FIGS. 50 to 53. The channels 872 and 880 are sealed by a cover 882 with a corresponding sealing element and fasteners, the channel 874 is sealed by a cover 884 with a corresponding sealing element and fasteners, the channel 876 is sealed by a cover 886 with a corresponding sealing element and fasteners, and the channel 878 is sealed by a cover 888 with a corresponding sealing element and fasteners. The heat exchange network of the embodiment shown in FIGS. 58 and 59 also includes an inlet fitting 890 which may be connect to an external heat-exchange fluid source (not shown) and an outlet fitting 892 which may be connect to an external heat-exchange fluid sink (not shown). The embodiment shown in FIGS. 58 and 59 operates similarly to the embodiment of FIGS. 50 to 53 and to the embodiment of FIGS. 54 to 57. That is, in operation, heat-exchange fluid from the external heat-exchange fluid source enters the heat-exchange network through the inlet fitting 890 and flows through the channel 872, the channel 874, the channel 876, the channel 878, and the channel 880, before exiting through the outlet fitting 892 to the external heat-exchange fluid sink. As the heat-exchange fluid flows through the heat-exchange network, it exchanges heat with the stator 870 to regulate the operating temperature of the stator 870. After the heat-exchange fluid has exited the heat-exchange network to the external heat-exchange fluid sink, it may be run through an external heat exchanger to be heated or cooled as needed before returning to the external heat-exchange fluid source to be reused in the heat-exchange network. If a leaking failure occurs in the heat-exchange network, the covers 882, 884, 886, and 888 are removable and allow access to the channels 872, 874, 876, 878, and 880.

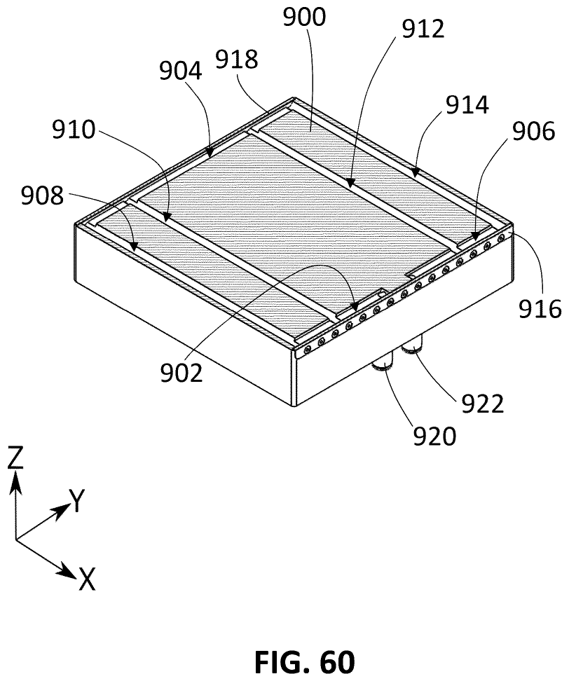

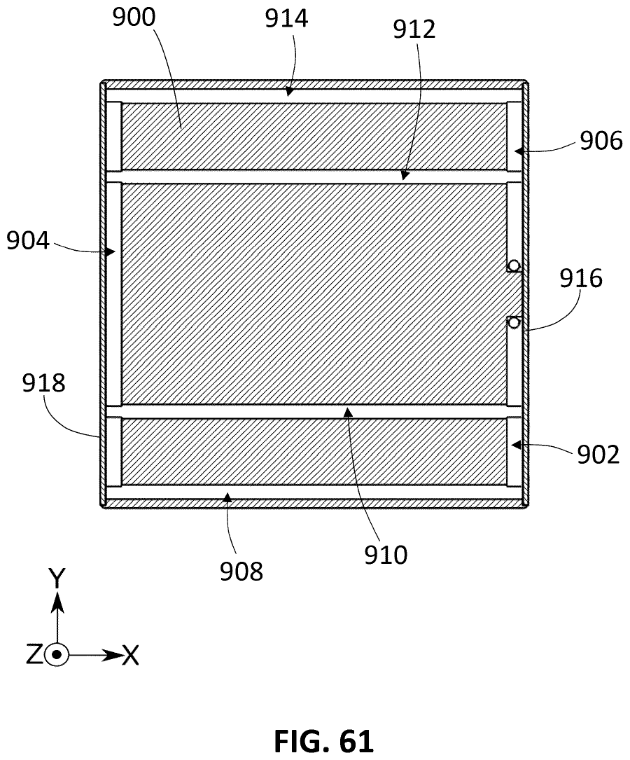

Referring to FIGS. 60 and 61, another embodiment of a heat-exchange network for a stator 900 is shown and includes a plurality of externally-routed heat-exchange conduits, including channels 902, 904, and 906, and through holes 908, 910, 912, and 914. The stator 900 may generally be similar to the stators described above (such as, for example, the stator 604 of the embodiment of FIGS. 35 to 38 and/or the stator 676 of the embodiment of FIGS. 41 to 45). The channels 902, 904, and 906 may generally be similar to the channels 802, 803, and 804 of the embodiment of FIGS. 50 to 53, and the through holes 908, 910, 912, and 914 may generally be similar to the through holes 806 and 808 of the embodiment of FIGS. 50 to 53. The channels 902 and 906 are sealed by a cover 916 with a corresponding sealing element and fasteners, and the channel 904 is sealed by a cover 918 with a corresponding sealing element and fasteners. The heat exchange network of the embodiment shown in FIGS. 60 and 61 also includes an inlet fitting 920 which may be connect to an external heat-exchange fluid source (not shown) and an outlet fitting 922 which may be connect to an external heat-exchange fluid sink (not shown). In the embodiment shown in FIGS. 60 and 61, the heat-exchange conduits provide multiple possible branching flow paths for the heat-exchange fluid. That is, in operation, heat-exchange fluid from the external heat-exchange fluid source enters the heat-exchange network through the inlet fitting 920 and flows through the channel 902, the through hole 908 and/or the through hole 910, the channel 904, the through hole 912 and/or the through hole 914, and the channel 906, before exiting through the outlet fitting 922 to the external heat-exchange fluid sink. As the heat-exchange fluid flows through the heat-exchange network, it exchanges heat with the stator 900 to regulate the operating temperature of the stator 900. The multiple branching flow paths of the heat-exchange network of the embodiment shown in FIGS. 60 and 61 may allow for more evenly distributed temperature regulation of the stator 900, with smaller local temperature differentials. After the heat-exchange fluid has exited the heat-exchange network to the external heat-exchange fluid sink, it may be run through an external heat exchanger to be heated or cooled as needed before returning to the external heat-exchange fluid source to be reused in the heat-exchange network. If a leaking failure occurs in the heat-exchange network, the covers 916 and 918 are removable and allow access to the channels 902, 904, and 906 and the through holes 908, 910, 912, and 914.

In some embodiments which include more than one stator device with a heat-exchange network, the heat-exchange network of each stator device may be connected together (that is, in fluid communication with each other) in series, in parallel, or in some combination thereof. In some embodiments which include a stator cover, such as the embodiments of FIGS. 35 to 38, 39, 40, and 41 to 45, the heat-exchange network may regulate a temperature of the stator cover when the stator cover is held to the stator by regulating the temperature of the stator, as described above.

In general, embodiments such as those described herein may move one or more parts, such as but not limited to one or more biological samples, one or more devices, one or more drugs (which may be in suitable containers), one or more products being assembled, one or more raw parts, one or more materials, or a combination of two or more thereof, for example. Therefore, embodiments such as those described herein may be a magnetic movement apparatus or a moveable robot system that may include one or more moveable robotic devices. Embodiments such as those described herein may be used in the automation of various processes including packaging where workpieces need to be transported, sorted, weighed, or packaged, for example. Therefore, robotic/displacement systems such as those described herein for example may function as assembly systems or as other systems for packaging, transferring, printing, inspecting, analyzing, or filling, for example.

### EXAMPLES

This disclosure includes the following other examples as further illustrations of embodiments of the disclosure, which are not intended to limit the scope of the disclosure.

1. A stator module comprising:
a stator body;
a working surface extending by a width in a first dimension between first and second exposed opposite sides of the stator module, the working surface further extending by a length in a second dimension between first and second opposite ends of the stator module, the second dimension different from the first dimension, the length greater than the width; and
a plurality of electrical conductors, each electrical conductor of the plurality of electrical conductors extending along a respective portion of the working surface and operable to generate a magnetic field to facilitate moving, relative to the working surface, a magnetized mover in the magnetic field in response to electrical current through the electrical conductor;
at least some electrical conductors of the plurality of electrical conductors in a first layer of electrical conductors of the plurality of electrical conductors extending in a first electrical conductor direction; and
at least some electrical conductors of the plurality of electrical conductors in a second layer of electrical conductors of the plurality of electrical conductors separate from the first layer of electrical conductors extending in a second electrical conductor direction nonparallel to the first electrical conductor direction;
the at least some electrical conductors of the plurality of electrical conductors in the first layer at least partially overlapping the at least some electrical conductors of the plurality of electrical conductors in the second layer in a direction orthogonal to the first and second electrical conductor directions;
wherein the plurality of electrical conductors and the working surface are supported relative to the stator body such that the stator module is a unitary assembly.

2. The stator module of example 1 wherein at least some electrical conductors of the plurality of electrical conductors extend transversely relative to the working surface and entirely across at least a portion of the width of the working surface.

3. The stator module of example 2 wherein all of the electrical conductors of the stator module that extend along respective portions of the working surface and transversely relative to the working surface are within the at least a portion of the width of the working surface.

4. The stator module of example 2 wherein all of the electrical conductors of the stator module that extend along respective portions of the working surface and transversely relative to the working surface extend entirely across the at least a portion of the width of the working surface.

5. The stator module of example 2, 3, or 4 wherein the working surface covers a single row of electromagnetic driving regions, each electromagnetic driving region of the single row of electromagnetic driving regions comprising a respective subset of the plurality of electrical conductors that extend entirely across the at least a portion of the width of the working surface.

6. The stator module of example 5 wherein each electrical conductor of the respective subset of the plurality of electrical conductors of each electromagnetic driving region of the single row of electromagnetic driving regions extends substantially across the electromagnetic driving region.

7. The stator module of example 5 or 6 wherein the single row of electromagnetic driving regions comprises two electromagnetic driving regions.

8. The stator module of example 5, 6, or 7 wherein the single row of electromagnetic driving regions comprises four electromagnetic driving regions.

9. The stator module of example 5, 6, or 7 wherein each electromagnetic driving region of the single row of electromagnetic driving regions comprises:
a respective subset of the at least some electrical conductors of the plurality of electrical conductors in the first layer of electrical conductors; and
a respective subset of the at least some electrical conductors of the plurality of electrical conductors in the second layer of electrical conductors.

10. The stator module of any one of examples 2 to 9 wherein at least some electrical conductors of the plurality of electrical conductors extend longitudinally relative to the working surface.

11. The stator module of example 10 wherein the at least some electrical conductors of the plurality of electrical conductors extend transversely relative to the working surface are orthogonal to the at least some electrical conductors of the plurality of electrical conductors that extend longitudinally relative to the working surface.

12. The stator module of example 10 or 11, when directly or indirectly dependent from example 5, wherein each electromagnetic driving region of the single row of electromagnetic driving regions comprises a respective subset of the plurality of electrical conductors that extend longitudinally relative to the working surface.

13. The stator module of example 12 wherein the respective subset of the plurality of electrical conductors that extend longitudinally relative to the working surface of each electromagnetic driving region of the single row of electromagnetic driving regions is distinct from each respective subset of the plurality of electrical conductors that extend longitudinally relative to the working surface of each other electromagnetic driving region of the single row of electromagnetic driving regions.

14. The stator module of any one of examples 1 to 13 wherein each electromagnetic driving region of the plurality of electromagnetic driving regions abuts an adjacent at least one of the plurality of electromagnetic driving regions.

15. The stator module of any one of examples 1 to 14 wherein the stator module is substantially rectangular.

16. The stator module of any one of examples 1 to 15 wherein the working surface is substantially rectangular.

17. The stator module of any one of examples 1 to 14 wherein:
the working surface is in a plane;
the working surface is at least partially curved in the plane;
the width is a width between at-least-partially-curved sides of the working surface; and
the length comprises at least one curve length.

18. The stator module of any one of examples 1 to 17 wherein the stator module further comprises at least one guide positioned to guide movement of the mover relative to the stator module along the length of the working surface.

19. The stator module of example 18 wherein the at least one guide comprises at least one rail.

20. A stator module comprising:
a stator body;
a working surface supported relative to the stator body; and
a plurality of electrical conductors, each electrical conductor of the plurality of electrical conductors extending along a respective portion of the working surface and operable to generate a magnetic field to facilitate moving, relative to the working surface, a magnetized mover in the magnetic field in response to electrical current through the electrical conductor;
at least some electrical conductors of the plurality of electrical conductors in a first layer of electrical conductors of the plurality of electrical conductors extending in a first electrical conductor direction;
at least some electrical conductors of the plurality of electrical conductors in the first layer of electrical conductors of the plurality of electrical conductors extending in a second electrical conductor direction nonparallel to the first electrical conductor direction; and
at least some electrical conductors of the plurality of electrical conductors in a second layer of electrical conductors of the plurality of electrical conductors separate from the first layer of electrical conductors extending in a third electrical conductor direction nonparallel to the first electrical conductor direction and nonparallel to the second electrical conductor direction.

21. The stator module of example 20 wherein the first electrical conductor direction is orthogonal to the second electrical conductor direction.

22. The stator module of example 20 or 21 wherein the first electrical conductor direction is linear.

23. The stator module of example 20, 21, or 22 wherein the second electrical conductor direction is linear.

24. The stator module of example 20, 21, 22, or 23 wherein the third electrical conductor direction is curvilinear.

25. The stator module of any one of examples 20 to 24 wherein the at least some electrical conductors extending in the first electrical conductor direction at least partially overlap, in a direction orthogonal to the first and second electrical conductor directions, with the at least some electrical conductors extending in the third electrical conductor direction.

26. The stator module of any one of examples 20 to 25 wherein the at least some electrical conductors extending in the second electrical conductor direction at least partially overlap, in a direction orthogonal to the second and third electrical conductor directions, with the at least some electrical conductors extending in the third electrical conductor direction.

27. The stator module of any one of examples 20 to 26 wherein at least some electrical conductors of the plurality of electrical conductors are in a third layer of electrical conductors of the plurality of electrical conductors separate from the first and second layers of electrical conductors and extend in a fourth electrical conductor direction nonparallel to the first electrical conductor direction, nonparallel to the second electrical conductor direction, and nonparallel to the third electrical conductor direction.

28. The stator module of example 27 wherein the third electrical conductor direction is orthogonal to the fourth electrical conductor direction.

29. The stator module of example 27 or 28 wherein the fourth electrical conductor direction is curvilinear.

30. The stator module of example 27, 28, or 29 wherein the at least some electrical conductors extending in the first electrical conductor direction at least partially overlap, in a direction orthogonal to the first and fourth electrical conductor directions, with the at least some electrical conductors extending in the fourth electrical conductor direction.

31. The stator module of example 27, 28, 29, or 30 wherein the at least some electrical conductors extending in the second electrical conductor direction at least partially overlap, in a direction orthogonal to the second and fourth electrical conductor directions, with the at least some electrical conductors extending in the fourth electrical conductor direction.

32. A stator module comprising:
a stator body;
a working surface supported relative to the stator body;
a motor sub-module comprising a plurality of electrical conductors, each electrical conductor of the plurality of electrical conductors extending along a respective portion of the working surface and operable to generate a magnetic field to facilitate moving, relative to the working surface, a magnetized mover in the magnetic field in response to electrical current through the electrical conductor; and
a position-sensor sub-module comprising at least one position sensor operable to sense a position of the mover and defining a plurality of through-holes;
wherein the stator body comprises a surface and a plurality of protrusions, each protrusion of the plurality of protrusions extending from the surface, towards the motor sub-module, and through a respective through-hole of the plurality of through-holes of the position-sensor sub-module and supporting the motor sub-module.

33. The stator module of example 32 wherein the position-sensor sub-module comprises a position-sensor body defining the plurality of through-holes and supporting the at least one position sensor.

34. The stator module of example 33 wherein the position-sensor body is planar.

35. The stator module of example 32, 33, or 34 wherein the plurality of protrusions are spaced apart from each other in at least two dimensions.

36. The stator module of example 32, 33, or 34 wherein the plurality of protrusions are arranged in at least two rows and in at least two columns.

37. A robotic system comprising at least one stator module comprising a first stator module according to any one of examples 32 to 36.

38. A robotic system comprising at least one stator module comprising a first stator module according to any one of examples 20 to 31.

39. A robotic system comprising at least one stator module comprising a first stator module according to any one of examples 1 to 19.

40. The robotic system of example 39 wherein the at least one stator module further comprises a second stator module comprising:
a stator body;
a working surface supported relative to the stator body and having a side adjacent the first stator module, the side of the working surface of the second stator module having a greater extent than the width of the working surface of the first stator module; and
a plurality of electrical conductors, each electrical conductor of the plurality of electrical conductors extending along a respective portion of the working surface and operable to generate a magnetic field to facilitate moving, relative to the working surface, the magnetized mover in the magnetic field in response to electrical current through the electrical conductor;
wherein the robotic system is operable to move the magnetized mover between the working surface of the first stator module and the working surface of the second stator module in response to electrical current through at least one electrical conductor of the pluralities of electrical conductors of the first and second stator modules.

41. The robotic system of example 40 wherein the side of the working surface of the second stator module is adjacent the first end of the first stator module.

42. The robotic system of example 40 or 41 wherein the side of the working surface of the second stator module abuts the first end of the first stator module.

43. The robotic system of example 40, 41, or 42 wherein the first stator module abuts the second stator module.

44. The robotic system of example 40, 41, 42, or 43 wherein the second stator module comprises a plurality of electromagnetic driving regions, each electromagnetic driving region of the second stator module comprising a respective subset of the plurality of electrical conductors of the second stator module.

45. The robotic system of example 44 wherein the plurality of electromagnetic driving regions of the second stator module are in respective ones of a plurality of rows and respective ones of a plurality of columns of the plurality of electromagnetic driving regions of the second stator module.

46. The robotic system of example 44 wherein the plurality of electromagnetic driving regions of the second stator module are in a single row.

47. The robotic system of any one of examples 40 to 46 wherein the working surface of the second stator module has a width and a length equal to the width.

48. The robotic system of any one of examples 40 to 46 wherein the working surface of the second stator module has a width and a length greater than the width.

49. The robotic system of example 48 wherein the side of the working surface of the second stator module extends along the width of the working surface of the second stator module.

50. The robotic system of example 48 wherein the side of the working surface of the second stator module extends along the length of the working surface of the second stator module.

51. The robotic system of any one of examples 40 to 50 wherein, in the second stator module:
at least some electrical conductors of the plurality of electrical conductors are in a first layer of electrical conductors of the plurality of electrical conductors extending in a first electrical conductor direction;
at least some electrical conductors of the plurality of electrical conductors are in a second layer of electrical conductors of the plurality of electrical conductors separate from the first layer of electrical conductors extending in a second electrical conductor direction nonparallel to the first electrical conductor direction; and
the at least some electrical conductors of the plurality of electrical conductors in the first layer at least partially overlap the at least some electrical conductors of the plurality of electrical conductors in the second layer in a direction orthogonal to the first and second electrical conductor directions.

52. The stator module of example 51, when directly or indirectly dependent from example 44, wherein, in the second stator module, each electromagnetic driving region of the plurality of electromagnetic driving regions comprises:
a respective subset of the at least some electrical conductors of the plurality of electrical conductors in the first layer of electrical conductors; and
a respective subset of the at least some electrical conductors of the plurality of electrical conductors in the second layer of electrical conductors.

53. The robotic system of any one of examples 38 to 52 wherein each stator module of the at least one stator module further comprises a respective position-sensor sub-module operable to sense a position of the mover.

54. The robotic system of any one of examples 33 to 53 further comprising the mover.

55. The robotic system of example 54 wherein the mover comprises a plurality of permanent magnets.

56. The robotic system of example 55 wherein: at least some of the plurality of permanent magnets are magnetized in a first magnetization direction; and at least some of the plurality of permanent magnets are magnetized in a second magnetization direction nonparallel to the first magnetization direction.

57. The robotic system of example 54, 55, or 56, when indirectly dependent from example 19, wherein the mover comprises at least one roller operable to roll on the at least one rail such that the at least one roller rolling on the at least one rail guides movement of the mover relative to the stator module along the length of the working surface.

58. The robotic system of example 54, 55, or 56, when indirectly dependent from example 19, wherein the mover comprises at least one slider operable to slide on the at least one rail such that the at least one roller rolling on the at least one rail guides movement of the mover relative to the stator module along the length of the working surface.

59. The robotic system of example 54, 55, or 56, when indirectly dependent from example 19, wherein the mover comprises at least one contact surface roller operable to contact the at least one rail such that the at least one contact surface contacting the at least one rail guides movement of the mover relative to the stator module along the length of the working surface.

60. The robotic system of any one of examples 33 to 59 further comprising a control system operable to, at least, directly or indirectly control electrical current through each electrical conductor of the plurality of electrical conductors of each stator module of the at least one stator module to cause the mover to move relative to the at least one stator module.

61. The robotic system of example 60 wherein the control system is a control circuit.

62. The robotic system of example 60 or 61 wherein the control system is operable to, at least, directly or indirectly control electrical current through at least some electrical conductors of the plurality of electrical conductors of the first stator module to cause the mover to move in a longitudinal direction relative to the first stator module between the first and second ends of the first stator module.

63. The robotic system of example 60, 61, or 62 wherein each stator module of the at least one stator module further comprises at least one amplifier operable to amplify control signals generated at least partially based on at least one signal received from the control system to control each electrical conductor of the plurality of electrical conductors of each stator module of the at least one stator module to cause the mover to move relative to the at least one stator module.

64. The robotic system of any one of examples 33 to 63 wherein the stator body of each stator module of the at least one stator module is a unitary body supporting the plurality of electrical conductors of the stator module.

65. The robotic system of any one of examples 33 to 64 wherein each stator module of the at least one stator module comprises electrical circuitry common to the plurality of electrical conductors of the stator module and operable to control electrical current through each electrical conductor of the plurality of electrical conductors of the stator module.

66. The robotic system of example 65 wherein, in each stator module of the at least one stator module, the electrical circuitry is housed within the stator body.

67. The robotic system of any one of examples 33 to 66 wherein each stator module of the at least one stator module comprises a communication device operable to communicate data between the stator module and one or more other stator modules.

68. The robotic system of example 67 wherein, in each stator module of the at least one stator module, the communication device is housed within the stator body.

69. A robotic system comprising:
a magnetized mover extending by a mover width in a first mover direction and extending by a mover length in a second mover direction different than the first mover direction;
a stator comprising:
a stator body;
a working surface supported relative to the stator body and extending by a working surface width in a first working surface dimension between first and second exposed opposite sides of the stator, the working surface further extending by a working surface length in a second working surface dimension between first and second opposite ends of the stator, the second working surface dimension different from the first working surface dimension, the working surface length greater than the working surface width; and
a plurality of electrical conductors, each electrical conductor of the plurality of electrical conductors extending along a respective portion of the working surface and operable to generate a magnetic field to facilitate moving, relative to the working surface, the magnetized mover in the magnetic field in response to electrical current through the electrical conductor,
wherein the mover width is greater than the working surface width.

70. The robotic system of example 69 wherein: the first mover direction is perpendicular to the second mover direction; and the mover length is greater than the working surface width.

71. The robotic system of example 70 wherein the mover length is approximately equal or equal to the mover width.

72. The robotic system of example 69 wherein the mover width is less than the working surface length.

73. The robotic system of example 69 wherein the magnetized mover comprises one or more magnets.

74. The robotic system of example 73 wherein the one or more magnets extend by a magnet width in the first mover direction, the magnet width greater than the working surface width.

75. The robotic system of example 74 wherein the one or more magnets comprise a plurality of magnets.

76. The robotic system of example 75 wherein magnets of the plurality of magnets are rigidly connected together.

77. The robotic system of example 73 wherein the stator is operable to, in response to electrical current through at least one electrical conductor of the plurality of electrical conductors, move the magnetized mover along the working surface in a movement direction such that, as the magnetized mover moves along the working surface in the movement direction, the one or more magnets extend a magnet extent along the first working surface dimension, the magnet extent greater than the working surface width.

78. The robotic system of example 69 wherein the stator is operable to, in response to electrical current through at least one electrical conductor of the plurality of electrical conductors, move the magnetized mover along the working surface in a movement direction such that, as the magnetized mover moves along the working surface in the movement direction, the magnetized mover extends a mover extent along the first working surface dimension, the mover extent greater than the working surface width.

79. The robotic system of example 78 wherein the movement direction is transverse to the first working surface dimension.

80. The robotic system of example 78 wherein the movement direction extends between the first and second opposite ends of the stator.

81. The robotic system of example 69 wherein the stator is operable to levitate the magnetized mover relative to the working surface.

82. The robotic system of example 69 wherein the stator is operable to move the magnetized mover relative to the working surface in at least two degrees of freedom.

83. The robotic system of example 82 wherein the stator is operable to move the magnetized mover relative to the working surface in at least three degrees of freedom.

84. A method of operating a robotic system comprising a magnetized mover and a stator, the method comprising:
causing the magnetized mover to move along a working surface of the stator in a movement direction such that, as the magnetized mover moves along the working surface in the movement direction, the magnetized mover extends a mover extent in an overhang direction along the working surface, the working surface extending a working surface extent in the overhang direction, the working surface extent in the overhang direction less than the mover extent in the overhang direction,
wherein causing the magnetized mover to move along the working surface in the movement direction comprises passing electrical current through at least one electrical conductor of the stator to generate a magnetic field to facilitate moving the magnetized mover relative to the working surface.

85. The method of example 84 wherein the overhang direction is transverse to the movement direction.

86. The method of example 85 wherein:
the working surface extends the working surface extent in the overhang direction between first and second exposed opposite sides of the stator; and
causing the magnetized mover to move along the working surface in the movement direction comprises causing the magnetized mover to move along the working surface in the movement direction such that the magnetized mover extends, in the overhang direction, beyond the first exposed side of the stator and beyond the second exposed side of the stator.

87. The method of example 84 wherein:
the magnetized mover comprises at least one magnet; and
causing the magnetized mover to move along the working surface in the movement direction comprises causing the magnetized mover to move along the working surface in the movement direction such that the at least one magnet extends a magnet extent in the overhang direction, the magnet extent in the overhang direction greater than the working surface extent in the overhang direction.

88. The method of example 84 wherein causing the magnetized mover to move along the working surface in the movement direction comprises causing the magnetized mover to move along the working surface in the movement direction when the magnetized mover is not loaded.

89. A method of operating a robotic system comprising a magnetized mover, a first stator, and a second stator, the method comprising:
causing the magnetized mover to move along a working surface of the first stator to an unloading position on the working surface of the first stator, wherein causing the magnetized mover to move along the working surface of the first stator to the unloading position comprises passing electrical current through at least one electrical conductor of the first stator to generate a first magnetic field to facilitate moving the magnetized mover relative to the working surface of the first stator;
when the magnetized mover is at the unloading position on the working surface of the first stator, unloading the magnetized mover;
causing the magnetized mover to move from the unloading position on the working surface of the first stator to a working surface of the second stator; and
causing the magnetized mover to move along the working surface of the second stator in a movement direction such that, as the magnetized mover moves along the working surface of the second stator in the movement direction, the magnetized mover extends a mover extent in an overhang direction along the working surface of the second stator, the working surface of the second stator extending a working surface extent in the overhang direction, the working surface extent in the overhang direction less than the mover extent in the overhang direction, wherein causing the magnetized mover to move along the working surface of the second stator in the movement direction comprises passing electrical current through at least one electrical conductor of the second stator to generate a second magnetic field to facilitate moving the magnetized mover relative to the working surface of the second stator.

90. The method of example 89 further comprising returning the magnetized mover to a loading area of the robotic system, wherein returning the magnetized mover to the loading area comprises causing the magnetized mover to move along the working surface of the second stator in the movement direction.

91. A method of holding a cover to a stator of a displacement system, the stator comprising a holding surface and at least one electrical conductor positioned to generate at least one magnetic field external to the stator and operable to move at least one mover in a working environment of the displacement system, the cover comprising a first surface facing the holding surface of the stator and a second surface across the cover from the first surface, the method comprising:
causing a first fluid pressure in at least a space between the holding surface of the stator and the first surface of the cover to be lower than a second fluid pressure at the second surface of the cover to urge the cover toward the holding surface to hold the cover to the stator.

92. The method of example 91 further comprising, before causing the first fluid pressure to be lower than the second fluid pressure, positioning the cover proximate the stator with the first surface facing the holding surface.

93. The method of example 92 wherein positioning the cover proximate the stator comprises positioning the cover between the stator and the working environment.

94. The method of example 93 further comprising causing one or more of the at least one mover to push the cover toward the holding surface.

95. The method of any one of examples 91 to 94 wherein the holding surface of the stator is positioned to face the working environment.

96. The method of any one of examples 91 to 95 wherein causing the first fluid pressure to be lower than the second fluid pressure comprises causing a vacuum source to remove at least some fluid from the space between the holding surface of the stator and the first surface of the cover.

97. The method of example 96 wherein the vacuum source comprises a vacuum pump.

98. The method of example 96 or 97 wherein the vacuum source comprises a vacuum accumulator.

99. The method of example 96, 97, or 98 wherein:
the stator further comprises a stator body comprising the holding surface;
the stator body defines an internal conduit comprising at least one conduit opening in the holding surface; and
causing the vacuum source to remove the at least some fluid from the space between the holding surface of the stator and the first surface of the cover comprises causing the vacuum source to remove the at least some fluid from the space between the holding surface of the stator and the first surface of the cover through the at least one conduit opening and at least a portion of the internal conduit.

100. The method of example 99 wherein:
the stator body further comprises an access surface different from the holding surface;
the internal conduit further comprises at least one access opening in the access surface; and
causing the vacuum source to remove the at least some fluid from the space between the holding surface of the stator and the first surface of the cover comprises causing the vacuum source to remove the at least some fluid from the space between the holding surface of the stator and the first surface of the cover through the at least one conduit opening, the at least a portion of the internal conduit, and the at least one access opening.

101. The method of example 99 or 100 when directly or indirectly dependent from example 98 wherein causing the vacuum source to remove the at least some fluid from the space between the holding surface of the stator and the first surface of the cover comprises:
removing at least some fluid from the vacuum accumulator while preventing fluid communication between the vacuum accumulator and the internal conduit; and
after removing the at least some fluid from the vacuum accumulator, causing the vacuum accumulator to be in fluid communication with the internal conduit.

102. The method of example 99, 100, or 101 further comprising preventing fluid from flowing from the internal conduit into the space between the holding surface of the stator and the first surface of the cover through the at least one conduit opening.

103. The method of example 102 wherein preventing fluid from flowing from the internal conduit into the space between the holding surface of the stator and the first surface of the cover through the at least one conduit opening comprises causing at least one valve to prevent fluid from flowing through at least a portion of the internal conduit.

104. The method of example 103 wherein the valve is positioned in the internal conduit.

105. The method of any one of examples 99 to 104 wherein the stator further comprises at least one check valve configured to prevent fluid from flowing from the internal conduit into the space between the holding surface of the stator and the first surface of the cover through the at least one conduit opening.

106. The method of example 105 wherein the at least one check valve is positioned in the internal conduit.

107. The method of any one of examples 91 to 106 wherein the space between the holding surface of the stator and the first surface of the cover comprises at least one cavity defined by at least one spacer between the holding surface of the stator and the first surface of the cover.

108. The method of example 107 wherein when the cover is held to the stator, the at least one spacer supports the cover on the holding surface of the stator.

109. The method of example 107 or 108 wherein when the cover is held to the stator, the at least one spacer seals at least a portion of the space within the at least one cavity from an exterior of the stator.

110. The method of example 109 wherein, in response to the cover being held to the stator, the at least one spacer deforms to seal the at least a portion of the space within the at least one cavity from the exterior of the stator.

111. The method of any one of examples 107 to 110 wherein a line normal to the holding surface of the stator and extending between the holding surface and the first surface of the cover when the cover is held to the stator passes through the at least one cavity and the at least one spacer.

112. The method of any one of examples 107 to 111 wherein:
the at least one spacer comprises a first spacer layer and a second spacer layer, at least a portion of the second spacer layer between at least a portion of the first spacer layer and the holding surface of the stator;
the first spacer layer defines a first cavity portion of the at least one cavity;
the second spacer layer defines a second cavity portion of the at least one cavity, the second cavity portion in fluid communication with the first cavity portion; and
a portion of the first spacer layer is exposed within the second cavity portion.

113. The method of any one of examples 107 to 112 wherein:
the at least one spacer comprises at least one contact surface contacting the first surface of the cover at least when the cover is held to the stator; and
the at least one cavity comprises at least one cavity opening in the at least one contact surface.

114. The method of example 113 wherein:
the at least one contact surface extends a contact-surface extent along the holding surface; and
the at least one cavity opening extends at least 50% of the contact-surface extent.

115. The method of example 114 wherein the at least one cavity opening extends at least 60% of the contact-surface extent.

116. The method of example 114 wherein the at least one cavity opening extends at least 70% of the contact-surface extent.

117. The method of example 114 wherein the at least one cavity opening extends at least 80% of the contact-surface extent.

118. The method of any one of examples 113 to 117 wherein the at least one cavity comprises a first plurality of channels extending parallel to one another in a first direction along the at least one contact surface.

119. The method of example 118 wherein the at least one cavity further comprises a second plurality of channels extending parallel to one another in a second direction along the at least one contact surface, the second direction transverse to the first direction.

120. The method of any one of examples 107 to 119 wherein:
the at least one spacer comprises a porous material defining a plurality of pores; and
the at least one cavity comprises the plurality of pores.

121. The method of any one of examples 107 to 120 wherein each of the at least one cavity is in fluid communication with each other one of the at least one cavity.

122. The method of any one of examples 107 to 121 when directly or indirectly dependent from example 99 wherein the at least one cavity is in fluid communication with the at least one conduit opening.

123. The method of example 122 wherein each of the at least one cavity is in fluid communication with one or more of the at least one conduit opening.

124. The method of any one of examples 107 to 123 wherein the at least one spacer is attached to the holding surface.

125. The method of any one of examples 107 to 124 wherein the at least one spacer comprises vinyl.

126. The method of any one of examples 107 to 125 wherein the at least one spacer comprises thermoplastic polyurethane.

127. The method of any one of examples 91 to 126 further comprising using a pressure sensor to measure the first fluid pressure.

128. The method of any one of examples 91 to 127 further comprising regulating a temperature of the cover when the cover is held to the stator.

129. The method of example 128 wherein regulating the temperature of the cover comprises regulating a temperature of the stator.

130. The method of example 129 wherein regulating the temperature of the stator comprises causing a heat exchange fluid to flow through at least one heat exchange conduit of the stator.

131. The method of any one of examples 91 to 130 wherein the cover is configured to maintain separation between the stator and the working environment at least when the cover is held to the stator.

132. The method of any one of examples 91 to 131 wherein the second surface of the cover comprises a working surface configured to be between the at least one mover and the stator when the at least one mover is moving in response to the at least one magnetic field.

133. The method of any one of examples 91 to 132 wherein:
the first surface of the cover has a first-surface surface area;
the holding surface of the stator has a holding-surface surface area; and
the first-surface surface area is at least 75% of the holding-surface surface area.

134. The method of any one of examples 91 to 133 wherein at least a portion of the cover generally conforms to at least a portion of the holding surface.

135. The method of any one of examples 91 to 134 wherein the at least one magnetic field is operable to move the at least one mover in at least two degrees of freedom in the working environment.

136. A stator for a displacement system, the stator comprising:
at least one electrical conductor positioned to generate at least one magnetic field external to the stator and operable to move at least one mover in a working environment of the displacement system; and
a stator body comprising a holding surface and an access surface different from the holding surface, the stator body defining an internal conduit comprising at least one conduit opening in the holding surface and at least one access opening in the access surface, the at least one access opening in fluid communication with the at least one conduit opening through the internal conduit.

137. The stator of example 136 further comprising at least one valve positioned in the internal conduit and operable to prevent fluid from flowing through at least a portion of the internal conduit.

138. The stator of example 136 or 137 further comprising at least one check valve positioned in the internal conduit and configured to prevent fluid from flowing out of the internal conduit through the at least one conduit opening.

139. The stator of example 136, 137, or 138 further comprising an internal pressure sensor positioned to measure a fluid pressure in the internal conduit.

140. A stator device for a displacement system, the stator device comprising:
the stator of any one of examples 136 to 139; and
a vacuum source in fluid communication with the internal conduit through the at least one access opening, the vacuum source operable to remove, through the at least one conduit opening, at least a portion of the internal conduit, and the at least one access opening, at least some fluid from a space between the holding surface of the stator and a mover positioned in the working environment proximate the holding surface at the at least one conduit opening, the mover operable to move in the working environment in response to the at least one external magnetic field generated by the at least one electrical conductor of the stator,
wherein removal, by the vacuum source, of the at least some fluid from the space between the holding surface of the stator and the mover causes a first fluid pressure, in at least the space between the holding surface of the stator and the mover, to be lower than a second fluid pressure in the working environment.

141. A stator device for a displacement system, the stator device comprising:
the stator of any one of examples 136 to 139; and
a vacuum source in fluid communication with the internal conduit through the at least one access opening, the vacuum source operable to remove, through the at least one conduit opening, at least a portion of the internal conduit, and the at least one access opening, at least some fluid from a space between the holding surface of the stator and a first surface of a cover positioned proximate the stator with the first surface facing the holding surface,
wherein removal, by the vacuum source, of the at least some fluid from the space between the holding surface of the stator and the first surface of the cover causes a first fluid pressure, in at least the space between the holding surface of the stator and the first surface of the cover, to be lower than a second fluid pressure, at a second surface of the cover across the cover from the first surface, to urge the cover toward the holding surface to hold the cover to the stator.

142. A stator device for a displacement system, the stator device comprising:
a stator comprising:
at least one electrical conductor positioned to generate at least one magnetic field external to the stator and operable to move at least one mover in a working environment of the displacement system; and
a holding surface; and
a vacuum source operable to cause a first fluid pressure, in at least a space between the holding surface of the stator and a first surface of a cover positioned proximate the stator with the first surface facing the holding surface, to be lower than a second fluid pressure, at a second surface of the cover across the cover from the first surface, to urge the cover toward the holding surface to hold the cover to the stator.

143. The stator device of example 141 or 142 wherein the vacuum source is operable to cause the first fluid pressure to be lower than the second fluid pressure at least when the cover is positioned between the stator and the working environment.

144. The stator device of example 141, 142, or 143 wherein the cover is configured to maintain separation between the stator and the working environment at least when the cover is held to the stator.

145. The stator device of any one of examples 141 to 144 further comprising the cover.

146. The stator device of any one of examples 141 to 145 further comprising at least one spacer positionable on the holding surface of the stator to be between the holding surface and the first surface of the cover at least when the cover is positioned proximate the stator with the first surface facing the holding surface, wherein:
the at least one spacer defines at least one cavity; and
the space between the holding surface of the stator and the first surface of the cover comprises the at least one cavity.

147. The stator device of example 146 wherein the at least one spacer supports the cover on the holding surface at least when the at least one spacer is positioned on the holding surface of the stator and the cover is held to the stator.

148. The stator device of example 146 or 147 wherein the at least one spacer is configured to seal at least a portion of the space within the at least one cavity from an exterior of the stator at least when the at least one spacer is positioned on the holding surface of the stator and the cover is held to the stator.

149. The stator device of example 148 wherein the at least one spacer is configured to deform, in response to the cover being held to the stator, to seal the at least a portion of the space within the at least one cavity from the exterior of the stator.

150. The stator device of any one of examples 146 to 149 wherein, when the at least one spacer is positioned on the holding surface of the stator and the cover is held to the stator, a line normal to the holding surface and extending between the holding surface and the first surface of the cover passes through the at least one cavity and the at least one spacer.

151. The stator device of any one of examples 146 to 150 wherein:
the at least one spacer comprises a first spacer layer and a second spacer layer, at least a portion of the second spacer layer between at least a portion of the first spacer layer and the holding surface of the stator when the at least one spacer is positioned on the holding surface;
the first spacer layer defines a first cavity portion of the at least one cavity;
the second spacer layer defines a second cavity portion of the at least one cavity, the second cavity portion in fluid communication with the first cavity portion; and
a portion of the first spacer layer is exposed within the second cavity portion.

152. The stator device of any one of examples 146 to 151 wherein:
the at least one spacer comprises at least one contact surface positioned to contact the first surface of the cover at least when the at least one spacer is positioned on the holding surface of the stator and the cover is held to the stator; and
the at least one cavity comprises at least one cavity opening in the at least one contact surface.

153. A stator device for a displacement system, the stator device comprising:
the stator of any one of examples 136 to 139; and
a cover comprising:
a first surface facing the holding surface of the stator; and
a second surface across the cover from the first surface,
wherein a first fluid pressure, in at least a space between the holding surface of the stator and the first surface of the cover, is lower than a second fluid pressure, at the second surface of the cover, to urge the cover toward the holding surface to hold the cover to the stator.

154. The stator device of example 153 further comprising a vacuum source in fluid communication with the internal conduit through the at least one access opening, wherein:
the vacuum source is operable to remove, through the at least one conduit opening, at least a portion of the internal conduit, and the at least one access opening, at least some fluid from the space between the holding surface of the stator and the first surface of the cover; and
removal, by the vacuum source, of the at least some fluid from the space between the holding surface of the stator and the first surface of the cover causes the first fluid pressure to be lower than the second fluid pressure.

155. A stator device for a displacement system, the stator device comprising:
a stator comprising:
at least one electrical conductor positioned to generate at least one magnetic field external to the stator and operable to move at least one mover in a working environment of the displacement system; and
a holding surface; and
a cover comprising:
a first surface facing the holding surface of the stator; and
a second surface across the cover from the first surface,
wherein a first fluid pressure, in at least a space between the holding surface of the stator and the first surface of the cover, is lower than a second fluid pressure, at the second surface of the cover, to urge the cover toward the holding surface to hold the cover to the stator.

156. The stator device of example 153, 154, or 155 wherein the cover is positioned between the stator and the working environment.

157. The stator device of any one of examples 153 to 156 wherein the cover is configured to maintain separation between the stator and the working environment.

158. The stator device of any one of examples 153 to 157 further comprising at least one spacer between the holding surface of the stator and the first surface of the cover, wherein:
the at least one spacer defines at least one cavity; and
the space between the holding surface of the stator and the first surface of the cover comprises the at least one cavity.

159. The stator device of example 158 wherein the at least one spacer supports the cover on the holding surface.

160. The stator device of example 158 or 159 wherein the at least one spacer seals at least a portion of the space within the at least one cavity from an exterior of the stator.

161. The stator device of example 158, 159, or 160 wherein a line normal to the holding surface of the stator and extending between the holding surface and the first surface of the cover passes through the at least one cavity and the at least one spacer.

162. The stator device of any one of examples 158 to 161 wherein:
the at least one spacer comprises a first spacer layer and a second spacer layer, at least a portion of the second spacer layer between at least a portion of the first spacer layer and the holding surface of the stator;
the first spacer layer defines a first cavity portion of the at least one cavity;
the second spacer layer defines a second cavity portion of the at least one cavity, the second cavity portion in fluid communication with the first cavity portion; and
a portion of the first spacer layer is exposed within the second cavity portion.

163. The stator device of any one of examples 158 to 162 wherein:
the at least one spacer comprises at least one contact surface contacting the first surface of the cover; and
the at least one cavity comprises at least one cavity opening in the at least one contact surface.

164. The stator device of example 152 or 163 wherein:
the at least one contact surface extends a contact-surface extent along the holding surface; and
the at least one cavity opening extends at least 50% of the contact-surface extent.

165. The stator device of example 164 wherein the at least one cavity opening extends at least 60% of the contact-surface extent.

166. The stator device of example 164 wherein the at least one cavity opening extends at least 70% of the contact-surface extent.

167. The stator device of example 164 wherein the at least one cavity opening extends at least 80% of the contact-surface extent.

168. The stator device of example 152, or any one of examples 163 to 167 wherein the at least one cavity comprises a first plurality of channels extending parallel to one another in a first direction along at least one contact surface.

169. The stator device of example 168 wherein the at least one cavity further comprises a second plurality of channels extending parallel to one another in a second direction along the at least one contact surface, the second direction transverse to the first direction.

170. The stator device of any one of examples 146 to 152 or 158 to 169 wherein:
the at least one spacer comprises a porous material defining a plurality of pores; and
the at least one cavity comprises the plurality of pores.

171. The stator device of any one of examples 146 to 152 or 158 to 170 wherein each of the at least one cavity is in fluid communication with each other one of the at least one cavity.

172. The stator device of any one of examples 146 to 152 or 158 to 171 wherein the at least one spacer is attached to the holding surface.

173. The stator device of any one of examples 146 to 152 or 158 to 172 wherein the at least one spacer comprises vinyl.

174. The stator device of any one of examples 146 to 152 or 158 to 173 wherein the at least one spacer comprises thermoplastic polyurethane.

175. The stator device of example 155, or of any one of examples 156 to 174 when directly or indirectly dependent from example 155, further comprising a vacuum source operable to cause the first fluid pressure to be lower than the second fluid pressure.

176. The stator device of any one of examples 141 to 152, 154, or 175 wherein the vacuum source comprises a vacuum pump.

177. The stator device of any one of examples 141 to 152, 154, 175, or 176 wherein the vacuum source comprises a vacuum accumulator.

178. The stator device of example 142, of any one of examples 143 to 152 when directly or indirectly dependent from example 142, of example 175, or of example 176 or 177 when directly or indirectly dependent from example 142 or 175, wherein the vacuum source is operable to remove at least some fluid from the space between the holding surface of the stator and the first surface of the cover to cause the first fluid pressure to be lower than the second fluid pressure.

179. The stator device of example 178 wherein:
the stator further comprises a stator body comprising the holding surface;
the stator body defines an internal conduit comprising at least one conduit opening in the holding surface; and
the vacuum source is in fluid communication with the internal conduit to remove the at least some fluid from the space between the holding surface of the stator and the first surface of the cover through the at least one conduit opening and at least a portion of the internal conduit.

180. The stator device of example 179 when directly or indirectly dependent from example 146 wherein the at least one cavity is in fluid communication with the at least one conduit opening when the at least one spacer is positioned on the holding surface of the stator.

181. The stator device of example 180 wherein each of the at least one cavity is in fluid communication with one or more of the at least one conduit opening when the at least one spacer is positioned on the holding surface of the stator.

182. The stator device of example 179 when directly or indirectly dependent from example 158 wherein the at least one cavity is in fluid communication with the at least one conduit opening.

183. The stator device of example 182 wherein each of the at least one cavity is in fluid communication with one or more of the at least one conduit opening.

184. The stator device of any one of examples 179 to 183 wherein:
the stator body further comprises an access surface different from the holding surface;
the internal conduit further comprises at least one access opening in the access surface; and
the vacuum source is in fluid communication with the internal conduit through the at least one access opening.

185. The stator device of any one of examples 179 to 184 further comprising at least one valve operable to prevent fluid from flowing through at least a portion of the internal conduit.

186. The stator device of example 185 wherein the at least one valve is positioned in the internal conduit.

187. The stator device of any one of examples 179 to 186 further comprising at least one check valve configured to prevent fluid from flowing from the internal conduit into the space between the holding surface of the stator and the first surface of the cover through the at least one conduit opening.

188. The stator device of example 187 wherein the at least one check valve is positioned in the internal conduit.

189. The stator device of example 146 when directly or indirectly dependent from example 141, or of any one of examples 147 to 152 or 164 to 177 when directly or indirectly dependent from examples 146 and 141, wherein the at least one cavity is in fluid communication with the at least one conduit opening when the at least one spacer is positioned on the holding surface of the stator.

190. The stator device of example 189 wherein each of the at least one cavity is in fluid communication with one or more of the at least one conduit opening when the at least one spacer is positioned on the holding surface of the stator.

191. The stator device of example 158 when directly or indirectly dependent from example 153 or of any one of examples 159 to 177 when directly or indirectly dependent from examples 158 and 153 wherein the at least one cavity is in fluid communication with the at least one conduit opening.

192. The stator device of example 191 wherein each of the at least one cavity is in fluid communication with one or more of the at least one conduit opening.

193. The stator device of any one of examples 141 to 192 further comprising a pressure sensor positioned to measure the first fluid pressure.

194. The stator device of any one of examples 141 to 193 wherein the second surface of the cover comprises a working surface configured to be between the at least one mover and the stator when the at least one mover is moving in response to the at least one magnetic field.

195. The stator device of any one of examples 141 to 194 wherein:
the first surface of the cover has a first-surface surface area;
the holding surface of the stator has a holding-surface surface area; and
the first-surface surface area is at least 75% of the holding-surface surface area.

196. The stator device of any one of examples 141 to 195 wherein at least a portion of the cover generally conforms to at least a portion of the holding surface.

197. The stator of any one of examples 136 to 139 or the stator device of any one of examples 141 to 196 wherein the stator defines at least one heat exchange conduit for conveying a heat exchange fluid through the stator.

198. The stator of any one of examples 136 to 139 or 197 or the stator device of any one of examples 141 to 197 wherein the holding surface of the stator is positioned to face the working environment.

199. The stator of any one of examples 136 to 139, 197, or 198 or the stator device of any one of examples 141 to 198 wherein the at least one external magnetic field is operable to move the at least one mover in at least two degrees of freedom in the working environment.

Although specific embodiments have been described and illustrated, such embodiments should be considered illustrative only and not as limiting the invention as construed according to the accompanying claims.

1. A method of holding a cover to a stator of a displacement system, the stator comprising a holding surface and at least one electrical conductor positioned to generate at least one magnetic field external to the stator and operable to move at least one mover in a working environment of the displacement system, the cover comprising a first surface facing the holding surface of the stator and a second surface across the cover from the first surface, the method comprising:
causing a first fluid pressure in at least a space between the holding surface of the stator and the first surface of the cover to be lower than a second fluid pressure at the second surface of the cover to urge the cover toward the holding surface to hold the cover to the stator.

2. The method of claim 1 further comprising, before causing the first fluid pressure to be lower than the second fluid pressure, positioning the cover proximate the stator with the first surface facing the holding surface.

3. The method of claim 2 wherein positioning the cover proximate the stator comprises positioning the cover between the stator and the working environment.

4. The method of claim 3 further comprising causing one or more of the at least one mover to push the cover toward the holding surface.

5. The method of claim 1 wherein causing the first fluid pressure to be lower than the second fluid pressure comprises causing a vacuum source to remove at least some fluid from the space between the holding surface of the stator and the first surface of the cover.

6. The method of claim 5 wherein the vacuum source comprises a vacuum accumulator.

7. The method of claim 6 wherein:
the stator further comprises a stator body comprising the holding surface;
the stator body defines an internal conduit comprising at least one conduit opening in the holding surface; and
causing the vacuum source to remove the at least some fluid from the space between the holding surface of the stator and the first surface of the cover comprises:
removing at least some fluid from the vacuum accumulator while preventing fluid communication between the vacuum accumulator and the internal conduit; and
after removing the at least some fluid from the vacuum accumulator, causing the vacuum accumulator to be in fluid communication with the internal conduit to remove the at least some fluid from the space between the holding surface of the stator and the first surface of the cover through the at least one conduit opening and at least a portion of the internal conduit.

8. The method of claim 5 wherein:
the stator further comprises a stator body comprising the holding surface;
the stator body defines an internal conduit comprising at least one conduit opening in the holding surface; and
the method further comprises preventing fluid from flowing from the internal conduit into the space between the holding surface of the stator and the first surface of the cover through the at least one conduit opening.

9. The method of claim 1 wherein the space between the holding surface of the stator and the first surface of the cover comprises at least one cavity defined by at least one spacer between the holding surface of the stator and the first surface of the cover.

10. The method of claim 1 further comprising using a pressure sensor to measure the first fluid pressure.

11. The method of claim 1 further comprising regulating a temperature of the cover when the cover is held to the stator.

12. The method of claim 1 wherein the second surface of the cover comprises a working surface configured to be between the at least one mover and the stator when the at least one mover is moving in response to the at least one magnetic field.

13. The method of claim 1 wherein the at least one magnetic field is operable to move the at least one mover in at least two degrees of freedom in the working environment.

14. A stator for a displacement system, the stator comprising:
at least one electrical conductor positioned to generate at least one magnetic field external to the stator and operable to move at least one mover in a working environment of the displacement system; and
a stator body comprising a holding surface and an access surface different from the holding surface, the stator body defining an internal conduit comprising at least one conduit opening in the holding surface and at least one access opening in the access surface, the at least one access opening in fluid communication with the at least one conduit opening through the internal conduit.

15. A stator device for a displacement system, the stator device comprising:
the stator of claim 14; and
a vacuum source in fluid communication with the internal conduit through the at least one access opening, the vacuum source operable to remove, through the at least one conduit opening, at least a portion of the internal conduit, and the at least one access opening, at least some fluid from a space between the holding surface of the stator and a mover positioned in the working environment proximate the holding surface at the at least one conduit opening, the mover operable to move in the working environment in response to the at least one external magnetic field generated by the at least one electrical conductor of the stator,
wherein removal, by the vacuum source, of the at least some fluid from the space between the holding surface of the stator and the mover causes a first fluid pressure, in at least the space between the holding surface of the stator and the mover, to be lower than a second fluid pressure in the working environment.

16. A stator device for a displacement system, the stator device comprising:
the stator of claim 14; and
a vacuum source in fluid communication with the internal conduit through the at least one access opening, the vacuum source operable to remove, through the at least one conduit opening, at least a portion of the internal conduit, and the at least one access opening, at least some fluid from a space between the holding surface of the stator and a first surface of a cover positioned proximate the stator with the first surface facing the holding surface,
wherein removal, by the vacuum source, of the at least some fluid from the space between the holding surface of the stator and the first surface of the cover causes a first fluid pressure, in at least the space between the holding surface of the stator and the first surface of the cover, to be lower than a second fluid pressure, at a second surface of the cover across the cover from the first surface, to urge the cover toward the holding surface to hold the cover to the stator.

17. A stator device for a displacement system, the stator device comprising:
the stator of claim 14; and
a cover comprising:
a first surface facing the holding surface of the stator; and
a second surface across the cover from the first surface,
wherein a first fluid pressure, in at least a space between the holding surface of the stator and the first surface of the cover, is lower than a second fluid pressure, at the second surface of the cover, to urge the cover toward the holding surface to hold the cover to the stator.

18. The stator device of claim 17 further comprising a vacuum source in fluid communication with the internal conduit through the at least one access opening, wherein:
the vacuum source is operable to remove, through the at least one conduit opening, at least a portion of the internal conduit, and the at least one access opening, at least some fluid from the space between the holding surface of the stator and the first surface of the cover; and
removal, by the vacuum source, of the at least some fluid from the space between the holding surface of the stator and the first surface of the cover causes the first fluid pressure to be lower than the second fluid pressure.

19. A stator device for a displacement system, the stator device comprising:
a stator comprising:
at least one electrical conductor positioned to generate at least one magnetic field external to the stator and operable to move at least one mover in a working environment of the displacement system; and
a holding surface; and
a cover comprising:
a first surface facing the holding surface of the stator; and
a second surface across the cover from the first surface,
wherein a first fluid pressure, in at least a space between the holding surface of the stator and the first surface of the cover, is lower than a second fluid pressure, at the second surface of the cover, to urge the cover toward the holding surface to hold the cover to the stator.

20. The stator device of claim 19 wherein the cover is configured to maintain separation between the stator and the working environment.

21. The stator device of claim 19 further comprising at least one spacer between the holding surface of the stator and the first surface of the cover, wherein:
the at least one spacer defines at least one cavity; and
the space between the holding surface of the stator and the first surface of the cover comprises the at least one cavity.

22. The stator device of claim 19 wherein the at least one spacer seals at least a portion of the space within the at least one cavity from an exterior of the stator.

23. The stator device of claim 19 further comprising a vacuum source operable to cause the first fluid pressure to be lower than the second fluid pressure.

24. The stator device of claim 19 wherein:
the first surface of the cover has a first-surface surface area;
the holding surface of the stator has a holding-surface surface area; and
the first-surface surface area is at least 75% of the holding-surface surface area.

25. The stator device of claim 19 wherein the stator defines at least one heat exchange conduit for conveying a heat exchange fluid through the stator.
